(19) United States
(12) Patent Application Publication
(10) Pub. No.: US 2004/0015381 A1
(43) Pub. Date: Jan. 22, 2004

(54) Digital cockpit

(76) Inventors: Christopher D. Johnson, Clifton Park, NY (US); Christina A. LaComb, Cropseyville, NY (US); Hong Cheng, Niskayuna, NY (US); Brian N. Dingman, Gloversville, NY (US); John A. Interrante, Schenectady, NY (US); Peter A. Kalish, Clifton Park, NY (US); Navneet Kapoor, Haryana (IN); Richard P. Messmer, Clifton Park, NY (US); Sunil Rajpal, Westport, CT (US); Melvin K. Simmons, Schenectady, NY (US)

Correspondence Address: LEE & HAYES PLLC, SUITE 500, 421 W RIVERSIDE, SPOKANE, WA, 99201

(21) Appl. No.: 10/339,166

(22) Filed: Jan. 9, 2003

Related U.S. Application Data
(60) Provisional application No. 60/347,230, filed on Jan. 9, 2002.

(51) Int. Cl. G06F 17/60

(52) U.S. Cl. 705/8; 705/10

(57) ABSTRACT

A digital cockpit allows a cockpit user to “steer” a business in the same manner that a cockpit of an airplane is used to control the airplane. A number of digital cockpit features enable this functionality. For example, the digital cockpit provides an efficient mechanism for providing prompt reporting regarding a business's past behavior, its current behavior, and its projected future behavior. The digital cockpit uses a suite of business models to provide such information. The digital cockpit further includes mechanisms for allowing a user to carry out desired control of the business by making changes to the business's processes and associated systems. Further, the digital cockpit provides a modular design which allows for the efficient plug-in and modification of business models.

The following application claims priority to provisional application 60/347,230, filed on Jan. 9, 2002, which is incorporated by reference herein in its entirety.

### TECHNICAL FIELD

This invention relates to a tool for use in managing a business, and more particularly, to a tool for providing information for use in controlling a business by steering the business in a desired direction.

### BACKGROUND

Business decision-makers have always relied heavily on high-level reporting mechanisms in making business decisions. One class of information provides an overview of a business's financial performance over a prescribed time interval, such as over a past month or year. Another class of information provides an overview of a business's current state. Still another class of information provides an overview of the business's projected future course. Various well-known models can be used to generate these overviews. Traditionally, businesses have relied on specific personnel within a business enterprise to generate such information, such as specifically trained business analysts. These analysts traditionally compile this information in various documents for manual dissemination to appropriate individuals within a business, or through other conventional information dissemination channels.

The introduction of computers has greatly facilitated the above tasks. For instance, many software packages exist for performing historical analysis on a collection of business data. Other software packages exist for performing business predictions using various modeling techniques, such as well known Time Series analysis, Monte Carlo analysis, etc. However, in other respects, the above-described paradigm for preparing and presenting business overview information has not greatly changed. Typically, various individuals within an organization still compile overview information and then distribute this information to appropriate individuals in the business using a variety of ad hoc dissemination techniques depending on the demands of a particular business operation.

For instance, a business analyst may first decide what information is required to generate a desired overview within the context of a specific analysis. This may require culling data from a particular sector within the business enterprise, or potentially collecting this data from an external source. The business analyst must then decide on an appropriate modeling tool for generating the desired overview, determine what vendor provides such a modeling tool, and then determine whether the business's infrastructure currently supports such a modeling tool. The business analyst then generates the overview information and presents it to the appropriate individuals within the organization for their assessment using various conventional information dissemination channels. The recipients of the information may feel that the information is not optimally suited to their needs, which may prompt the business analyst to repeat the above-identified steps. Potentially, the business analyst may have to select another modeling tool to provide the desired information.

If the recipients of such information are satisfied with the overview information presented, they may decide to make a change to the business system based on the overview information. Again, businesses often do not employ a well-defined methodology for affecting changes in the business. For instance, it is common to make predictions for a specific subsystem of a business, without considering the overall effect on the business as a whole.

As a result of the above lack of structure in providing and acting on business information, the businesses often cannot exploit the information in an effective manner. For instance, the above approach to presenting overview information may introduce a substantial time lag between a decision to collect the data and the receipt of such data (and the subsequent ability to act on that data). This time lag may prevent the businesses from acting in a timely manner to rectify problems in the business and avoiding future problems. The time lag may also prevent the business from optimizing its mix of risk and return. This problem is greatly exacerbated in today's business environment due to its fast-moving pace and integration of value chain stakeholders. For instance, business conditions may change relatively quickly, warranting relatively timely reporting capability. In addition, technology changes frequently, requiring the business to frequently reassess the suitability of their tools for a given business operation, and potentially quickly substitute new and more powerful tools as need requires. The known ad hoc methodology for delivering business overview information does not satisfy these requirements. In addition, according to the conventional technique, when the business leaders do make a change in the system to correct a perceived deficiency, these changes are not always reliably propagated throughout the business enterprise, and also are not reliably fed back into the modeling tools. This lack of reliable feedback also impedes the business's ability to act on information in a timely manner.

In other words, as appreciated by the present inventors, if one were to consider the above-described methodology as the “steering” mechanism of a vehicle (where the vehicle is representative of the business), then this mechanism would fail to keep the business on the “road” and moving toward a desired goal. The time lags and inefficiencies inherent in the delivery of information may prevent the decision-maker from steering the business in a desired direction, as the decision-maker essentially has poor “visibility.” The inefficiencies inherent in the dissemination of control instructions may also prevent the decision-maker from steering the business in an efficient manner, as the business's “steering wheel” is not well-coupled to the various systems and subsystems of the business.

More specifically, as appreciated by the present inventors, it would be desirable to provide an information presentation technique that allows for real-time or near real-time reporting of historical information and business forecasts. It would further be desirable to have the ability to look far enough ahead to enable a business to make a change in “direction” in sufficient time, should such a change be warranted. It would further be desirable to provide a business steering mechanism that more efficiently disseminates control instructions to appropriate parts of the business. It would further be desirable to provide a flexible technique for selecting business tools for performing business modeling calculations, including an efficient technique for adding new tools and removing tools in a time-efficient and resource-efficient manner.

### SUMMARY

The disclosed technique addresses the above needs through the use of a digital cockpit. According to one exemplary implementation, the digital cockpit is purposely evocative of the cockpit of an airplane in at least three respects. First, an airplane cockpit has various gauges and displays for determining the past course of the airplane as well as its current operational state. In a related fashion, the digital cockpit of a business also can present summary information to assist the user in assessing the past and present state of a business enterprise. Second, an airplane cockpit also has various forward-looking mechanisms for determining the likely future course of the airplane, and to detect potential hazards in the path of the airplane. In a related fashion, the digital cockpit of a business also can present various business predictions to assist the user in assessing the probable future course of the business. Third, an airplane cockpit can include various control mechanisms for controlling the movement of the airplane, and various coupling mechanisms for translating changes in the control mechanisms to the engineered subsystems that are responsible for carrying out the control of the airplane. In a related fashion, the digital cockpit of a business can also provide a mechanism for ensuring that changes made to the “course” of the business are propagated throughout the business to achieve the desired control responsiveness; such responsiveness also entails making appropriate changes in the modeling tools and decisioning systems used in the business so that they reflect the business changes that have been made. The very analogy between an airplane cockpit and a digital cockpit of a business reflects the insight of the inventors, and constitutes a contributing element to the uniqueness of its design.

The digital cockpit includes a suite of business models for providing the above information to a cockpit user. According to another beneficial feature provided by another exemplary implementation, the digital cockpit provides a modular design which allows for the efficient plug-in and modification of business models. This modularity is achieved through the use of an engine abstraction layer. The engine abstraction layer acts as a generic interface which coordinates interaction between the models and other aspects of the digital cockpit, enabling changes to be made in the models without necessarily requiring a change in other aspects of the digital cockpit.

More formally, one exemplary implementation of the technique pertains to a method for controlling a business operation in a business, where the business includes plural subprocesses. The method includes: (a) collecting data relevant to the operation of the business; (b) storing the data in a data storage; (c) performing a first data manipulation task using the stored data to generate a first output result that provides historical information regarding the past course of the business operation and the present course of the business operation; (d) performing a second data manipulation task using the stored data to generate a second output result that provides a forecast regarding the future course of the business operation; (e) disseminating the first output result and the second output result to a user for viewing at a viewing device, where the user makes a decision regarding the control of the business operation, including its plural subprocesses, based on the first output result and the second output result; and (f) receiving an input from the user using the viewing device that affects guidance of the business operation based on the user's decision. A related system is also provided.

According to another implementation, a method is provided for presenting information for use in controlling a business operation. The method includes: (a) initiating the execution of a data manipulation task involving the use of a business tool, where the business tool is one among a group of business tools having different respective processing protocols; (b) activating an interface associated with the business tool; (c) executing the performance of the data manipulation task in a manner specified by the interface, including: (c1) retrieving a file that specifies instructions for use in performing the data manipulation task; and (c2) executing the instructions specified in the file using the business tool, and generating an output result in response thereto; and (d) disseminating the output result to a user for viewing, wherein the output result provides guidance on the operation of the business for use in steering the business in a desired direction. A related system is also provided.

According to another implementation, a method is provided for developing a model. The method includes: (a) specifying at least one activity used by the model; (b) specifying a tool to be used to perform the at least one activity; and (c) storing an indication of the specified at least one activity and the specified tool to form a job script, where the at least one activity includes a file associated therewith, the file containing instructions to be used by the tool in performing the at least one activity when the job script is executed. A related system is also provided.

The above summary is intended to provide non-limiting examples of different manifestations of the digital cockpit concept. Addition manifestations of the digital cockpit technique will be described below, with reference to exemplary drawing figures. The scope of the invention is to be measured solely by the claims provided in the claims section.

### BRIEF DESCRIPTION OF THE DRAWINGS

FIG. 1 shows an exemplary high-level view of an environment in which a business is using a digital cockpit to steer it in a desired direction.

FIG. 2 shows an exemplary flow depiction of the role of a digital cockpit within a business system.

FIG. 3 shows an exemplary business scenario that can benefit from the use of the digital cockpit paradigm.

FIG. 4 shows an exemplary business model for mapping X's into Y's.

FIG. 5 shows another exemplary business model.

FIG. 6 shows another exemplary business model, and the use of the model within a digital cockpit feedback loop.

FIG. 7 shows an exemplary architecture system for implementing the digital cockpit.

FIGS. 8-14 show features of an exemplary digital cockpit interface.

FIG. 15 shows an exemplary system that further drills down on the system shown in FIG. 7 to provide additional detail regarding the predictive features of the system of FIG. 7.

FIG. 16 illustrates the concept of strategy patterns.

FIG. 17 shows the application of the strategy pattern concept to the design of a predictive digital cockpit.

FIG. 18 shows a more detailed view of the application of the strategy pattern concept to the design of a predictive digital cockpit.

FIG. 19 shows a high-level Unified Modeling Language (UML) diagram showing the functions performed by different aspects of the predictive digital cockpit.

FIGS. 20 and 21 collectively show an exemplary xml job script.

FIG. 22 provides an exemplary description of activities performed by the predictive digital cockpit in performing a job.

FIG. 23 provides an exemplary description of activities performed by the digital cockpit in performing an individual activity within a job.

FIGS. 24 and 25 provide specific examples of the execution of activities involving different kinds of tools.

FIG. 26 shows a high-level UML diagram that describes the functions performed by a job management system.

FIGS. 27-34 show different user interface pages provided by the job management system.

FIGS. 35-53 show exemplary digital cockpit displays used in different businesses.

FIG. 54 is a flowchart of a process that provides general steps used to design a digital cockpit

FIG. 55 is another more finely-tuned process for developing a digital cockpit that includes predictive capability.

FIG. 56 shows an exemplary evolution of an implementation of the digital cockpit in successive generations.

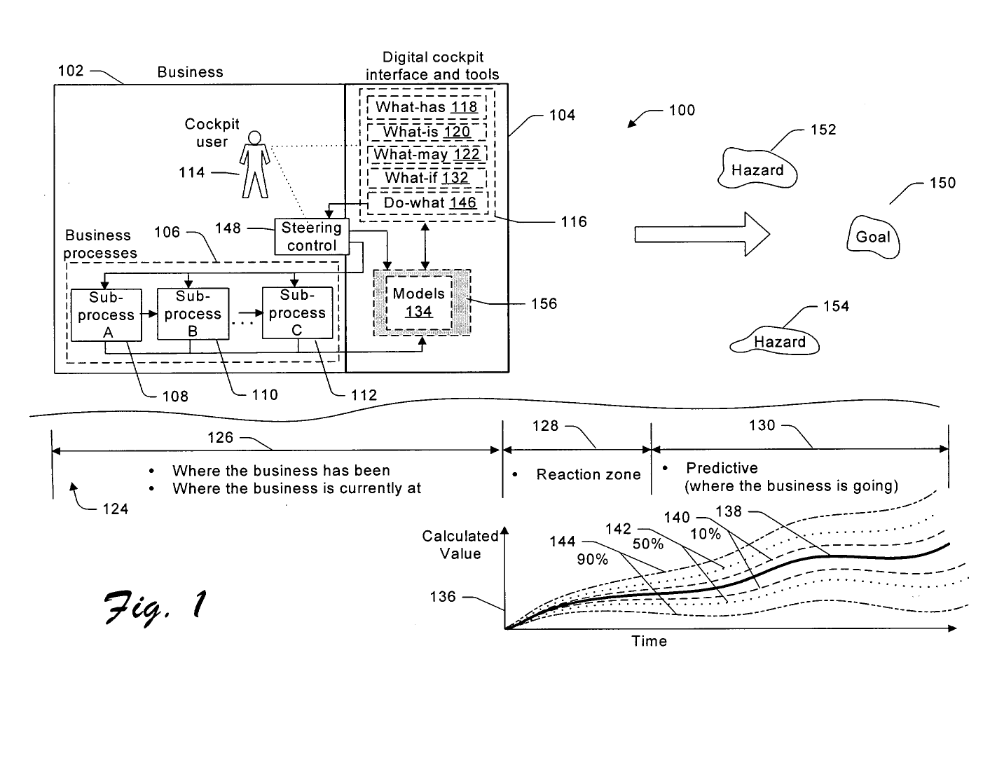

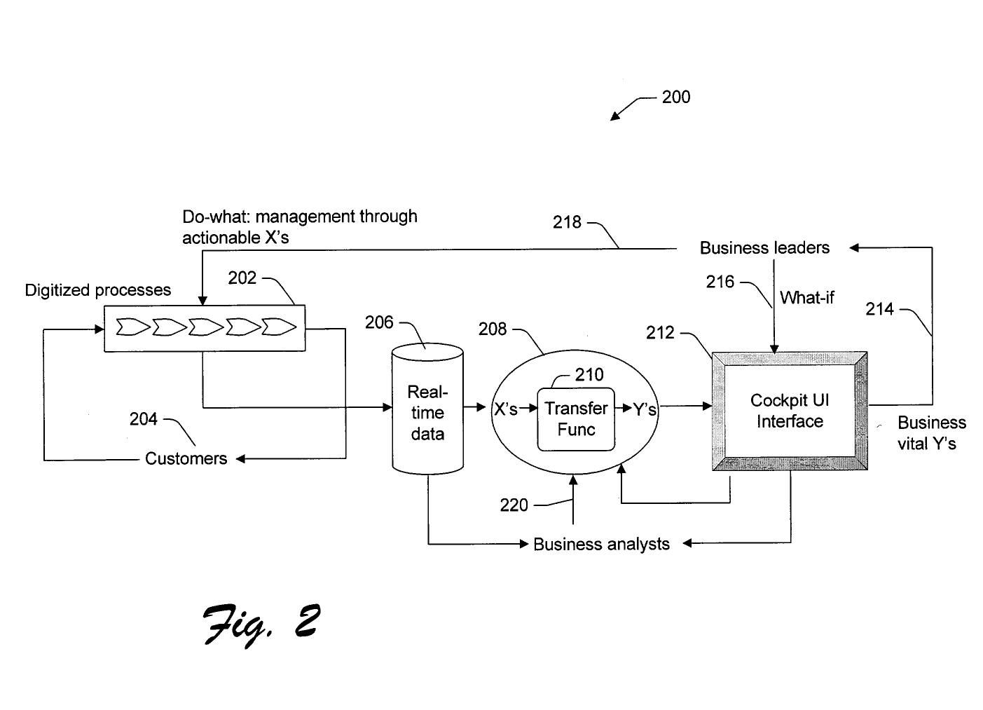

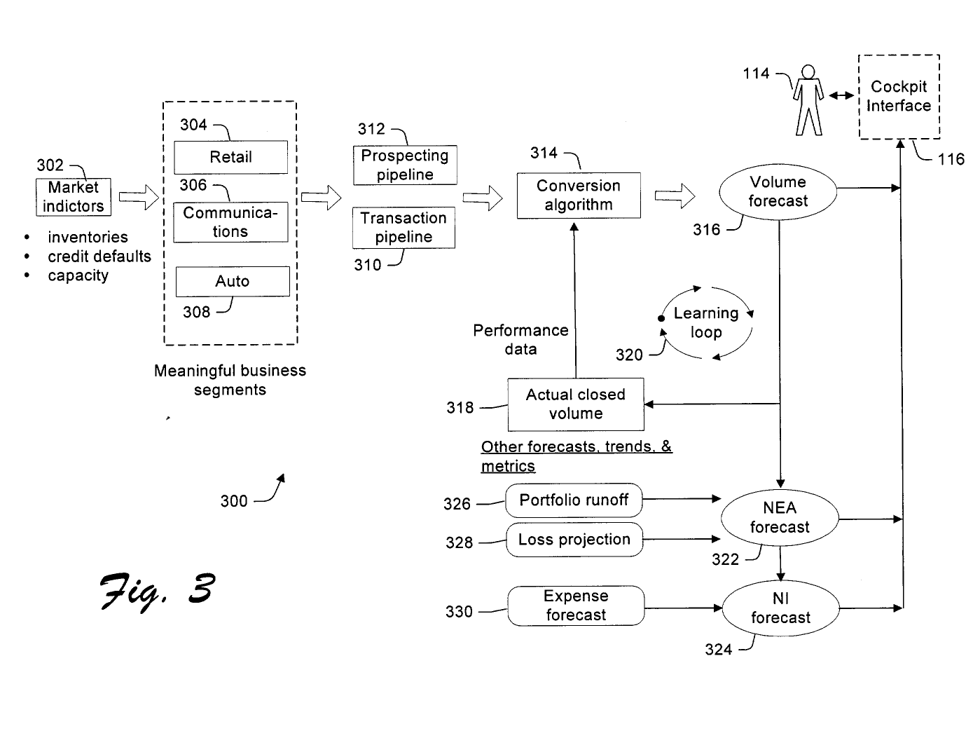

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

A technique disclosed herein provides a mechanism for presenting information for use in controlling a business. The term “business” has broad connotation. A business may refer to a conventional enterprise for providing goods or services for profit. The business may include a single entity, or a conglomerate entity comprising several different business groups or companies. Further, a business may include a chain of businesses formally or informally coupled through market forces to create economic value. The term “business” may also loosely refer to any organization, such as any non-profit organization, an academic organization, governmental organization, etc.

The disclosure contains the following sections:

A. Overview of a Digital Cockpit with Predictive Capability

A.1 Enhancements to the Predictive Capability of the Digital Cockpit

B. General Digital Cockpit Architecture

C. Exemplary Digital Cockpit User Interface

D. The Predictive Digital Cockpit Subsystem

D.1. Predictive Digital Cockpit Architecture Design

D.2. Functional Features of the Predictive Digital Cockpit

E. Predictive Cockpit Job Management System

F. Exemplary Cockpit UI displays for Different Companies

G. Exemplary Method for Designing a Digital Cockpit

H. Conclusion

A. Overview of a Digital Cockpit with Predictive Capability (with Reference to FIGS. 1-6).

FIG. 1 shows a high-level view of an environment 100 in which a business 102 is using a digital cockpit 104 to steer it in a desired direction. The business 102 is generically shown as including business processes 106. The business processes 106, in turn, may be conceptualized as including a flow of subprocesses, such as subprocess A 108, subprocess B 110, and subprocess C 112. The subprocesses (108, 110, 112) may exist within a single business entity. Alternatively, one or more of the subprocesses (108, 110, 112) can extend to other entities, markets, and value chains (such as suppliers, distribution conduits, commercial conduits, associations, and providers of relevant information). Each of these subprocesses (108, 110, 112) may draw from a collection of business resources, such as business personnel, decisioning engines (which refer to automated algorithms for making decisions within the business), control platforms (such as Supply Chain, Enterprise Resource Planning, Manufacturing-Requisitioning & Planning platforms, etc.), technical infrastructure, etc. Further, some of these subprocesses (108, 110, 112) are characterized by behavior that can be modeled using various kinds of transfer functions. A transfer function simulates the behavior of a subprocess by mapping a set of process inputs to projected process outputs. In other words, a transfer function translates at least one input into at least one output using a translation function, which may be a mathematical model or other form of mapping strategy.

Generally, the business processes 106 forward information regarding the “course” of the business to digital cockpit 104 for viewing and for facilitating proactive control of the business processes 106 by a cockpit user 114. The cockpit user 114 can include any individual within the business 102 (or potentially outside the business 102). The cockpit user 114 frequently will have a decision-maker role within the organization, such as a managerial role. Alternatively, the cockpit user 114 can be replaced by an automated decisioning algorithm that provides direct automated process control without the required intervention of a human user. Still alternatively, an automated decisioning algorithm can be provided to assist the cockpit user 114 in making decisions.

More specifically, the digital cockpit 104 includes a cockpit interface 116 which can display a number of categories of information regarding the business. For instance, the cockpit interface 116 may include a first field 118 for presenting information regarding the past course of the business 102 (referred to as “What has happened,” or “What-has” for brevity). The cockpit interface 116 may include a second field 120 for presenting information regarding the present state of the business 102 (referred to as “What is happening,” or “What-is” for brevity). Further, the cockpit interface 116 may also include another field 122 for presenting information regarding the projected future course of the business (referred to as “What may happen,” or “What-may” for brevity). A timeline 124 appears beneath the business 102 which clarifies the sources of information presented in fields 118, 120, and 122 of the digital cockpit interface. A first span 126 of time reflects the past course of the business 102, as well as its present state. Information from this span 126 is culled and presented in interface fields 118 and 120, respectively. A second span 128 of time and a third span 130 of time reflect the projected future course of the business 102. Namely, the second span of time 128 represents the projected near future course of the business 102, while the third span 130 of time represents the projected more distance future course of the business 102. The second span of time 128 may also represent the amount of time that a business needs to adequately respond to a decision change. This reaction time (also referred to as the “reaction zone”) should be chosen to be large enough to account for the inherent “sluggishness” of the business to change (analogous to a time constant in a physical system), as well as errors in the forecasts presented to the digital cockpit 104 (which correspond to degrees of certainties in the algorithms used to generates the forecasts). Information from these spans (128, 130) is culled and presented to the interface field 122.

In addition, the cockpit interface 116 presents a “What-if” field 132. The What-if field allows the cockpit user 114 to enter information into the cockpit interface 116 regarding hypothetical or actual conditions within the business 102. The digital cockpit 104 will then compute various consequences of the identified conditions within the business 102 and present the results to the cockpit user 114 for viewing. Generally, the term “prediction” is used broadly in this disclosure. This term encompasses any kind of projection of “what may happen” given any kind of input assumptions. In one case, a user may generate a prediction by formulating a forecast based on the course of the business thus far in time. Here, the input assumption is defined by the actual course of the business. In another case, a user may generate a prediction by inputting a set of assumptions that could be present in the business (but which do not necessarily reflect the current state of the business), which prompts the system to generate a forecast of what may happen if these assumptions are realized. Here, the forecast assumes more of a hypothetical character (e.g., “If X is put into place, then Y is likely to happen”).

The cockpit interface 116 interacts with a set of models 134, comprising one or more models. The models 134 may perform various tasks in conjunction with the presentation of information in the cockpit interface 116. For instance, a first series of models may perform data extraction, transformation, and loading functions. These models basically are in charge of culling information from the business processes 106 and presenting it in a form suitable for viewing or further analysis. A second series of models may perform various analytical functions, such as various business prediction functions. For instance, these functions may include discrete event simulations, continuous simulations, Monte Carlo simulations, regressive analysis techniques, time series analyses, artificial intelligence analyses, extrapolation and logic analyses, etc.

The output generated by forward-looking models will typically include some uncertainty associated therewith. This uncertainty may stem, in part, from the uncertainty in the input values that are fed to the models (due to natural uncertainties regarding what may occur in the future). Trend chart 136 illustrates the uncertainties associated with the output of forward-looking models. The vertical axis of the chart 136 represents the output of an exemplary forward-looking model, while the horizontal axis represents time. Curve 138 represents the output of the model (e.g., the “calculated value”) as a function of time. Confidence bands 140, 142, and 144 reflect the level of certainty associated with the output 138 of the model at different respective confidence levels. For instance, the chart 136 indicates that there is a 10% confidence level that future events will correspond to a value that lies within band 140 (demarcated by two dashed lines that straddled the curve 138). There is a 50% confidence level that future events will correspond to a value that lies within band 142 (demarcated by two dotted lines that straddled the curve 138). There is a 90% confidence level that future events will correspond to a value that lies within band 144 (demarcated by two outermost dashed lines that straddled the curve 138). All of the bands (140, 142, 144) widen as future time increases. Accordingly, it can be seen that the confidence associated with the model's output decreases as the predictions become progressively more remote in the future. Stated another way, the confidence associated with a specific future time period will increase as the business moves closer to that time period.

The cockpit user 114 will take the above-described factors into account when “steering” the business, realizing that predictions in the distant future may have a significant uncertainty associated therewith. The business 102 may be likened to a vehicle moving in a fog, where the fog increases as a function of distance. “Objects” that are close to the business 102 in time are clearly discerned, but there is limited time to react. “Objects” in the distant future are only dimly observed, but there is more ample time to react. Like an actual driver, the cockpit user 114 takes this situation into account in plotting a prudent course into the future (e.g., by slowing down, taking steps to gain better visibility, etc.).

More specifically, based on all of the information presented to the cockpit user 114 via the cockpit interface 116, a cockpit user 114 may decide to change the business processes 106. The digital cockpit 104 enables the cockpit user 114 to make these changes via a cockpit interface field 146 of the cockpit interface 116, which may comprise various user interface input mechanisms (not shown), such as various graphical knobs, sliding bars, etc. Alternatively, the cockpit user 114 may affect these changes through other routes of control, such as conventional mechanisms for affecting changes in an organization (e.g., oral instruction, written report, email, physical change to the business infrastructure, etc.). The steering control module 148 generally represents the cockpit user's 114 ability to make changes to the business process 106. More specifically, the steering control module 148 enables the cockpit user to make changes to any of the business subprocesses (108, 110, 112). These changes may include changes to any aspect of the business subprocesses (108, 110, 112), such as changes in staffing, changes in business methodology, changes to decisioning algorithms used to make decisions, changes to workflows, changes in business systems, etc. In the case that a subprocess can be represented by a transfer function, making a change to the subprocess may effectively provide different input to the transfer function, or may constitute changing the transfer function itself. In the case that the subprocess uses a decisioning algorithm, making a change to the subprocess may constitute changing the data (e.g., constants, etc.) used by the decisioning algorithm, or may constitute changing the decision flow used by the decisioning algorithm, or may constitute any other of a myriad of different ways that a decisioning algorithm can be changed.

The steering control module 148 also enables the cockpit user 114 to directly make changes to the models 134 used by the digital cockpit 104 in presenting information to the cockpit interface 116. Such changes may constitute modifying one or more models 134, replacing one or more models 134 with different models, or supplementing the existing models 134 with additional models. Moreover, the use of the digital cockpit 104 may comprise an integral part of the operation of different business subprocesses (108, 110, 112). In this case, cockpit user 114 may want to change the models 134 in order to affect a change in the subprocesses (108, 110, 112).

In one implementation, the steering control module 148 formalizes the above-described control functions by including an automated control mechanism for propagating a cockpit user's 114 instructions to relevant parts of the business processes 106. For instance, the steering control module 148 can map a cockpit user's 114 instructions to the specific commands necessary to affect such instructions. This mapping can be implemented in various ways. For instance, the steering control module 148 can use rule-based logic to perform the required mapping. For instance, an exemplary rule might specify: “If a user enters instruction X, then affect change Y to subprocess 108, and affect change Z to subprocess 110.” Another exemplary rule might state: “If a user enters instruction W, then notify employee M to perform defined task P.” Such rules can be stored in a knowledge base (not shown), which may reflect empirical knowledge garnished from the business processes 106 over time (e.g., in response to observed causal relationships between changes made within a business and their respective effects). Effectively, this knowledge base constitutes the control coupling between the digital cockpit 104 and the business processes 106 which it controls. Still more complex strategies can be used, such as artificial intelligence (expert systems) solutions for translating a cockpit user's 114 instructions to the commands necessary to affect such instructions. The actual commands required to affect changes can be propagated through the business 102 in any manner supported by the business 102. In one implementation, a computer network (not shown) can be used to transmit the required commands to the targeted personnel, decisioning engines, systems, etc.

Further, as noted above, the digital cockpit 104 can rely on automated decisioning to also make decisions on what changes to make to the business in response to information forwarded to the digital cockpit 104. This automated decisioning can entirely replace the judgment of a human cockpit user 114, or can be used to supplement the judgment of the human cockpit user 114. This automation can be implemented in the manner described above, such as using rule-based decisioning logic, an expert system, or other strategy. That is, for instance, an automatic decisioning algorithm can translate the information provided to the digital cockpit 104 to recommendations (pertaining to what to do in response to this information) by relying on a knowledge base of decision rules (e.g., “If conditions A, B, and C are present, then recommend courses of action X and Y”), or some other decision-based strategy.

Due to the above feature, changes made through the above-described measures allow a cockpit user 114 to “steer” the business 102 along a desired or required path toward a desired goal 150, while improving the probability of avoiding one or more potential hazards or constraints (e.g., 152, 154) along the way. Like a physical engineering system, there are certain limitations regarding how quickly the cockpit user 114 can “turn” the business 102 to avoid hazards. For instance, there is a limit to how,quickly a cockpit user 114 can change the direction of the business 102 in the near future to avoid problems that will immediately impact the business. As explained above, reaction zone 128 may represent a time period required for the business to make a change to avoid a hazard (152, 154). As such, in order to prevent navigating into troubled regions where it is too late to steer away from hazards, the cockpit user 114 will want to keep an eye on the more distance future, representative of time span 130. The reaction zone 128 is determined, in part, based on the inherent “sluggishness” of the business in response to change, as well as the ability of the business to see into the future—e.g., the “visibility” of the business's forward-looking “window.” (which is related to the uncertainties in the forecasts). Thus, one way of improving performance with respect to the reaction time of the business is to improve the quality of predictions (by reducing the error or uncertainty associated with the predictions).

Affective control of the business 102 is also facilitated through the digital cockpit's 104 architecture for interfacing with its models 134. Namely, the digital cockpit 104 interfaces with the models 134 through an abstraction layer 156. The abstraction layer 156 encapsulates the models 134 by providing a generic interface for use by the models 134 in interacting with other aspects of the digital cockpit 104. Hence, this generic interface effectively hides the uniqueness of models 134 from other aspects of the digital cockpit 104. In operation, an entity that wishes to communicate with a model 134 sends instructions to the interface of a particular model 134. The interface interprets the instructions and then coordinates with the model 134 based on the model's 134 specific characteristic. The interface also receives any output generated by the model 134, and coordinates the transfer of this information to other entities in the digital cockpit 104. Because the models 134 are, in effect, encapsulated in its abstraction layer 146, a cockpit user 114 can easily make changes to the models 134 without this change requiring labor-intensive changes to other aspects of the digital cockpit system. This also promotes the goal of timely “steering” the business 102 in a desired direction, because according to the use of the abstraction layer 156, the digital cockpit 104 is not disabled for any substantial period of time when a cockpit user 114 decides to make changes to a model 134.

In general, the “steering” analogies used in the above discussion were deliberately chosen. The intent of the inventors was to provide a digital cockpit 104 for use in a business 102 that acted in a manner related to an actual cockpit of an airplane—and hence the use of the term “cockpit” to describe this system. Generally speaking, just as the cockpit of an airplane serves as an indispensable tool for guiding the plane in a desired direction, the digital cockpit 104 of a business 102 provides guidance in steering a business 102 in a desired direction. The insight involved in making this analogy constitutes part of the uniqueness of the digital cockpit. The digital cockpit differs from conventional business simulation in a number of ways. For instance, the digital cockpit links systems, data, analyses, and processes used within a business to enable the business to be literally “operated,” which differs from the merely advisory role of business simulations.

To summarize the discussion of FIG. 1, three analogies can be made between an airplane cockpit and a business digital cockpit 104 to clarify the functionality of the digital cockpit 104. First, an airplane can be regarded as an overall engineering system including a collection of subsystems. These subsystems may have known transfer functions and control couplings that determine their respective behavior. This engineering system enables the flight of the airplane in a desired manner under the control of a pilot or autopilot. In a similar fashion, a business 102 can also be viewed as an engineered system or process 106 comprising multiple subprocesses and associated systems (e.g., 108, 110, 112). Like an airplane, the business digital cockpit 104 also includes a steering control module 148 that allows a cockpit user 114 to make various changes to the subprocesses (108, 110, 112) to allow the business 102 to carry out a mission in the face of various circumstances (with the benefit of information in past, present, and future time domains).

Second, an airplane cockpit has various gauges and displays for providing substantial quantities of past and current information pertaining to the airplane's flight, as well as to the status of subsystems used by the airplane. The effective navigation of the airplane demands that the airplane cockpit presents this information in a timely, intuitive, and accessible form, such that it can be acted upon by the pilot or autopilot in the operation of the airplane. In a similar fashion, the digital cockpit 114 of a business 102 also can present various summary information to assist the user in assessing the past and present state of a business 102, including its various “engineering” subprocesses (108, 110, 112).

Third, an airplane cockpit also has various forward-looking mechanisms for determining the likely future course of the airplane, and for detecting potential hazards in the path of the airplane. For instance, the engineering constraints of an actual airplane prevent it from reacting to a hazard if given insufficient time. As such, the airplane may include forward-looking radar to look over the horizon to see what lies ahead so as to provide sufficient time to react. In the same way, a business 102 may also have natural constraints that limit its ability to react instantly to assessed hazards (142, 144). Accordingly, the digital cockpit 104 of a business 102 also can present various business predictions to assist the user in assessing the probable future course of the business 102. This look-ahead capability can constitute various forecasts and what-if analyses. Further, like an airplane, a pilot may have a relatively clear view of objects that lie directly ahead of the airplane, but a progressively dimmer view of objects farther away. In a related way, the cockpit interface 116 may present confidence levels associated with its forward-looking information; events located in the near future will be relatively clearly discerned by the cockpit user 114, while more distance events will be more dimly discerned. And like a pilot, the cockpit user 114 takes this into account in the prudent “steering” of the business. Further, a cockpit user 114 may proceed by examining the uncertainty associated with input data, the inherent uncertainty associated with the forward-looking models, the capability of a business to react to a change, and other factors, and then deliberately manipulate at least some of these factors to provide a desired level of visibility.

The next series of figures provide additional information regarding the predictive capability of the digital cockpit 104. FIG. 2, for instance, shows a flow depiction of the role of a digital cockpit within a business system 200. It conveys many of the same concepts as FIG. 1. The business system 200 includes various digitized processes 202 that represent the normal course of business operations performed by the business (and which may generally correspond to the business process 106 shown in FIG. 1). The digitized processes 202 typically involve interaction with customers, and this interaction may form a loop, where the “end product” of digitized process 202 serves as input for a next cycle of the digitized process 202. This loop is represented in FIG. 2 as loop 204. A real-time data storage 206 extracts information from the digitized processes 202 and stores it in a suitable format for later retrieval and analysis.

Model engine 208 then extracts this information from the real-time data base 206 and uses it to generate one or more business forecasts as needed. (Model engine 208 may generally correspond to the models 134 shown in FIG. 1). More specifically, the model engine 208 is preferably tailored to map various independent X variables (“X's”) to various dependent Y values using one or more transfer functions 210. For convenience, only one model transfer function 210 is shown in FIG. 2. An X variable is said to be “actionable” when it presents a parameter that the business system 200 is empowered to change. That is, a given X value is actionable in the sense that a business leader within the business system 200 can attempt to change the course of the business by taking action and modifying the value of the X variable. Both the X and Y values may be discrete scalar quantities, vectors, matrices, tensors, or other higher order symbolic representations of data.

The model engine 208 can forward its predictions to the predictive cockpit interface 212 for display thereat. (This predictive cockpit interface 212 may generally correspond to the cockpit interface 116 shown in FIG. 1). More specifically, the cockpit interface 212 may present information regarding so-called “vital Y's” of the business. A Y value is “vital” in the sense that it is directly associated with the success of the business in achieving its intended goal. (The vitality of these metrics can be assessed using the domain expertise of appropriate business personnel within the business, and can also be analytically derived). The upward-swinging arrow 214 indicates that a business leader examines the output of the cockpit interface 212—namely the vital “Y,” contributing “X's” and other information provided by the cockpit interface 212. The business leader may also experiment with the model engine 208 by inputting a number of “what if” scenarios to the cockpit interface 212, comprising one or more hypothetical input conditions. These what-if scenarios prompt the cockpit interface 212 to provide a series of additional forecasts based on formation extracted from the digitized processes 202, which may (or may not) involve running input data through the model engine 208 again. For instance, an exemplary “what-if” scenario might involve determining how variation in one variable (e.g., sales figures, interest rates, unemployment rates) can affect another (e.g., the profitability of the company, future sales, staffing needs, etc.). The downward arrow 216 reflects the input of what-if scenarios, and the examination of the output results.

Through the above procedure, the digital cockpit has the highly desirable ability to simulate the likely course and responsivity of the business system to a proposed change, prior to an actual implementation of the change. This feature helps reduce costly mistakes in control and the consequence delay required to uncover these mistakes. Suboptimizations can be avoided on account of the opportunity to first assess responses in a virtual, high speed, high fidelity modeled environment.

Eventually, the business leader will make a business decision based on the forecasts presented in the cockpit interface 212. Namely, the business leader may decide to affect a change in the management of business by making a change in one or more of the actionable X's. These changes may induce changes in the digitized processes 202, which, in turn, will prompt the output of new data and/or business metrics for storage in the real-time database 206, and the subsequent generation of new forecasts. In this manner, a feedback loop 218 is established, where a business leader investigates various what-if scenarios, makes a change to the digitized processes 202, notes the response of the business system 200, and then provides further corrective measures if necessary.

Business analysts may also examine the information being stored in the realtime database 206, as well as the predictions forwarded to the cockpit interface 212. In response, the business analysts may assess whether the models provided in the model engine 208 are optimally suited for the current state of the business system 200. If not, the business analyst may decide to edit or replace one or more business models provided in the model engine 208. This series of tasks is represented by the feedback loop 220 shown in FIG. 2.

FIG. 3 shows a specific exemplary business scenario 300 that might benefit from the use of the above-described methodology of iteratively making business changes based on the feedback provided by a digital cockpit. By way of high-level overview, the scenario 300 involves collecting various market indicators 302 (such as inventory levels, credit default levels, capacity, values, etc.). The scenario 300 also involves collecting additional information pertaining to business opportunities available to a particular business under consideration, such as business opportunities in various business sectors (such as retail 304, communications 306, and the automobile industry 308) or other meaningful aggregation or segment. The scenario involves collecting yet further information pertaining to a business's existing transaction pipeline 310 and a business's prospecting pipeline 312 (reflecting business prospects). All of the above-described information is fed into a conversion algorithm 314 which produces a volume forecast 316 based on the collected information. This volume forecast 316 is compared with an actual closed volume value 318 subsequently measured by the business. Discrepancies between the volume forecast 316 and the actual closed volume 318 are noted and used to tailor the conversion algorithm 314 so that it generates more accurate results in the future. Through a number of iterations, the convergence algorithm 314 will likely converge on an accurate predictive model. This interactive process is represented in FIG. 3 as a learning loop 320.

Based on the output of the learning loop 320, the scenario 300 can entail generating a forecast of Net Earning Assets (NEA) 322 and Net Income (NI) 324. To generate a forecast of NEA 322, the volume forecast 316 is combined with other metrics, such as portfolio runoff 326, and loss projection 328. To generate a projection of NI 324, the NEA forecast 322 is combined with an expense forecast 330. As shown in FIG. 3, the above-described cockpit interface 116 can receive and display the above-identified metrices (as well as other information regarding the business), whereupon a cockpit user 114 may exercise judgment based thereon (or an automated decisioning system may make automated decisions based thereon).

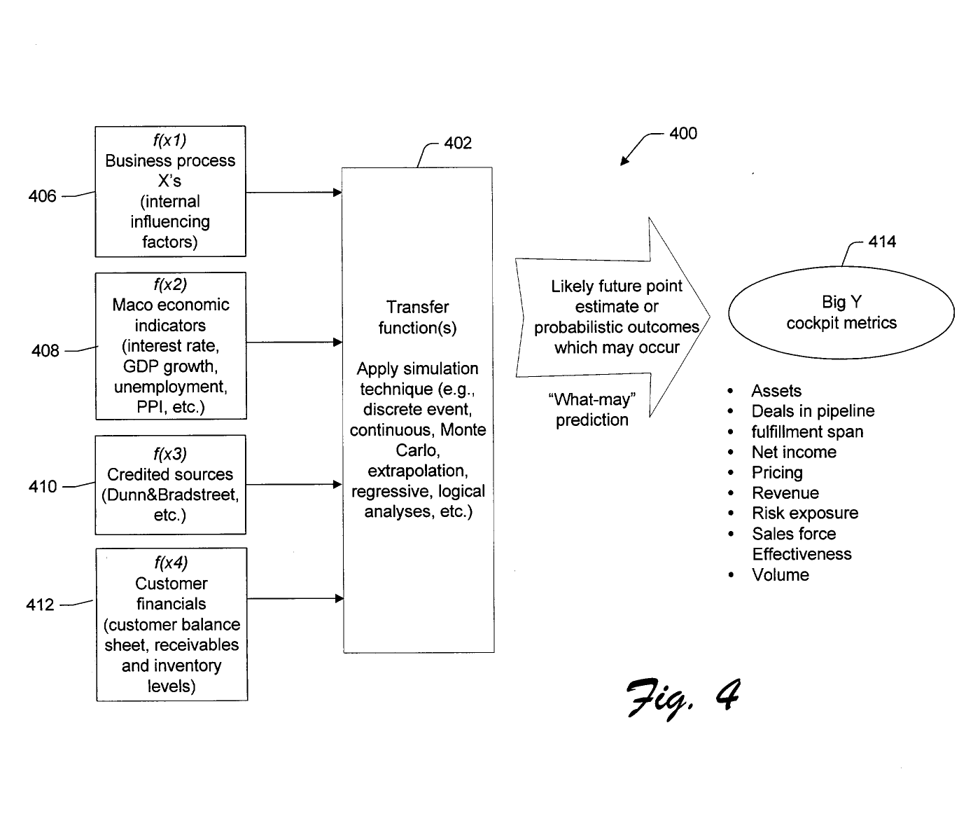

FIG. 4 provides additional high-level information regarding analysis performed by a particular business model 400. The model 400 employs transfer functions 402 that map a collection of X's (406, 408, 410, 412) into a Big Y 414 (e.g., a vital Y). The X's (406, 408, 410, 412) may be actionable or may be of informational value. The exemplary X's shown in FIG. 3 may include a first actionable X category 406 pertaining to “business process X's” (that is, those X values that represent influential factors within an internal business process, such as staffing levels, decisioning engine coefficients, shifts, etc). Another X category 408 may represent broad-based market information, such as information pertaining to macroeconomic indicators (such as interest rate, Gross Domestic Product, growth rate, unemployment rate, etc.). A third X category 410 may pertain to credited sources (such as Dunn & Bradstreet, commodity, exchange prices, etc.). A fourth X category 412 may pertain to customer financials (such as customer balance sheet information, receivables, inventory levels, etc.). This list is merely illustrative of one exemplary set of X's pertinent to one exemplary business operation.

A variety of different transfer functions 402 can be used to map the actionable X's into the Big Y 414. Well known exemplary transfer function techniques include discrete event analyses, continuous analyses, Monte Carlo and Latin Hypercube simulations, various regression based techniques, artificial intelligence techniques, mathematical operand analyses, logical reasoning, etc. Generally, the transfer functions 402 map the X's (406, 408, 410, 412) into the Big Y 414 using an appropriate modeling technique. Common exemplary Big Y's may include assets, deals in pipeline, fulfillment span, net income, pricing, revenue, risk exposure, sales force effectiveness, volume, asset utilization, make/buy/sell information, etc.

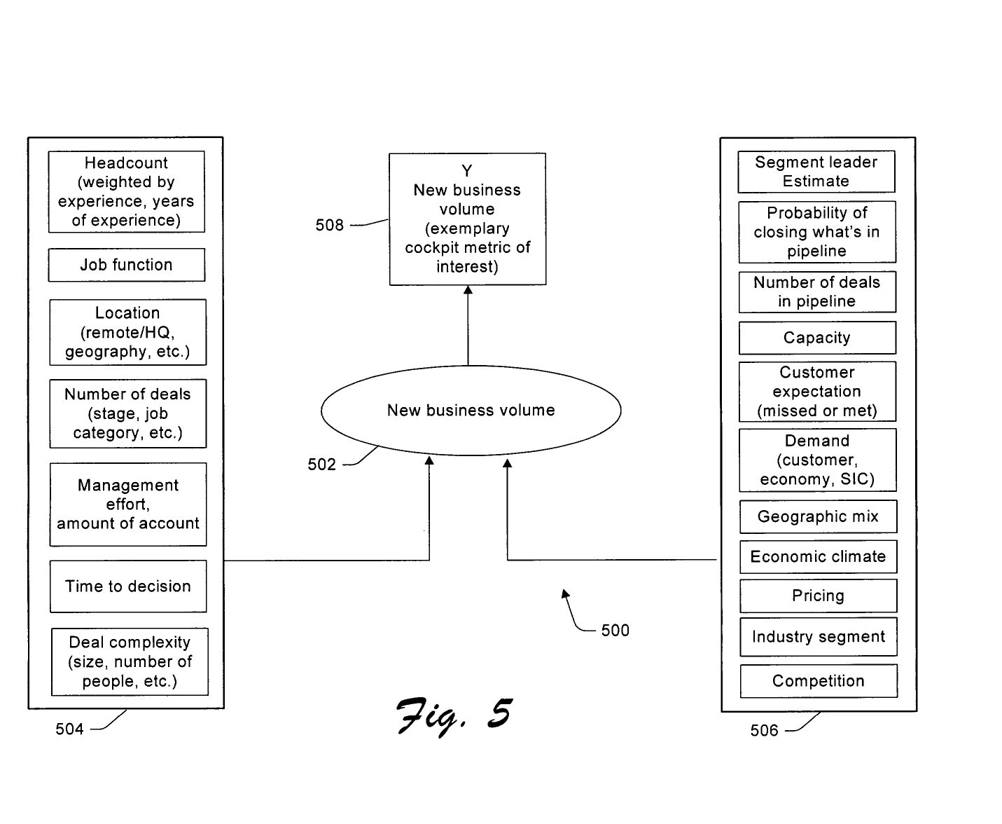

FIG. 5 shows another example of model 500 using another transfer function 502 (i.e., a New Business Volume transfer function). The depiction of this model 500 drills down still further by showing more specific combinations of actionable X's (504, 506) that can be used to provide the exemplary Big Y of New Business volume 508 using the transfer function 502. More specifically, a first and second series (504, 506) of actionable X's can be used to feed values into the New Business volume transfer function 502, which generates the Big Y value 508 representative of new business volume. The first exemplary series of actionable X's 504 includes: headcount, job function, location, number of deals, management effort, time-to-decision, and deal complexity. The second series of actionable X's 506 includes: segment leader estimate, probability of closing what's in the pipeline, number of deals in the pipeline, capacity, customer expectation, demand, geographic mix, economic climate, pricing, industry segment, and competition. To repeat, this particular combination of X's represents just one sampling in a myriad of possible permutations.

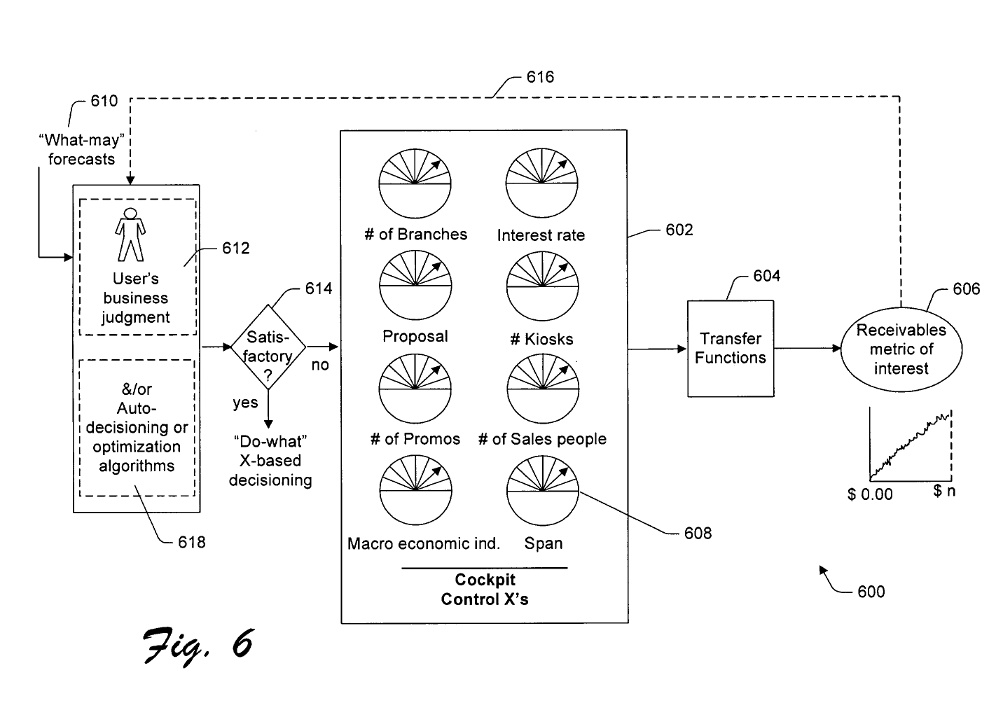

FIG. 6 provides yet another example of a model 600. This model 600 maps a collection 602 of actionable X's into a Big Y of interest 604 (receivables) using transfer functions 606. In the implementation shown in FIG. 6, the actionable X's can be specified using various input dials (such as input dial 608) presented on the cockpit interface (e.g., through an appropriate graphical user interface presentation of the dials). In this merely illustrative example, the dials are used to input information regarding actionable X's pertaining to the following categories: number of branches, interest rate, proposals, number of kiosks, number of promotions, number of sales people, macro economic indicators, and span. Again, the transfer functions 606 map these actionable X's into a Big Y 604 representative of receivables.

FIG. 6 also illustrates an exemplary context in which the transfer functions 604 can be used. More specifically, a cockpit user 114 may desire a certain outcome at a specific future time frame (such as a future financial reporting period). To achieve this outcome, the cockpit user 114 may use the digital cockpit to generate forecasts (e.g., “What-may” information 610). Again, this information 610 is analogous to the forward-looking radar provided by an airplane cockpit. Based on this information 610, the cockpit user 114 makes a judgment regarding various changes that may be required to accomplish the desired outcome. This judgment is represented by the block that reads “User's business judgment” 612 in FIG. 6. The digital cockpit user 114 also implicitly determines whether the current forecasts are appropriate to achieve the desire outcome. This judgment is represented by decision block 614. If the present forecasts are not sufficient to realize the desired outcome, the cockpit user 114 inputs a change in modeling assumptions to the transfer functions 604 via, for example, the inputs dials in collection 602. The transfer functions 604 generate output metrics based thereon (e.g., pertaining to receivables), and these metrics are displayed to the cockpit user via the cockpit interface (as represented by the feedback loop 616). In block 612, the cockpit user 114 again reviews the generated metrics. If the metrics are now acceptable, the cockpit user 114 can implement the solution by inputting appropriate commands through the cockpit interface, or through other mechanisms. This will transmit “Do-what” instructions to the appropriate subsystems, processes, decisioning engines, personnel, and stakeholders within the business. This allows the business to change in a well-understood, rapid and stable manner. On the other hand, if the metrics evaluated in block 612 are still deficient, then the cockpit user 114 can repeat the above-described procedure by inputting another set of “what if” assumptions to the transfer functions 604.

As explained above, the cockpit user's judgment can be supplemented by autodecisioning or optimization algorithms 618, or can be entirely replaced by such algorithms. In the latter case, the digital cockpit would automatically cycle through a number of permutations of decisions, and automatically select an optimum permutation. The automatic decisioning can also be designed to automatically implement the required changes in the business upon arriving at the optimum permutation of decisions, such as by automatically determining what “Do-what” instructions are required, and then automatically propagating such instructions through the business.

Generally, the ability to “try out” a plurality of proposed solutions prior to actual implementing these solutions in the business results in a number of benefits. As described above, this virtual mode can help reduce various time-inefficiencies, resource inefficiencies, and general suboptimizations that might occur had the actual solutions been implemented in the business in iterative fashion.

FIGS. 1-6 represent only a small number of possible applications of the digital cockpit business paradigm. Indeed, any kind of organization or collection of stakeholder collaborators could benefit from the use of a digital cockpit. For instance, many businesses can be modeled in the manner described above, namely as a flow of processes with associated system infrastructures and transfer functions. Such processes may have distinct input materials and a final generated product in much the same way that a physical manufacturing line converts certain raw materials into a finished product. The digital cockpit can be used in the manner described above to steer such business “manufacturing lines” in an efficient manner.

For example, consider the illustrative case in a business which involves leasing. Here, this business begins with a lessor that may wish to lease an asset to a lessee. The lessee is thus analogous to the input material in this process. The output of this process, if successful, constitutes a lessee having a valid lease of the asset. Various intermediary steps can be identified for converting the input material to the output product, in the same manner as a physical manufacturing line. Some of these steps may have consistent input and output characteristics that can be modeled with appropriate transfer functions. This therefore describes an environment in which the digital cockpit paradigm can be successfully deployed.

Another exemplary application of the digital cockpit paradigm is in credit approval and underwriting environments. Again, the input “material” is a candidate for credit. The main task here is to determine the credit-worthiness or risk of the candidate. A number of heuristic rules are traditionally employed in performing this task. If the candidate is deemed credit-worthy, then the candidate advances to a number of downstream stages in the process. Many of these stages can be automated and monitored using the digital cockpit paradigm described above, greatly reducing the costly involvement of human beings in the analysis and the time lags associated therewith.

For example, this application may provide multiple decision engines at various stages in the process to implement the business operation. Various metrics from the process are culled and presented to the cockpit interface. Based thereon, a cockpit user (or automatic counterpart) can decide how to modify the decisioning engines to achieve desired results. These “Do-what” commands may take the form of changing the input data used by the decisioning engines, or may constitute an actual change to the methodology used by the decisioning engines, or may entail still other ways of changing the decisioning engines.

These kinds of applications of the digital cockpit are referred to as autodecisioning applications.

In yet another application, the digital cockpit paradigm can be applied to the decision-making that goes into introducing a new product or service to a marketplace. Again, this environment is characterized by a series of distinct stages, many of which lend themselves well to automated analysis and monitoring. In this environment, the digital cockpit can model the value and risk attendant upon the introduction of a new product or service, so as to make more informed and profitable decisions regarding the introduction of a new product or service.

Still other applications of the digital cockpit are possible. The above examples are merely illustrative.

A.1. Enhancements to the Predictive Capability of the Digital Cockpit

A number of additional predictive features can be added to the digital cockpit to enhance its utility to the business. For instance, the digital cockpit can anticipate the types of predictions that a decision-maker is likely to want to make. The digital cockpit can then calculate a batch of these predictions in advance and store these predictions until the decision-maker requests them. This solution can greatly expedite the delivery of real-time predictions to a user, and thus further contributes to the goal of providing a real-time steering mechanism to steer the business. The digital cockpit can anticipate a digital cockpit user's informational needs in various ways. For instance, the digital cockpit can initiate a recalculation of predictions at predetermined scheduled times. Alternatively, the digital cockpit can initiate the recalculation of predictions when input variables change by a predetermined amount. That is, changes in the input variables serve as a trigger for recalculation. The digital cockpit can alternatively predict a user's information needs through more complex mechanisms, such as various rule-based systems for assessing informational needs, or other analysis techniques.

In a variation of the above-identified feature, the digital cockpit can assess how much advance analysis should be performed in different “zones” defined by the model's transfer function. More specifically, the digital cockpit can plot the output of the model's transfer function as a two dimensional, three dimensional, or higher dimensional graph on the cockpit interface. This plotted transfer function output defines an output surface. This output surface may include regions that are relatively “flat,” and other regions where the surface changes dramatically. The digital cockpit takes the shape of this surface into consideration by presenting more fine-grained calculations for those regions where the surface changes dramatically, and fewer calculations for those regions that are relatively flat. This intelligent pre-calculation of the predictive results improves predictive results in regions where the surface changes abruptly by ensuring that sufficient information is computed to meet the user's inquiry needs with respect to these regions. At the same time, the precalculation does not unnecessarily overburden the system by requiring fine-grained analysis in all regions of the surface, such as those regions that do not contain rapid change in output results. Regions of rapid change can be assessed using various techniques, such as by forming a derivative of the output surface.

In another enhancement, the digital cockpit can generate a batch of predicted results for different input assumptions. The digital cockpit can also generate measures of reliability (or “robustness”) associated with these predicted results based on various user-selected criteria. As such, the digital cockpit can rank different possible courses of action (corresponding to different possible what-if scenarios). Thus, in this implementation, the user is not confined to manually making individual “what-if” projections; the digital cockpit can generate many predictions and provide the user with some guidance on their relative merit. This information is of course valuable to the decision-maker when deciding on the business's course of action. Further, once the decision-maker arrives at a process configuration setpoint that is desired, the digital cockpit can then cascade the desired X setpoints to the subprocesses of the business to affect the recommendation in a reliable fashion.

Many other variations of the above concepts are possible.

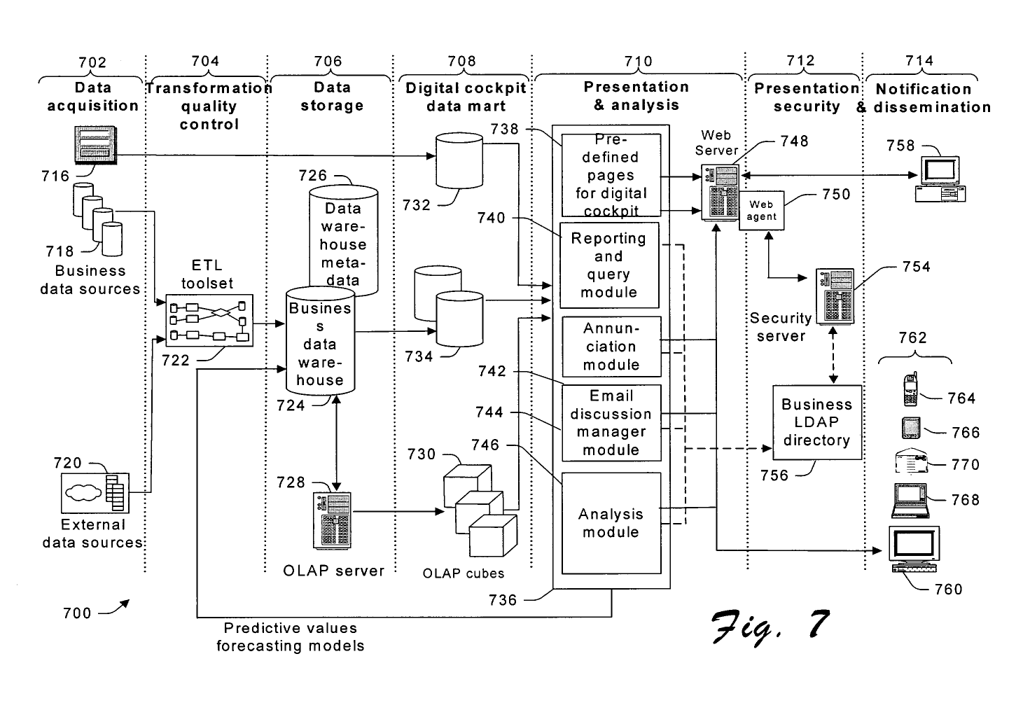

B. General Digital Cockpit Architecture (with Reference to FIG. 7).

FIG. 7 shows an exemplary architecture system 700 for implementing the digital cockpit. The system includes a series of stages (702-714). A data acquisition stage 702 represents the systems and functionality used for providing relevant data for use by the digital cockpit. A transformation quality control stage 704 represents the systems and functionality used for transforming the collected data into a desire form. A data storage stage 706 represents the systems and functionality used for storing the data collected in the previous stage 704 (and the systems required to perform this task). A digital cockpit data mart stage 708 represents the systems and functionality for culling and storing a subset of the data stored in the data storage stage 706. A presentation and analysis stage 710 represents the systems and functionality used for performing various tasks pertaining to the collection of data, such as various analysis and notification tasks. A presentation and security stage 712 represents the systems and functionality used for ensuring the security of collected information. Finally, a notification and dissemination stage 714 represents systems and functionality used for forwarding information to users in a variety of different formats depending on the users' respective information access devices. The modular design of the system 700 has numerous advantages. For instance, the modular approach facilitates making various changes to the system as the needs of the business evolve. Each of the stages will be described in further detail below.

The data acquisition stage 702 generally represents the systems and functionality for providing information from a number of different sources. Such sources may include a forms source 716 which provides forms data for use by the digital cockpit in processing data or presenting data to users. Another source may consist of a business data source 718. This source 718 may represent information culled from the data stores internal to the business (or, if the business has multiple affiliated companies, this source may represent information culled from the data stores of any of these affiliated companies). More specifically, businesses typically maintain various digitized records related to their normal operations. Business data source 718 may represent such information. Another source may consist of external data sources 720. This source 720 may comprise a wide variety of data culled from sources external to the business, such as various industry-specific clearing houses, the Internet, or other external sources. For instance, such information may comprise market-related data, such as interest rates, etc. Generally, a premium is placed on providing the most current and accurate data possible, and refreshing (updating) this data as often as is practical.

The transformation quality control stage 704 performs the task of extracting information from the data sources shown in the data acquisition stage 702 and performing various operations on the extracted data. More specifically, the operations performed by the transformation quality control stage 704 may include one or more of the following operations: 1) performing data selection and extraction from the internal or external data sources (718, 720); 2) performing quality assurance on the extracted data to ensure adherence to pre-defined guidelines, such as various expectations pertaining to the range of data, the validity of data, the internal consistency of data, etc; 3) performing data mapping and transformation, such as mapping identical fields that are defined differently in separate data sources, eliminating duplicates, validating cross-data source consistency, providing data convergence (such as merging records for the same customer from two different data sources), and performing data aggregation and summarization; 4) performing post-transformation quality assurance to ensure that the transformation process does not introduce errors, and to ensure that data convergence operations did not introduce anomalies; and 5) loading of the data into data warehouse in a format compatible with the storage devices used by the data storage stage 702. Toolset 722 performs the above-identified functions of extracting, transforming, and loading, and hence it is referred to henceforth as ETL toolset 722. The ETL toolset 722 may specifically comprise multiple different selectable tools for performing ETL operation. Various commercial tools can be used in the ETL toolset 722. For instance, the ETL toolset can include one of the tools provided by Informatica Corporation of Redwood City, Calif., and/or one of the tools provided by DataJunction Corporation of Austin, Tex. Still other tools can be used in the ETL toolset 722, including tools specifically tailored by the business to perform unique in-house functions.

The data storage stage 706 receives extracted data from the transformation quality control stage 704 in series or in parallel, and then stores this in one or more data storage devices. For instance, the data storage stage 706 may provide a business data warehouse 724 for storing the data. The data warehouse 724 may represent one or more storage devices; if multiple storage devices are used, these storage devices can be located in one central location or distributed. Generally, the data warehouse 724 captures, scrubs, summarizes, and retains the transactional and historical detail necessary to monitor changing conditions and events within the business. The data storage stage 706 may also include a data storage device 726 for storing metadata for use in the data warehouse 724. Metadata refers to high-level information regarding information stored in the data warehouse 724. For instance, this metadata may includes information regarding the origin of information stored in the data warehouse 724, the definition of such data, the data type of such information, the transformations performed on such data, etc. Metadata can also include a summarization of information stored in the data warehouse 726. The data warehouse 724 and the metadata data storage 726 can employ any can kind of storage strategy, such as relational storage strategy. Various known commercial products can be used to implement the data warehouse 724 and the metadata storage 726, such as various data storage solutions provided by the Oracle Corporation of Redwood Shores, Calif.

The data storage stage 706 also includes an On-Line Analytical Processing (OLAP) server. An OLAP server 728 provides an engine that is specifically tailored to perform data manipulation of multi-dimensional data structures. Such multi-dimensional data structures arrange data according to various informational categories (dimensions), such as time, geography, etc. The dimensions serve as indices for retrieving information from a multi-dimensional array of information, such as so-called OLAP cubes (such as cubes 730 provided in the digital cockpit data mart stage 708). More specifically, the OLAP server 728 constructs and maintains multiple subject-area cubes of information within the digital cockpit data mart stage 708, each cube being targeted for a particular user community or analytic need. Generally, OLAP functionality is commonly used in business enterprises to facilitate drill-down analysis of information stored in a data warehouse, historical trending analysis, and so-called slicing and dicing of information to provide a desired subset of information within the data warehouse. The OLAP server can also perform a variety of transforms on the collected data, including various mathematical, logical, or business rule transforms, various statistical regressions, time series forecasting, discrete event simulations, dynamic simulations, Monte Carlo simulations, single and/or multifactor linear analyses, stochastic and dynamic optimizations, neural nets computations, and various types of decisioning analyses, etc.

The digital cockpit data mart stage 708 (referred to below for brevity as simply a “data mart stage”) culls a specific set of information from the data storage stage 706 for use in performing a specific subset of tasks within the business enterprise. For instance, the information provided in the data storage stage 706 may serve as a global resource for the entire business enterprise. The information culled from this data storage stage 706 and stored in the data mart stage 708 may correspond to the specific needs of a particular group or sector within the business enterprise. Culling this subset of information helps reduce the amount of data requests to the data storage stage 706, and thus helps reduce the data traffic in this stage 706. The specific data storage devices included in the data mart stage 708 may include a storage device 732 for storing forms data, a storage device 734 for generally receiving a subset of information from the data warehouse 724, and information formulated in one or more OLAP cubes 730. Although the data mart stage 708 is functionally separate from the data storage stage 706, both these stages can be implemented in the same geographic location, and possibly by a single storage system. Alternatively, the data mart stage 708 can be implemented as a storage system which is distinct from the data storage stage 706. If an end-user drills down to a level of detail that is not supported in the data mart stage 708, then the system 700 may grant the user permission to access additional information from the data storage stage 706 (if the user is so authorized). Finally, the data mart stage 708 also may provide a storage section for storing rules used for triggering various actions in the system 700. These rules can take the form of a simple numerical tests (e.g., by comparing conditions to various threshold levels), or can take the form of more complex rule-based protocols.

The presentation and analysis stage 710 represents the heart of the data manipulation tasks performed by the system 700. This stage 710 includes a collection of processing modules 736 for performing various tasks. In one implementation, a single computing system implements all of these modules 736 (where each module represents different software functionality installed on the system). In another implementation, different computing systems can be allocated to one or more of the processing modules 736.

A first module 738 presents pre-defined pages for the digital cockpit, and can perform other presentation-related tasks. These pages determine the layout of information presented in the cockpit interface. A second module 740 provides ad-hoc reporting, query, and OLAP functionality. This module 740 generally provides functionality which allows a user to enter queries using a variety of input parameters and input strategies. This module 740 also provides a mechanism that allows a user to view information in a specified informational dimension, and then drill-down or drill-up to receive more fine-grained information or less fine-grained information, respectively.

An annunciation module 742 provides functionality for notifying users of various events. An exemplary event may pertain to the occurrence of an alarm condition within the business, such as a perceived deficiency in one or more business metric values. The annunciation module can use any kind of strategy for deciding when to deliver such notifications. For instance, the module 742 can rely on the human judgment of a business analyst in deciding when to the issue notifications. Alternatively, the annunciation module 742 can use automated mechanisms in deciding when to deliver notifications (such as various rule-based trigger mechanisms). The annunciation module 742 also performs various managerial tasks associated with its notification role.

An email discussion manager module 744 allows an individual within the business to send an email to one or more other individuals within the business regarding, for instance, the topic of business metrics. For instance, an individual can send an email message to a person within the business closely associated with a particular business metric (referred to as a “metric owner”). This email message asks the metric owner for information regarding the metric, etc. This allows the metric owner and potentially other associated business team members to respond to the question via a threaded discussion paradigm. The messages are threaded in the sense that transmitted emails regarding a particular metric topic are linked together for convenient review. The email discussion manager module 744 also allows a metric owner to proactively enter a comment or explanation and associate it with a metric for subsequent viewing by other individuals in the business. Further still, this module 742 enables the aggregation and summarization of comments associated with different business metrics.

Finally, an analysis module 746 performs a wide variety of analytical tasks using data collected using the system 700. For instance, this module 746 may develop information pertaining to the past course of the business operation, as well as its present state. The analysis module 746 may also develop information pertaining to the projected future course of the business operation. The analysis module 746 can also support what-if analysis, where the analysis module 746 generates predictions in response to a user's specifications of input conditions. Various known modeling techniques can be employed to perform these analysis tasks provided by the analysis module 746, including regression analysis, time-series computations, cluster analysis, simulation, etc. A variety of commercially available packages can implement the above-described modeling tasks. To name but a small sample, the analysis module 746 can use one or more of the family of Crystal Ball products produced by Decisioneering, Inc. of Denver Colo., one or more of the Mathematica products produced by Wolfram, Inc. of Champaign Ill., one or more of the SAS products produced by SAS Institute Inc. of Cary, N.C., etc. The architecture of the analysis module is explored in much greater detail in Section D of this disclosure.

The processing modules 736 forward the results of their respective processing to users via a suitable web-enabled computing system, such as a web server 748. Any suitable system can be used to provide this functionality, such as the server functionality provided by iPlanet, now produced by Sun Microsystems, Inc., of Santa Clara, Calif. The web server 748 functions in conjunction with web agent 750 in a conventional manner. More specifically, the web server 748 can be implemented as an Internet web-enabled server, or an intranet-enabled server. In alternative embodiments, other types of networks can be used to deliver cockpit-related information, such as LAN networks, various wireless networks (e.g., radio communications networks), etc.

The processing modules 736 may also transmit calculated results back to the business data warehouse 724 for storage at that location. Loop 752 generally represents the transfer of calculated information back to the data warehouse 724. Such fed-back information may include the results of predictions as well and other associated information. The storage of such information supplements and enhances the raw data collected in the transformation quality control stage 704 to provide an enhanced knowledge base regarding the past and future behavior of the business.

The presentation and security stage 712 represents various systems and functionality for ensuring that confidential information is restricted to appropriate recipients. For instance, a security server 754 may grant access to its data as a function of the role of the recipient within the business. For example, the security server 754 may allow high-level managers to view a wide range of information, but may restrict certain information from lower level employees. In still another implementation, the security server 754 grants access to users depending on their roles on a page-by-page basis, where each page of a user interface display has a different security level associated therewith. In performing authentication, the security server 754 may draw from the Business Lightweight Director Access Storage Protocol (LDAP) directory 756. This directory 756 stores information regarding the access rights of different users. More specifically, the LDAP directory 756 stores user profiles and user identification information. (Of course, other known security arrangements can be used here as well, such as biometric locks, etc.).

Finally, the notification and dissemination stage 714 represents systems and functionality for the forwarding of digital cockpit-related information to users in a variety of formats. For instance, the user may receive the cockpit information using a variety of general or special purpose computing devices 758, 760. The presentation and analysis stage 710 may alternatively format the cockpit information for presentation using a variety of other devices 762, such as a cellular telephone 764, a Personal Data Assistant device 766, a laptop computing device 768, etc. Finally, the presentation and analysis stage 710 may generate various printed reports containing cockpit information and forward such information to the recipients using other conventional dissemination techniques, such as by forwarding the cockpit information via conventional mail 770.

Although not specifically illustrated in FIG. 7, the system 700 may include an overarching control stage that serves to coordinate the operations performed in different stages, as well as perform general high-level control functions.

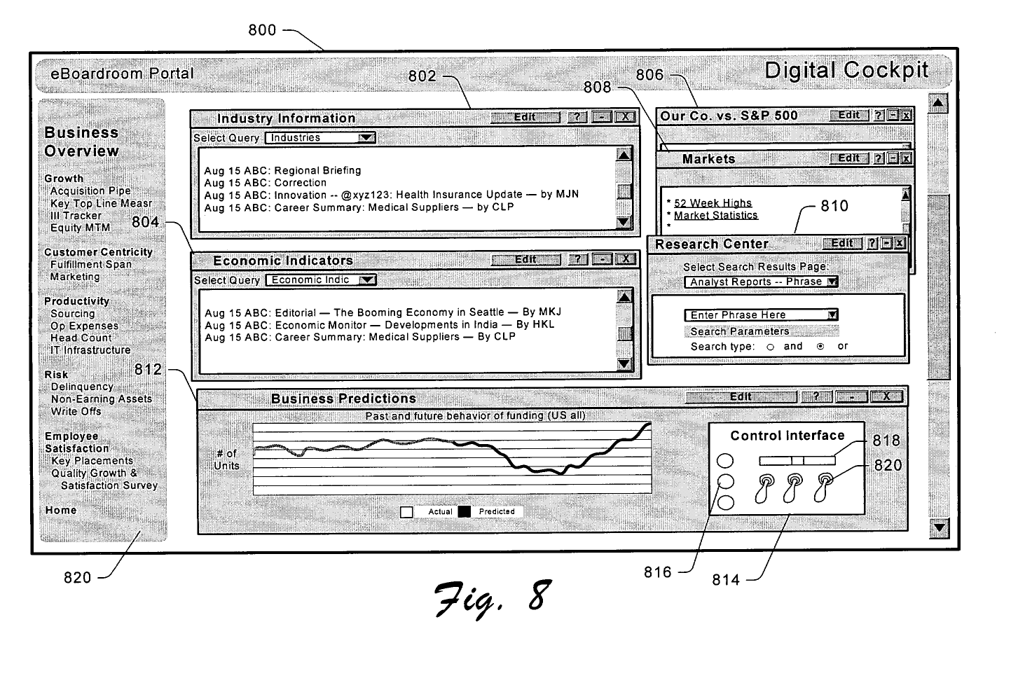

C. Exemplary Digital Cockpit User Interface (with Reference to FIGS. 8-14).

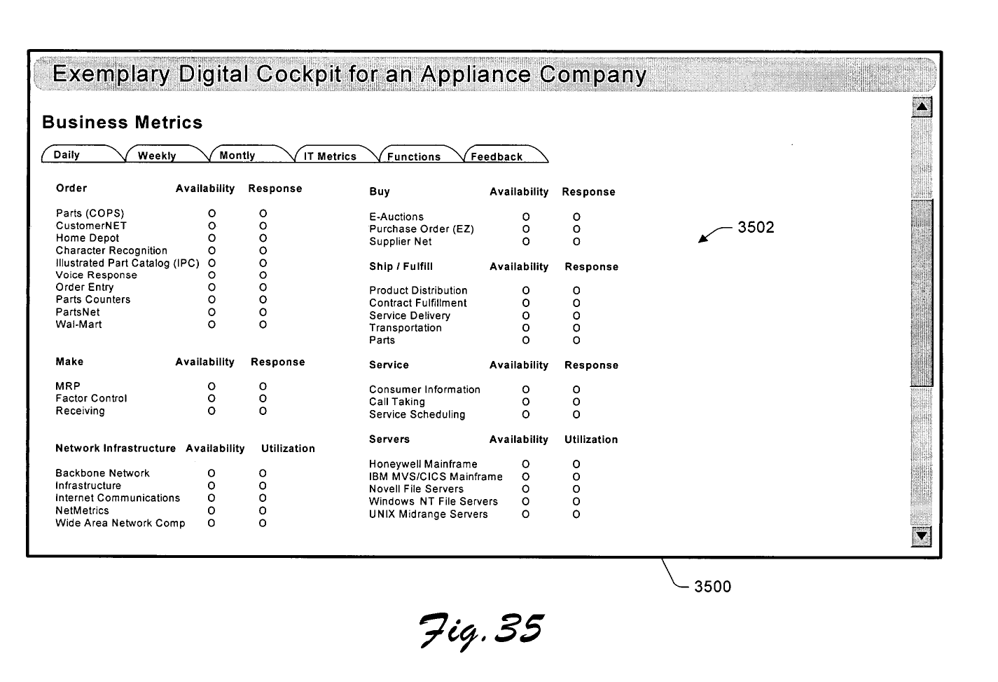

FIGS. 8-14 show features of an exemplary digital cockpit interface. Of course, the information presented in a digital cockpit display will be tailored to the specific needs of a particular business. As such, the type of information shown in these figures is merely illustrative of the range of information that can be included in a digital cockpit display. Also, since the business environment greatly influences the kinds of information presented in a cockpit display, the following discussion points out only certain high-level functional aspects of the cockpit displays. Numerical values are denoted with x's (or simply removed) to facilitate discussion. FIGS. 35-54 provide yet more examples of cockpit displays that can be used in various business contexts. These figures are discussed in Section F of this patent disclosure.

To begin with, FIG. 8 shows a first digital cockpit page 800 including a variety of windows for presenting information pertaining to the operation of an exemplary business environment. Window 802 provides information regarding events within a selected industry, which may provide valuable insight into the activities of a business's competitors. Window 804 provides information regarding a selected economic indicator. Window 806 provides information regarding the performance of a particular business with respect the S&P 500 benchmark (or other established economic benchmark). Window 808 provides additional information regarding financial markets. Window 810 provides an interface for allowing a user to enter queries and retrieve general information of interest, such as various analyst reports of interest.

Window 812 provides information regarding business predictions. In the exemplary implementation shown in FIG. 8, the window 812 shows past and future behavior of funding. Accordingly, this window 812 presents information relevant to both the past course of the business as well as its projected future course. In one implementation, the digital cockpit generates the predicted information shown in window 812 automatically, for instance, at scheduled times. In other implementations, the digital cockpit may generate these predictions in response to the user's selection of various input factors (such as various “what-if” input selections). Although not shown, the window 812 can also provide confidence bands associated with the predicted values, such as in a manner analogous to chart 136 of FIG. 1. Such confidence bands can be calculated using known statistical methods.

Control interface 814 represents an exemplary portal which allows a user to enter such what-if selections. As shown there, the control interface 814 includes a variety of known user interface input mechanisms, such as various graphical knobs 816, a graphical slide bar 818, graphical toggle switches 820, etc. Of course, this is only a representative sample of the many possible input mechanisms that can be used.

Control interface 814 may also provide a portal which allows a user to make various changes to the business process in response business decisions made after viewing the information shown in FIG. 8. Insofar as the business employs automated processes, these changes made through control interface 814 may automatically prompt the modification of these processes without human intervention. Such changes may be transmitted through electronic channels, such as a computer network coupling the digital cockpit to the targeted business processes (and related subsystems). The changes may results in the modification of input data sent to program modules or the modification of the program modules themselves, etc. In other cases, the business may not rely on automation to affect its business process. In this case, the control interface 814 may generate instructions using more conventional mechanisms, such as by sending emails to various individuals within the business instructing these individuals to make changes in the business processes. Still other control coupling strategies are possible depending on the characteristics of a particular business operation.

Finally, menu field 820 allows a user to advance to other pages of the cockpit presentation, such as pages pertaining to categories of growth, customer centricity, productivity, risk, employee satisfaction, etc. Although not shown, this display page 800 can also provide an indication of the last date (and time) that the cockpit page 800 was modified.

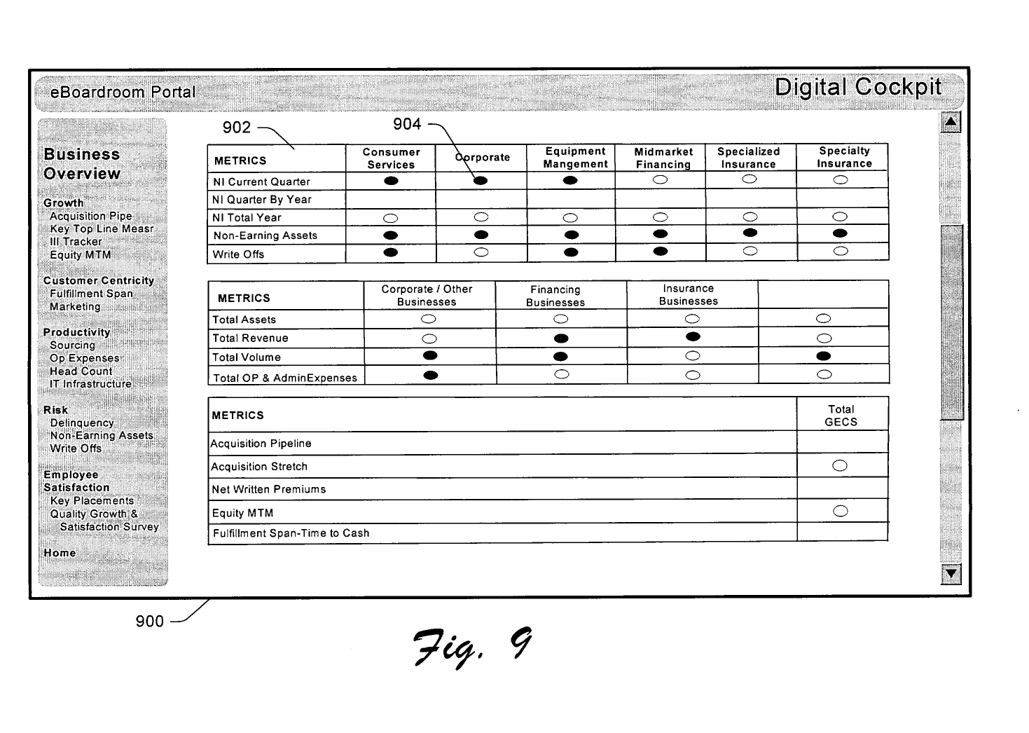

FIG. 9 provides another exemplary digital cockpit display page 900. This page 900 provides a summary of various metrics pertaining to a business. More specifically this page 900 provides various metrics (e.g., metrics 902) for different business groups or companies within a business enterprise. The “traffic light” type indicators (e.g., indicator 904) provide information regarding the status of these different business groups within the enterprise with respect to the identified metrics. For instance, “red” might indicate that there is a problem, yellow might indicate that there is a warning level associated with the business, and green might indicate that there is no assessed problem.

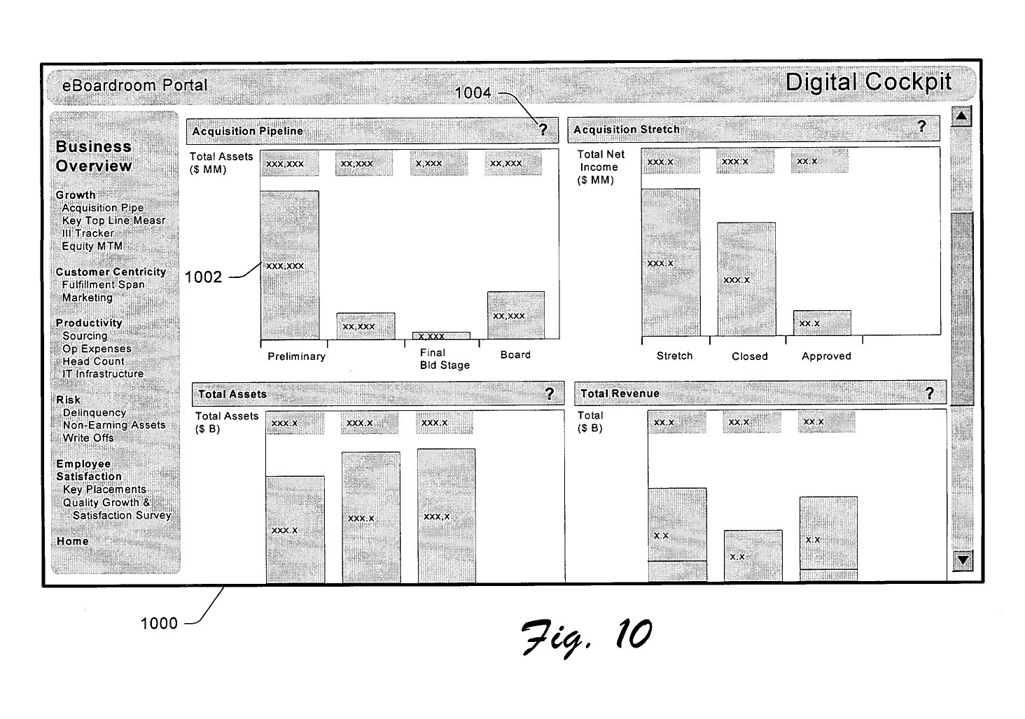

FIG. 10 provides another exemplary digital cockpit display page 1000. This page 1000 shows additional information regarding the performance of a business in bar chart form (e.g., via bar chart display 1002). More specifically, this page 1000 provides information regarding total assets in an acquisition pipeline, etc. A user may further drill down to segment and business levels to receive additional information regarding the performance of the business. Activating the question mark “?” 1004 prompts the digital cockpit to provide additional information regarding each metric.

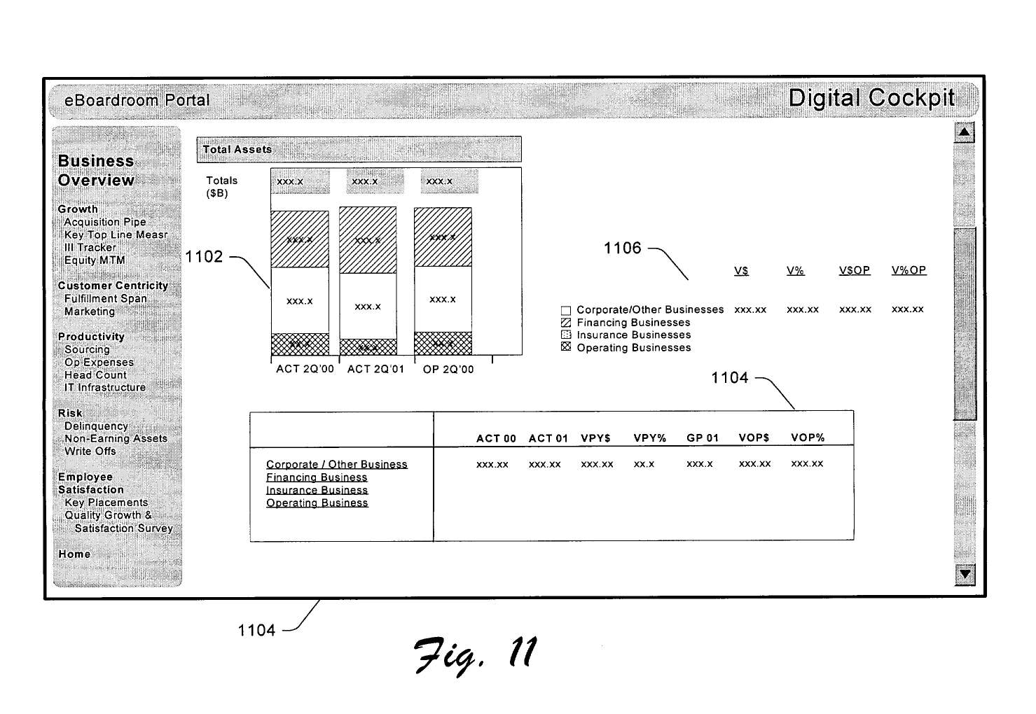

FIG. 11 provides another exemplary digital cockpit display page 1100. This page 1100 provides a bar chart 1102 showing total assets for various segments and business levels. The table 1104 provides detailed information to support the information presented graphically in the bar chart 1102. Field 1106 provides information regarding performance variations with respect to a prior reporting period.

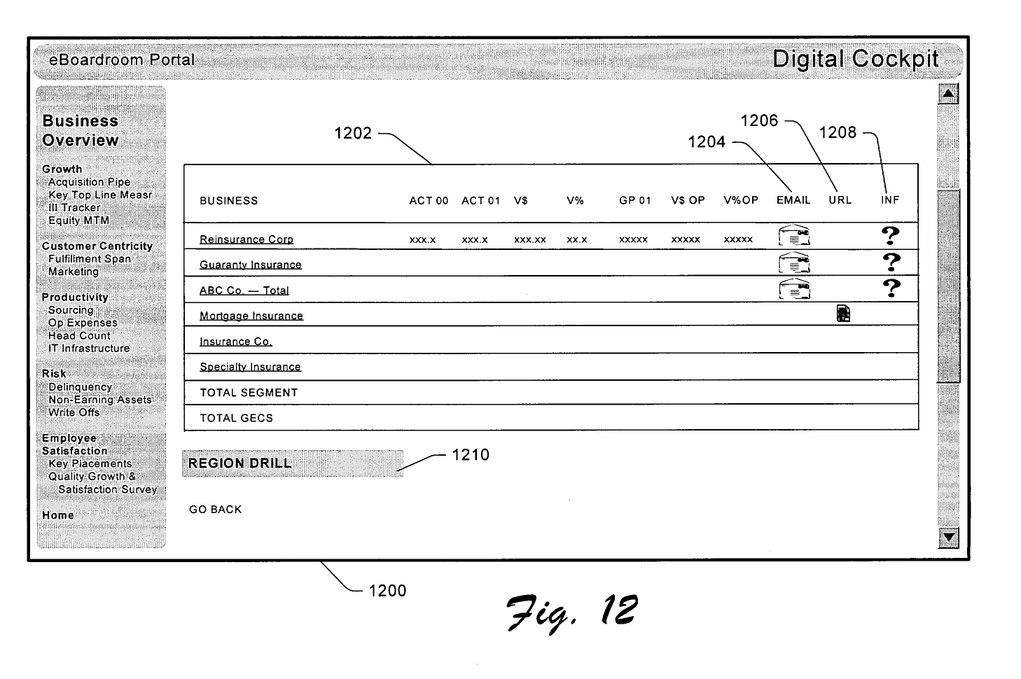

FIG. 12 provides another exemplary digital cockpit display page 1200. This page 1200 provides a table 1202 that provides still additional overview information regarding the performance of various business groups within a business enterprise. The table also includes a field that allows a cockpit user to send a metric owner email messages (e.g., to send queries regarding the metric). Field 1206 provides a link to additional cockpits pages to provide further business details. Field 1208 provides functionality for allowing a cockpit user to proactively enter explanations regarding a metric. Field 1210 allows a user to drill down by country or by region to provide more fine-grained information regarding the performance of the business enterprise.

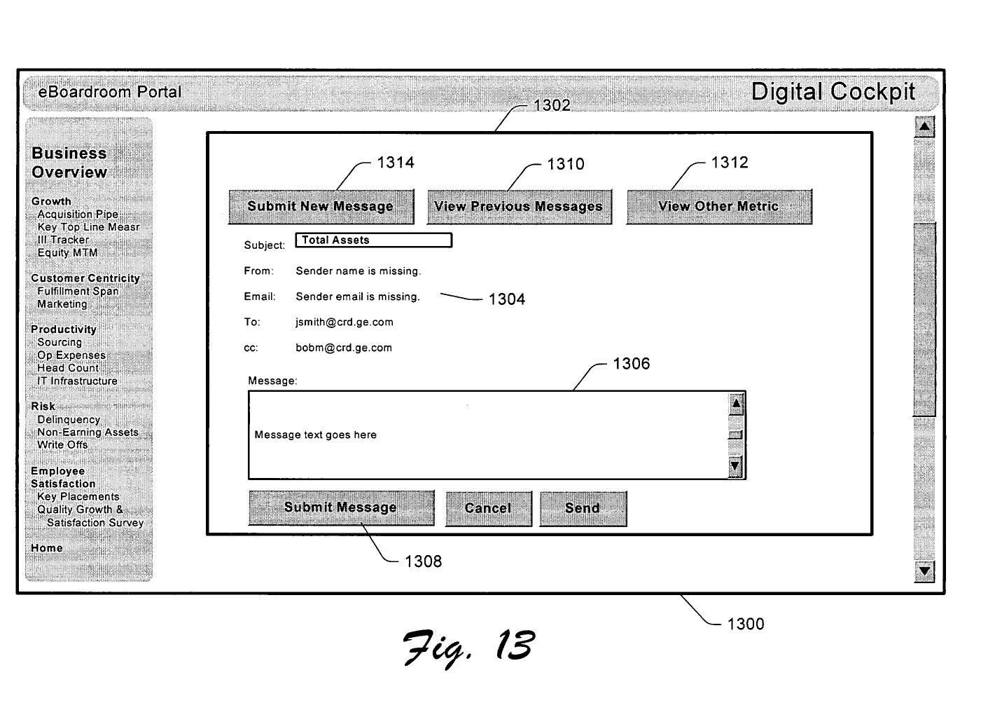

FIG. 13 provides another exemplary digital cockpit display page 1300. This page 1300 provides an interface 1302 which allows a cockpit user to send an email to a metric owner. The interface 1302 may pre-populate various fields 1304 with known information, such as the sender, recipient, metric information (e.g., “total assets”), etc. Such information regarding data owners and other information may be stored in the data warehouse 724. Field 1306 defines an entry box for entering a message. Field 1308 instructs the interface 1302 to transmit the email message to the metric owner. A graphical button 1310 allows the cockpit user to view previous messages regarding a metric. A graphical button 1312 allows a user to view messages pertaining to additional metrics. A graphical button 1314 allows a user to submit a new message regarding a metric.

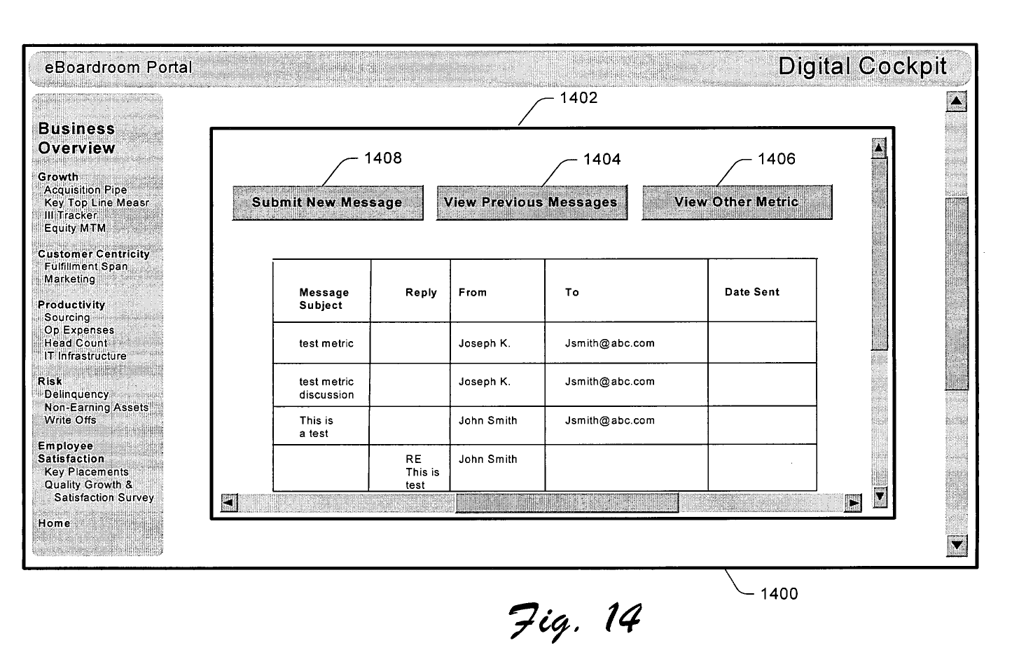

Finally, FIG. 14 provides yet another exemplary digital cockpit display page 1400. This cockpit display page 1400 provides overview information 1402 regarding email communications that have taken place regarding various business metrics. This page specifically identifies communication regarding business metrics by identifying the metric that is being discussed, the sender of a communication, the recipient of the communication, the date sent, etc. A graphical button 1404 allows the cockpit user to view previous messages regarding a metric. A graphical button 1406 allows a user to view messages pertaining to additional metrics. A graphical button 1408 allows a user to submit a new message regarding a metric.

D. The Predictive Digital Cockpit Subsystem

D.1. Predictive Digital Cockpit Architecture Design (with Reference to 15-18).

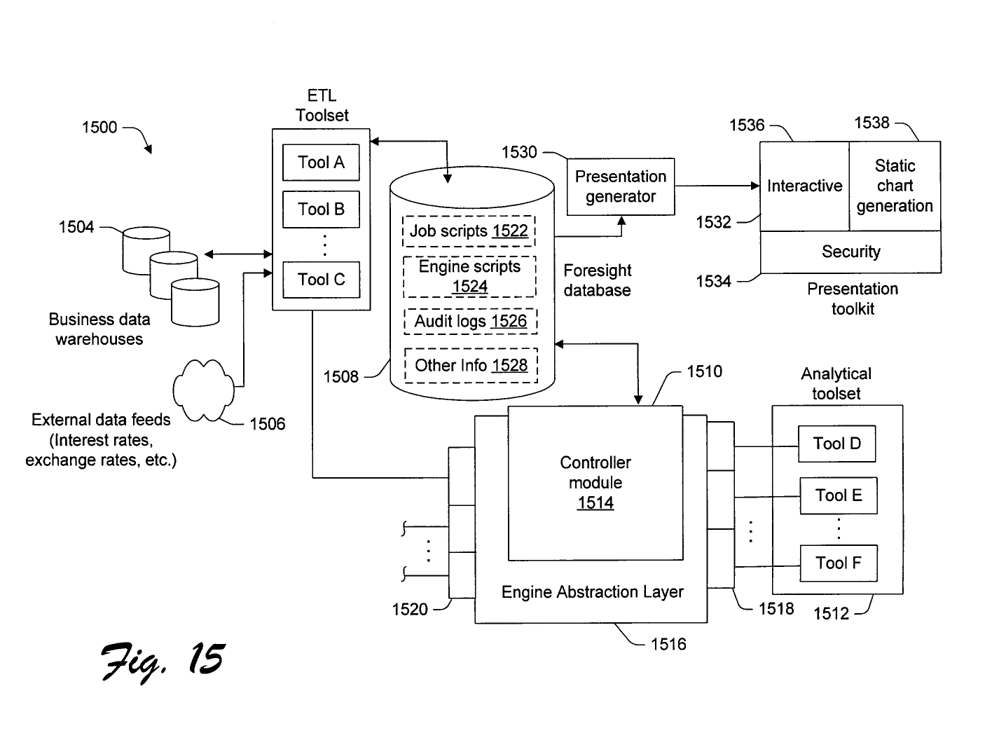

As discussed, a portion of the general digital cockpit architecture shown in FIG. 7 can be used to perform predictive analysis. This predictive analysis provides insight into the projected course of a business operation in the future, or enables various what-if queries. Namely, the analysis model 746 shown in FIG. 7 performs this task in cooperation with other features of FIG. 7. FIG. 15 shows a system 1500 that further drills down on the system shown in FIG. 7 to provide additional detail regarding the predictive features of the architecture.

The ETL toolset 1502 performs the same kind of functions identified above with respect to the ETL toolset 722 shown in FIG. 7. More specifically, the ETL toolset 1502 extracts data from various business data warehouses 1504 and external data feeds 1506 (corresponding generally to sources 718 and 720, respectively, of FIG. 7), cleans this data, transforms this data into a desired form, and then loads this data into the a foresight data base 1508. As shown in FIG. 8, the ETL toolset 1502 may include multiple different tools (tool A, tool B, tool C) for performing extract, transform, and load operations. For instance, tool A may be implemented using an ETL tool provided by Informatica, while tool B can be implemented using an ETL tool provided by DataJunction. The use of different ETL tools within toolset 1502 enhances the flexibility of the system 1500 in handling ETL tasks. The Foresight database 1508 may generally correspond to the data warehouse 724 shown in FIG. 7, or alternatively, a part of the data warehouse 724.

A controller 1510 and associated analytical toolset 1512 perform various analysis tasks on the data stored in the Foresight database 1508, and store results back into the Foresight database 1508. More specifically, the analytical toolset 1512, like the ETL toolset 1502, may include a variety of tools (tool D, tool E, tool F) for performing analysis. For example, a tool D can be implemented using a predictive tool provided by Mathematica. Tool E can be implemented using a predictive tools provided by Crystal Ball. Tool C can be implemented using a predictive tool provided by SAS. Again, the use of multiple tools enhances the flexibility of the digital cockpit design. Typically, the capabilities of different tools do not completely overlap. As such, a business analyst may find it desirable to use one kind of tool to perform a certain analysis task, and another kind of tool to provide another kind of business analysis task.

The controller 1510 itself may comprise any kind of general purpose or specialized computing device. The controller may be conceptualized as including a control module 1514 and an abstraction layer 1516. The control module 1514 generally represents the high-level functional control aspects of the tasks carried out by the controller 1510. The engine abstraction layer 1516 provides a generic interface for interacting with different analytical tools in the analytical toolset 1512 and the ETL toolset 1502. This generic interface of the abstraction layer 1516 is generally represented by interface 1516 for interacting with the analytical tools in the analytical toolset 1512 and interface 1520 for interacting with different ETL tools in the ETL toolset 1502. These interfaces (1518, 1520) effectively act as a go-between in the interaction between the controller module 1514 and the individuals tools in the analytical toolset 1512 and the ETL toolset 1502. Namely, the different analytical tools in the analytical toolset 1512 and the ETL toolset 1502 generally do not have identical input and output requirements. The engine abstraction layer 1516 (via its interfaces 1516, 1518) receives general instructions from the controller module 1514. These instructions may require the use of a particular tool, but these instructions are not specifically tailored to this particular tool. The abstraction layer 1516 therefore takes the controller module's instructions and interacts with the required tool to coordinate performance of the desired task. When the tool is finished performing its task, the abstraction layer 1516 takes the results of the tool and forwards the results to an appropriate location (such to the Foresight database 1518 for storage therein). The use of an engine abstraction layer 1516 therefore effectively insulates the controller module 1514 from the uniqueness of the tools used in system 1500. This, in turn, has a number of benefits. For instance, a business analyst can modify a tool or replace a tool with another tool without requiring detailed modifications to the code used by the controller module 1514 itself. In other words, the use of the abstraction layer 1516 results in a modular plug-in design in the system 1500.

The Foresight database 1508 includes a number of tables that will be better understood as the discussion progresses. For the time being, the Foresight database 1508 includes a first table 1522 that stores job scripts. A job refers to a series activities involved in executing a model. A model, in turn, refers to some kind of function involved in processing information for presentation at the digital cockpit user interface. For instance, a job script might be used to implement any of the transfer functions shown in FIGS. 2-6, where these transfer functions also constitute models. Such a job script might involve both ETL-related activities and data analysis activities, and accordingly, the job script will include instructions to carry out these separate activities. In one embodiment, these job scripts comprise extensible markup language (xml) documents containing xml-coded instructions. The Foresight database includes another table 1524 for storing engine scripts. These scripts provide instructions for use by the ETL tools and the analytical tools in carrying out their respective functions. The Foresight database 1508 also includes an audit log 1526. The audit log 1526 stores information regarding jobs that were run, including individual activities within jobs that were run. Further details regarding the specific information stored in the audit log 1526 will be provided in Section E of this disclosure. Finally, the Foresight database 1508 stores a variety of other information 1528. Such other information 1528 may include metadata associated with jobs, such as job version information, which will also be discussed in further detail in Section E.

A presentation generator 1530 generally comprises presentation functionality associated with the presentation and analysis stage 710 of FIG. 7. Namely, the presentation generator 1530 presents various prediction results to a user in an appropriate cockpit presentation format. A presentation toolkit 1532 provides additional presentation-related features. For instance, the presentation toolkit 1532 includes presentation security functionality (generally corresponding to the presentation security stage 712 of FIG. 7). The presentation toolkit 1532 also includes functionality 1536 for presenting static chart information to a user and functionality 1538 for presenting an interactive display to the user. As the names suggest, a static chart does not allow for user interactivity (e.g., its presentation is fixed). An interactive display allows for user interactivity, allowing a user to view a particular information presentation, request additional information through cockpit interface, and receive such additional information.

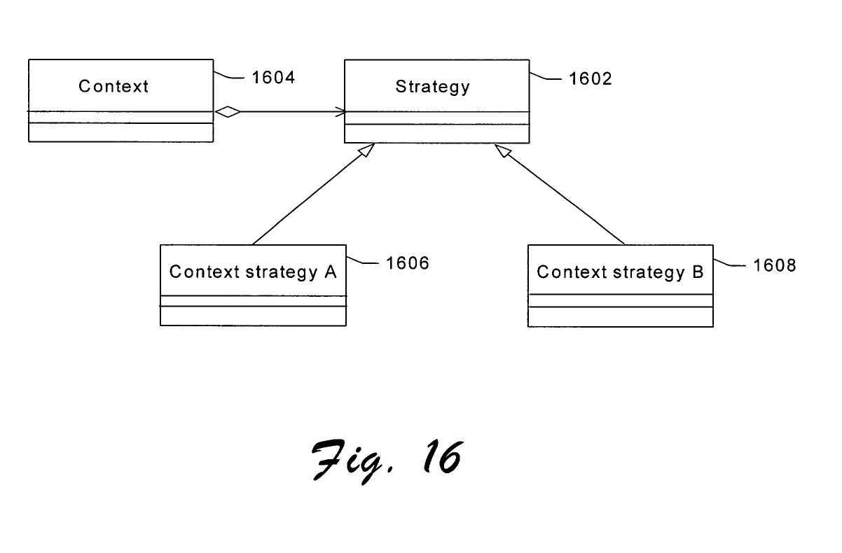

FIGS. 16-18 provide additional information regarding the design of the engine abstraction layer 1516 shown in FIG. 7.

To begin with, some background on the concept of strategy patterns is provided. Generally, there are certain “good strategies” for performing computing tasks in different contexts. Accordingly, these good strategies appear with some frequency in different applications. The common features of these strategies can be identified and abstracted as a general class. Such general class forms a strategy pattern. For example, FIG. 16 illustrates the concept of strategy patterns. As indicated there, a general class of strategy 1602 can be formulated for a specified context 1604. Two specific strategies, strategy A 1606 and strategy B 1608, provide specific implementations of the general class of strategy 1602. In an actual implementation, high-level aspects of an object-oriented program (e.g., the client application) can interact with a specific strategy (e.g., strategy A 1606 or strategy B 1608) through the formalism of the general strategy class 1602. Doing so effectively insulates the client application from the particulars of the specific strategies (strategies 1606 or 1608). This has the further benefit of allowing changes to be made to the specific strategies without necessarily directly impacting the client application. Additional information regarding so-called design patterns may be found in Gamma et al., Design Patterns, Addison-Wesley Pub. Co, 1995.

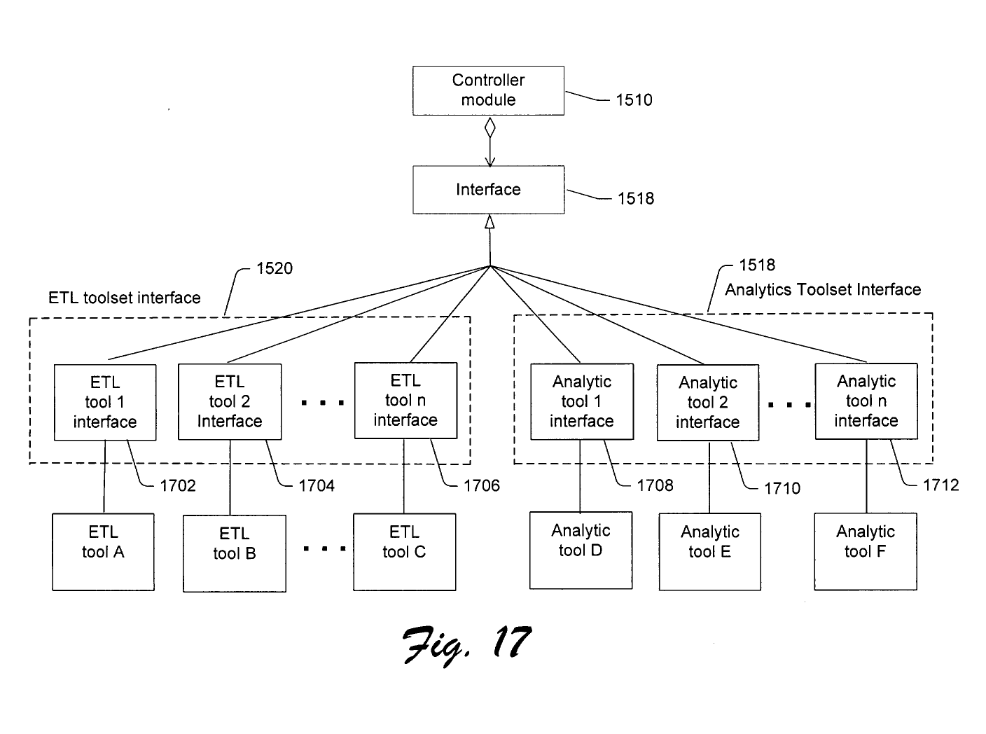

FIG. 17 shows how this concept is employed in the digital cockpit. Namely, this figure shows how the controller module 1514 interfaces with various ETL and analytical tools via the abstraction layer 1516 (also called the interface). The abstraction layer 1516 includes an ETL toolset interface 1520 that includes specific interfaces (1702, 1704, 1706) for interacting with respective ETL tools (tools A, B, and C). The abstraction layer 1516 also includes an analytics toolset interface 1518 that includes specific interfaces (1708, 1710, 1712) for interacting with respective analytical tools (tools D, E, and F). This design effectively insulates the controller module 1514 from the specific requirements of the individual tools.

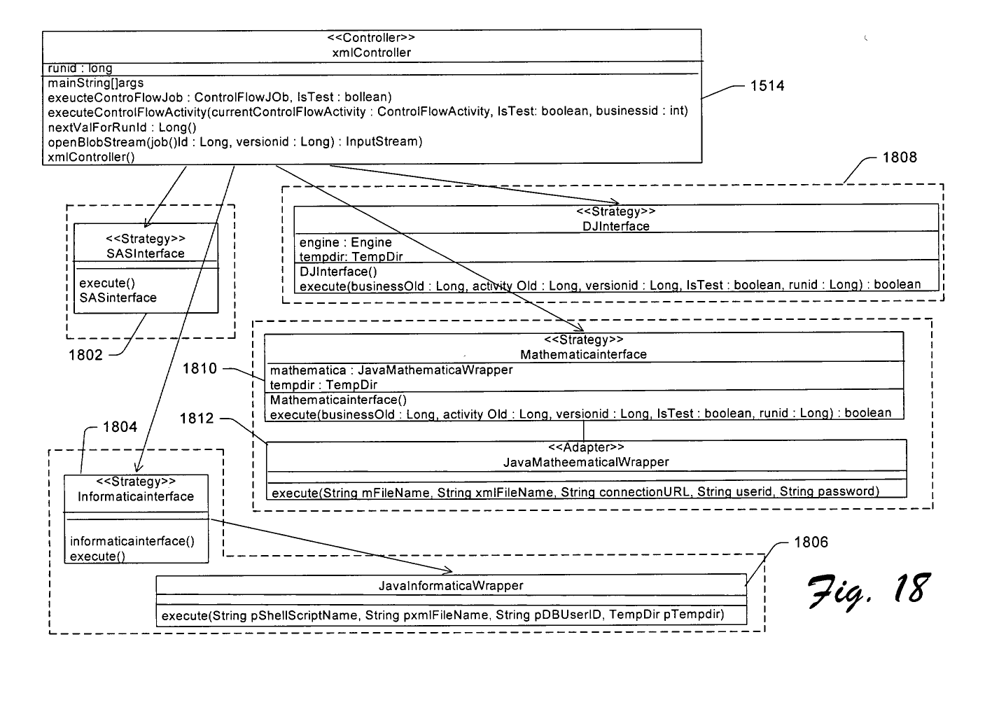

FIG. 18 shows a more detailed explanation of the application of the strategy pattern concept to the design of a predictive digital cockpit. In this figure the controller module 1514 (here referred to as “xmlcontroller”) is shown interfacing with a variety of interfaces associated with specific tools. For instance, the controller module 1514 can interface with a SAS interface 1802, which provides interaction between the controller module and a SAS analytical tool. The controller module 1514 can interface with an Informatica interface 1804 which provides interaction between the controller module 1514 and the Informatica analytical tool via a wrapper class. The controller module 1514 can interface with a DataJunction interface 1808, which provides interaction between the controller module 1514 and a DataJunction analytical tool. And finally, the controller module 1514 can interface with a Mathematica interface 1810, which provides interaction between the controller module 1514 and a Mathematica tool. The selection of tools in this figure is of course exemplary. A particular business application may warrant the selection of a different grouping of ETL and analytical tools, or may warrant designing custom tools specifically tailored to a business's needs.

The wrapper classes 1806 and 1808 represent additional layers of insulation between the controller module 1510 and the Informatica tool and the Mathematica tool, respectively. For instance, the Informatica wrapper 1806 receives a request from Information interface 1804 entity to perform an activity and tailors that request to a specific format required by the Informatica tool. The Informatica wrapper 1806 also coordinates the transfer of information from the Informatica tool to higher levels of the program. The individual series of instruction contained within each of the above-identified classes will become clearer in the context of the following discussion of the functional attributes of the predictive cockpit architecture. Generally, however, as can be seen from the programming notation shown in FIG. 18, one exemplary implementation of the digital cockpit is using object-oriented programming, and in particular, a Java-implemented object-oriented design solution. Java is an object-oriented language provided Sun Microsystems, Inc., of Santa Clara, Calif. However, any suitable programming technique can be used to provide the same general benefits illustrated in the figures.

D.2. Functional Aspects of the Predictive Digital Cockpit Architecture

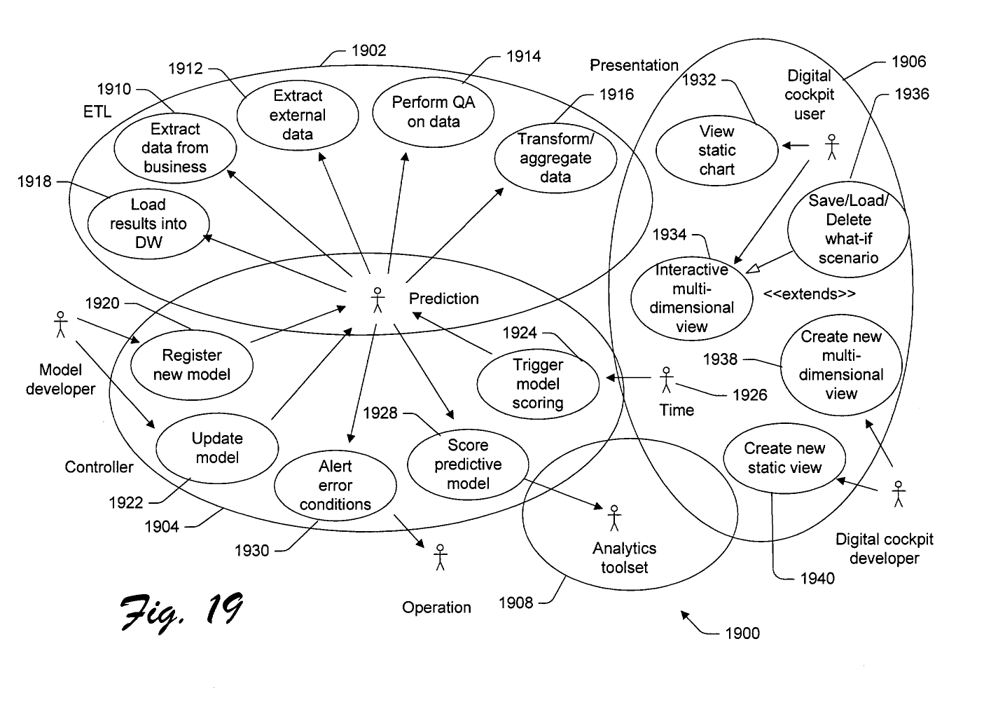

FIGS. 19-27 provide information regarding the functional aspects of the predictive digital cockpit architecture. To begin with, FIG. 19 shows a high-level Unified Modeling Language (UML) diagram 1900 showing the functions performed by different aspects of the predictive digital cockpit. This type of diagram is also called a Jacobson Use Case Model. More specifically, FIG. 19 groups these functions into four broad categories: functions 1902 associated with the ETL operation; functions 1904 associated with the controller 1510; functions 1906 associated with the presentation aspects of the digital cockpit; and functions 1908 associated with the analytics toolset. These functions are described with reference to various actors who are impacted by these functions (or who are the cause of such functions). An actor may comprise an actual human subject that interacts with the system, or may comprise a non-human system or abstract entity that interacts with the system.

The ETL series of functions 1902 includes functions that involves extracting data from the business sources (function 1910), extracting data from internal sources (function 1912), performing quality assurance operations on the data (function 1914), and transforming and aggregating the data (function 1916). The ETL series of functions 1902 also includes loading final results back to the business warehouse database (function 1918) (e.g., warehouse 724 shown in FIG. 7). These functions generally correspond to the ETL operations described in FIGS. 7 and 8, and thus will not be described again here.

The controller series of functions 1904 include functions that involve registering a new model and updating a new model (functions 1920 and 1922, respectively). As previously described, a model pertains to a technique for performing data manipulation tasks. The model is also referred to herein as a job. A job consists of series of activities for performing individual tasks within the job. The register new model function 1920 allows a model developer to add a new model to the Foresight database 1508. The update model function 1922 allows a model developer to modify and update a previously stored model in the Foresight database 1508.

The trigger model scoring function 1924 initiates the execution of a model (job). In one implementation, the model developer can configure the controller 1510 to execute the job at a specific time, such as once a day, once a week, etc. The use of chronological information to trigger the execution of a model is presented by showing the influence of an actor labeled time 1926 on the trigger model scoring function 1924. In another implementation, a model developer can configure the controller 1510 such that the model executes in response to the specific request of a business analyst. Still alternatively, the model developer can configure the controller 1510 such that model executes in response to a change in input data that exceeds a prescribed threshold. Still other strategies governing the initiation of the execution of the models are possible. The function of scoring the predictive model (function 1928) pertains to the actual execution of the predictive model. The function of running the model requires interaction with the analytics toolset, and therefore FIG. 19 shows a link to the analytics toolset functionality 1908. Finally, the function of “alert error conditions” (function 1930) provides information to the model developer that indicates that an anomalous event has occurred in the performance of a model. This may prompt the generation of an email to an identified individual tasked with the responsibility of investigating and addressing the error.

The presentation series of functions 1906 includes a function for viewing a static chart (function 1932) and an operation for viewing an interactive multi-dimensional view chart (function 1934). The multi-dimensional view chart allows a user to interact with the digital cockpit by entering various requests for specific information, and subsequently receiving such additional information. For example, the multi-dimensional view chart allows a user to input various what-if scenario factors. This prompts the system to generate a predictive result based on the what-if scenarios. According to the function of save/load/delete (function 1936), a user may save an inputted scenario, load a previously stored input scenario, or delete a previously stored input scenario. The functions of creating a new multi-dimensional view (function 1938) and creating a new static view (function 1940) reflect the design operations performed by digital cockpit developer in creating such new views.

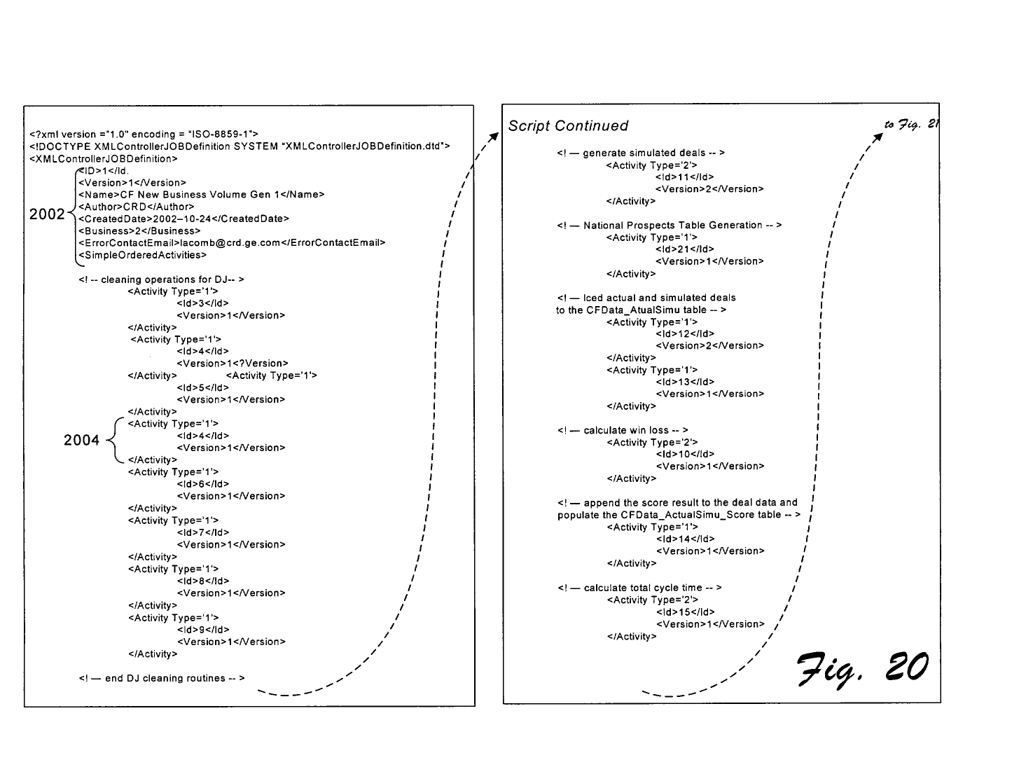

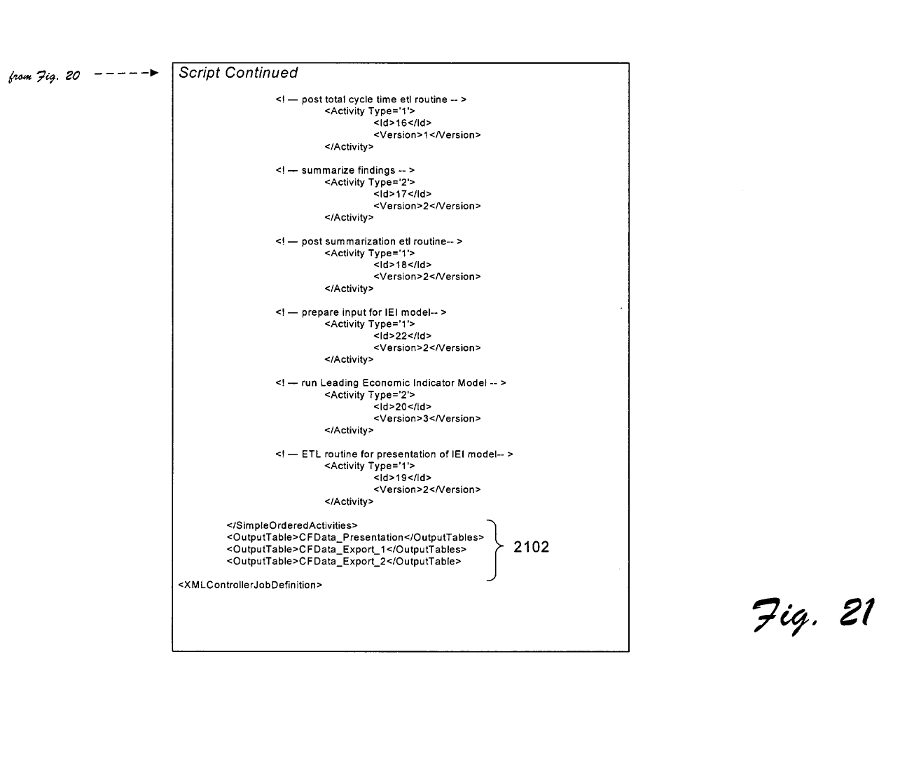

Before advancing to further functional aspects of the predictive digital cockpit, it is instructive to examine an exemplary job script. FIGS. 20 and 21 collectively show an exemplary xml job script. The script includes introductory metadata which identifies such parameters as job ID, version number, name of the script, author who created the script, date one which the script was created, identity of the business associated with the script, and the email address of the person who shall receive an alert message in the event of an error running the script.

The script also includes a series of instructions for performing individual activities. Some of these activities may involve an ETL tool, while other of these activities may involve an analytical tool. The anatomy of one such series of instructions 2004 includes a first instruction that identifies an activity type. The activity type identifies the tool responsible for performing a given activity. For instance, activity type 1 corresponds to an ETL operation performed by a DataJunction tool. Activity type 2 may correspond to an analytical function performed by a Mathematica tool, and so on. The next instruction identifies an activity ID. An activity ID corresponds to a specific operation to be performed using the identified tool. For example, activity ID 4 may correspond to a data cleaning operation performed by the DataJunction tool, while activity ID 10 might correspond to an analytical function performed by the Mathematica tool, and so on. The next instruction in the series 1204 includes version information. Version information identifies the appropriate version that the tool is requested to execute. The controller module 1514 executes the instructions provided in the job by parsing the xml information provided in the job script and then executing the individual activities within the job in succession.

Finally note the series of instructions provided in field 2102 in FIG. 21. This field of instructions identifies the tables that will receive the data produced by the job. More specifically, these tables are listed in the script to instruct the controller 1510 to archive the tables after the job is completed. This provides a historical record of the contents of these tables across all executions of the job. This, in turn, permits historical tracking of the effectiveness of the model over time.

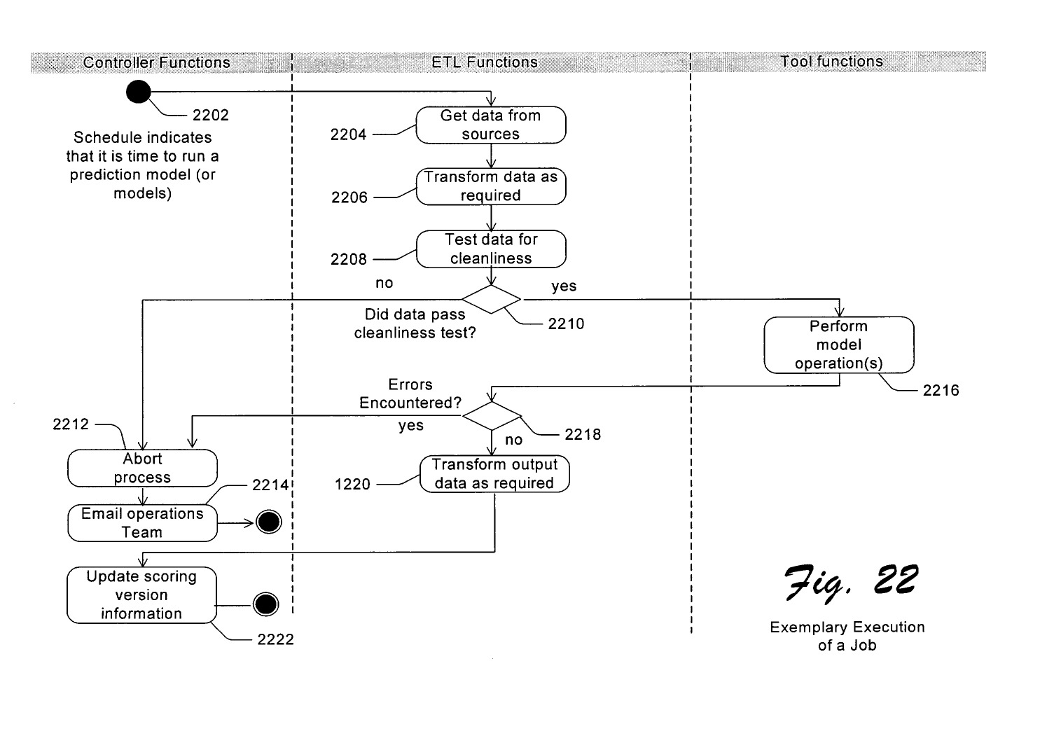

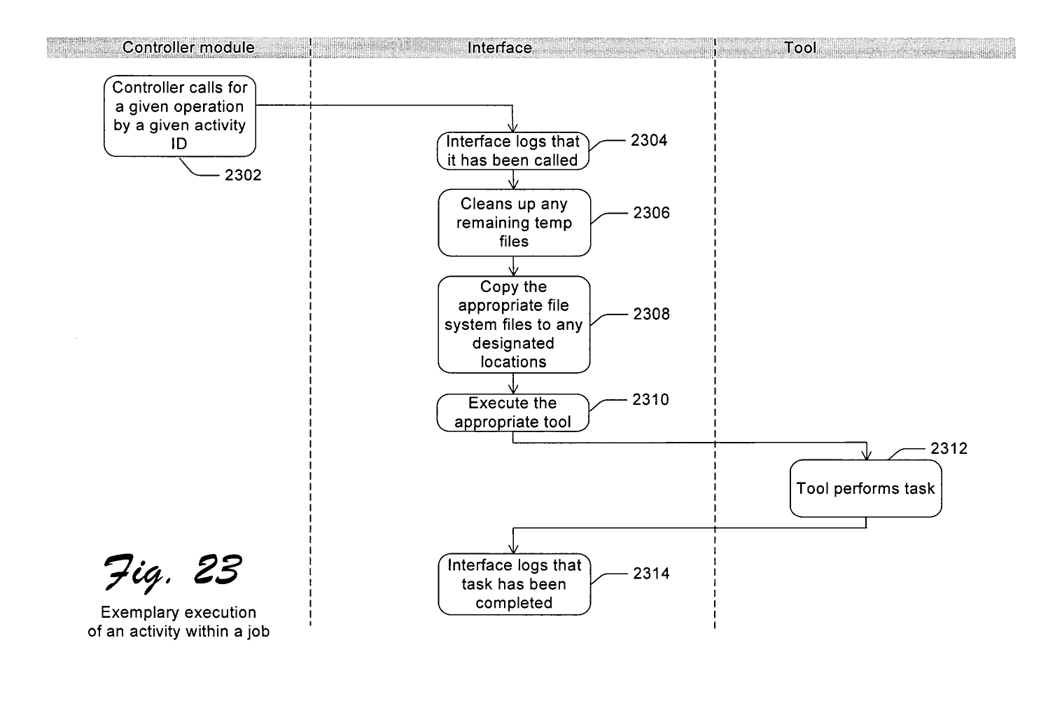

FIG. 22 provides a description of activities performed by the predictive digital cockpit in performing a job, while FIG. 23 provides a description of activities performed by the digital cockpit in performing an individual activity within a job. The figures also identify the parts of the system responsible for performing the identified functions.

Starting with FIG. 22, the process commences in step 2202 when the controller 1510 initiates the execution of a job associated with a model. The controller 1510 can specifically initiate the job at a scheduled time, or in response to some other event (such as an express request from a user, etc.) The controller 1510 initiates a job by retrieving the xml script corresponding to the job in the Foresight database 1508. A job script may by retrieved by specifying the job ID. The controller 1510 then proceeds to execute each of the activities within the script in succession.

Assuming the job script functionality requires the use of an ETL function, the ETL functionally (e.g., an ETL tool contained in ETL toolset 1502) responds by retrieving the data from appropriate sources (in step 2204), transforming the data as required (in step 2206), and then testing the data for cleanliness (in step 2208). If the data fails to meet the cleanliness test (as assessed in step 2210), the controller 1510 aborts the data collection process (in step 2212). The controller 1510 may then email an alert message to the individual identified in the job script (in step 2214), alerting that person of the potential problem in the inputting of data. However, if the data does meet the cleanliness test, then the data is passed to an analytical tool which performs an identified operation on the data (in step 2216). Step 2218 assesses whether an error was encountered in the execution of the model. Is so, the process is aborted using the procedure discussed above. If no errors were encountered, then the ETL functionality serves to transform the output data into an appropriate form (in step 2220). This step may comprise formatting the data into a format suitable for display or storage, such as assembling the data into a table, etc. Thereafter, the controller 1510 updates the scoring version information to provide an indication that the tool successfully executed its functions (in step 2222).

The above technique can be modified in various ways. For instance, the ETL functionality can collect data from a variety of different sources, such as both internal business sources and external sources. It can run data received from one source (such as an internal data source) through a first analytical model to generate a first result. The ETL functionality can then extract information from another source and then forward this information to another analytical model. This other analytical model can generate an output using both the information received from the other source as well as the results of the first analytical model. Still other variations of these operations are possible to suit different business needs.

As explained above, a job includes a series of tasks, referred to as activities. FIG. 23 provides a flowchart that outlines the general steps used in performing an activity. In step 2302 the controller module 1514 initiates a task that will involve the use of one of the cockpit tools, such as one of the ETL or analytic tools. More specifically, the controller performs this task by forwarding an activity ID to an interface associated with the tool. In step 2304, the interface responds by first logging that it has been called, e.g., by entering a log record in the Foresight database 1508. In step 2306, the interface cleans up any remaining temp files from a prior activity run. In step 2308, the interface copies the appropriate file system files to designated locations. These files contain instructions for use by the tool in performing the identified activity. In step 2310, the interface instructs the appropriate tool to perform the activity corresponding to the activity ID. In step 2312, the tool performs the requested task. The interface assists the tool in performing this task by passing it information that it needs, as well as receiving information that the tool generates. In step 2314, the interface logs that the task has been completed.

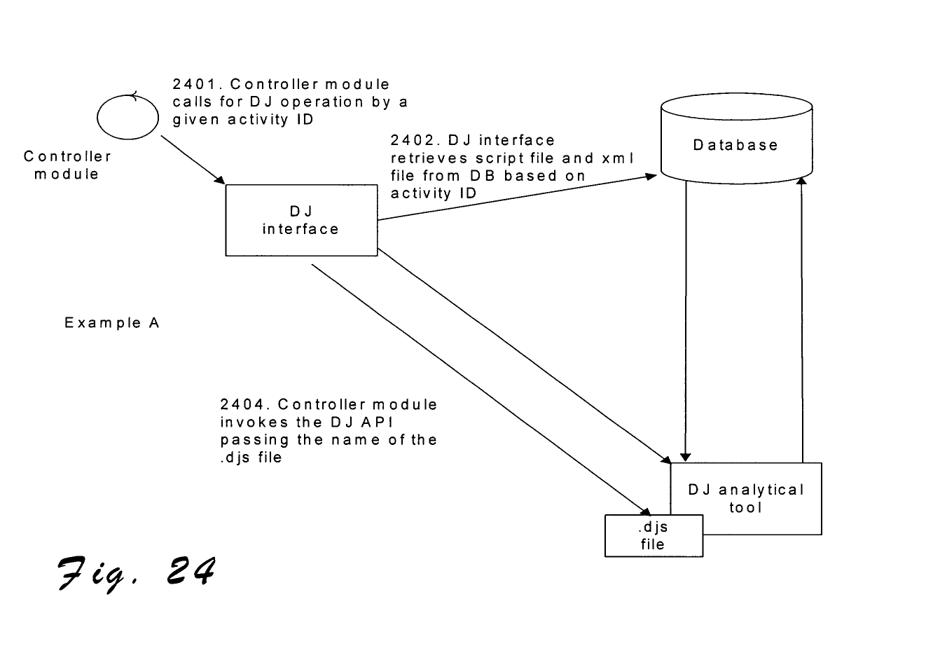

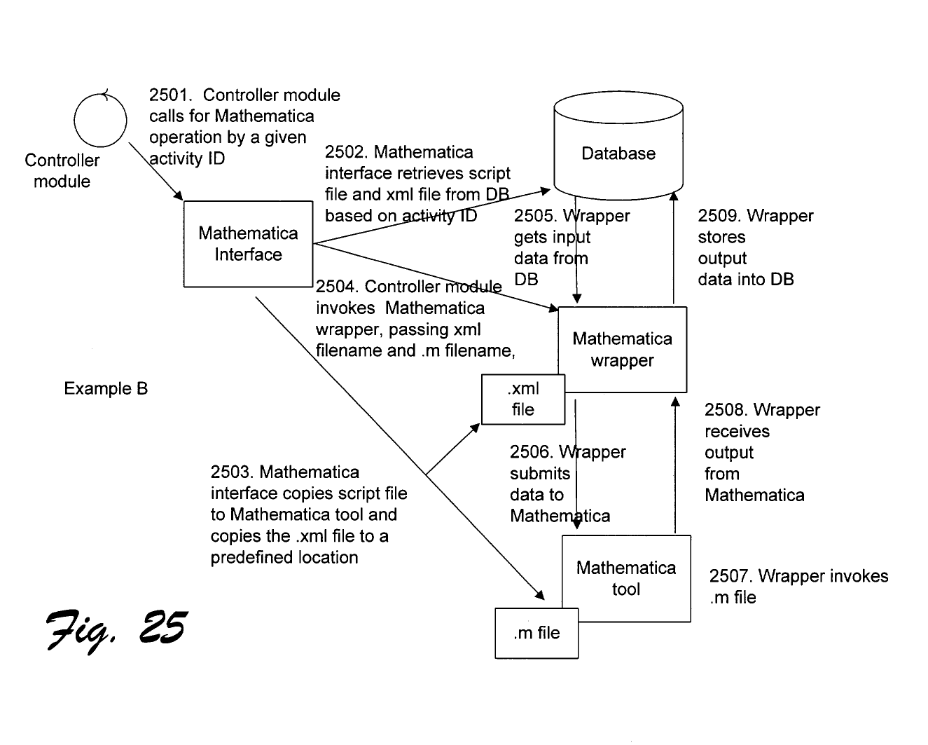

FIGS. 24 and 25 provide specific examples of the execution of activities involving different kinds of tools. More specifically, FIG. 24 shows an example of the execution of activities using an ETL tool (the DataJunction tool), and FIG. 25 shows an exemplary of the execution of activities using an analytical tool (the Mathematica tools).

To begin with, FIG. 24 describes a technique for performing an operation using a DataJunction tool. In step 2401, the controller module 1514 calls for a given DataJunction operation by a given activity ID. In step 2402, the DataJunction interface retrieves a script file and an xml file from the Foresight database 1508. The script file for a DataJunction tool is denoted as a .djs file. This script file provides instructions to the DataJunction tool for its use in executing the assigned task. This script file is copied to the DataJunction tool directory. The xml file provides information for coordinating the input and output to and from the DataJunction tool. In step 2403, the controller module invokes the DataJunction Application Programming Interface (API). The DataJunction tool then performs the task that it is instructed to execute.

FIG. 25 describes a technique for performing an operation using the Mathematica tool. In step 2501, the controller module 1514 calls for a Mathematica operation by a given activity ID. In step 2502, the Mathematica interface retrieves a script file (an .m file) from the Foresight database 1508 that identifies the series of instruction that are to be performed by the Mathematica tool. The Mathematica interface also retrieves an .xml file from the Foresight database 1508 that informs a Mathematica wrapper class 1812 how it should interact with the Mathematica tool. In step 2503, the Mathematica interface copies the script file (.m file) to the Mathematica tool and then copies the xml file to a predefined location. In step 2504, the controller module 1514 invokes the wrapper by passing the xml file name, .m file name and other information to the wrapper. In step 2505, the wrapper gets input data from the Foresight database 1508 for use by the Mathematica tool in performing its assigned activity. In step 2506, the wrapper submits the retrieved data to the Mathematica tool. In step 2507, the wrapper invokes the .m file which prompts the Mathematica tool to perform the assigned activity. In step 2508, the wrapper receives output from the Mathematica tool. In step 2509, the wrapper stores output data into the Foresight database 1508.

The execution of activities involving other kinds of tools follows a similar methodology to the techniques described above. Generally, the Informatica interface parses a retrieved xml file that describes the operation to be performed. An Informatica wrapper invokes the Informatica tool. The SAS interface works directly with a SAS library to instantiate the SAS tool, passes the database connection information, and executes a .sas file.

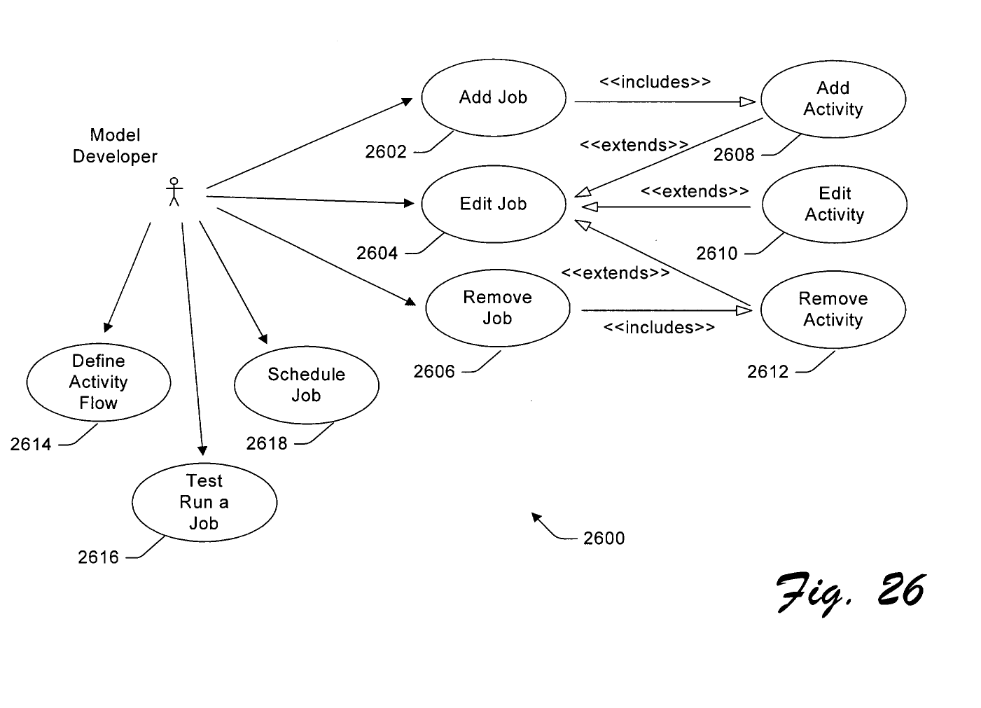

E. Predictive Cockpit Job Management System (FIGS. 26-34).

FIGS. 26-34 provide information regarding the Foresight Job Management System (referred to as the “management system” hereinafter for brevity). The management system generally allows a model developer to input, modify and delete jobs. FIG. 26 shows a high-level UML use case diagram that describes the functions performed by the job management system 2600. The functions include adding a job (function 2602), editing a job (2604), and removing a job (function 2604). Since a job implicitly includes at least one activity, the function of adding a job (function 2602) also includes adding an activity (function 2608). This necessary relationship is represented by the standard UML notation of “<<includes>>”. The function of editing a job (function 2604) may include editing an activity (function 2610). This non-binding relationship is represented by the standard UML notation of “<<extends>>”. The function of removing a job (function 2606) implicitly includes removing an activity (function 2612). Again, this necessary relationship is represented by the notation “<<includes>>”. The model developer may also perform the functions of defining activity flow within a job (function 2614), the function of test running a job (function 2616), and the function of scheduling a job (function 2618). The functions described above, as well as other aspects of the predictive digital cockpit, can be implemented using any of a variety of technologies. For instance, the application can run inside a J2EE servlet container such as Tomcat or JRun and utilize Java Server Pages, JSP tags, and Java bean classes containing JDBC code.

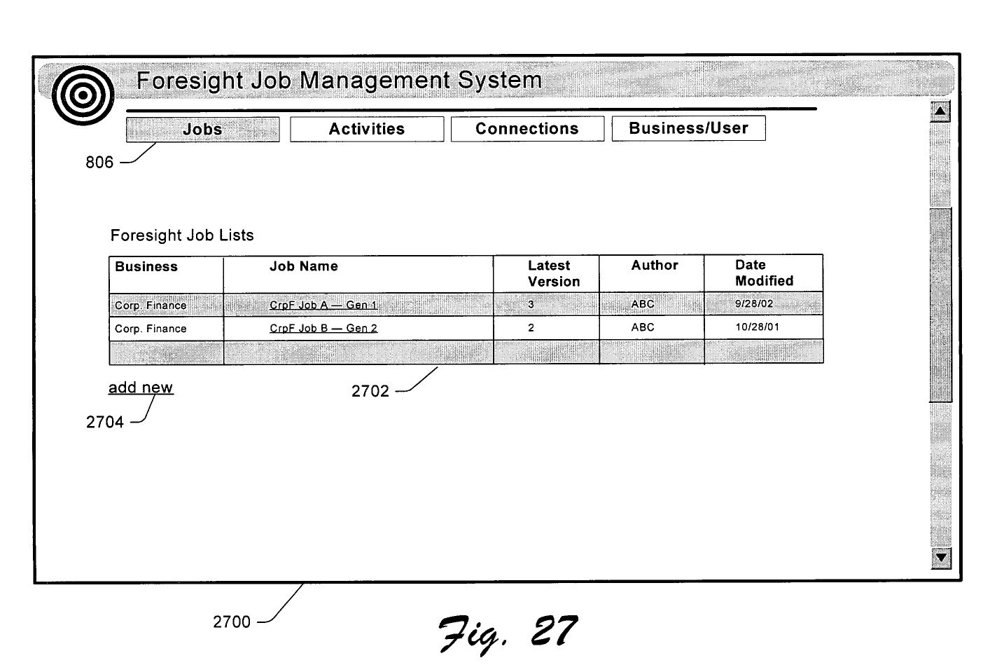

FIGS. 27-34 shows different user interface pages provided by the job management system 2600. These pages are presented to a user at any kind of computing device, where the computing device is coupled to the predictive digital cockpit system shown, for example, in FIG. 15 (e.g., via a network connection). A first interface page 2700 shown in FIG. 27 provides a list 2702 of jobs stored in the Foresight database 1508. The listing identifies the businesses associated with the jobs, the names of the jobs, the latest versions of the jobs, and the dates that the jobs were last modified. If a user belongs to a business, they will only see jobs belonging to that business. But if the user is in an administrative group, the job management system 2600 will display all of the jobs in the Foresight database 1508. Jobs are ordered by business. Within a business, jobs are ordered by name. By selecting a job name, the user can view or edit the job information associated with the job. By clicking on a link 2704 at the bottom of the page, a user can add new jobs to the Foresight database 1508.

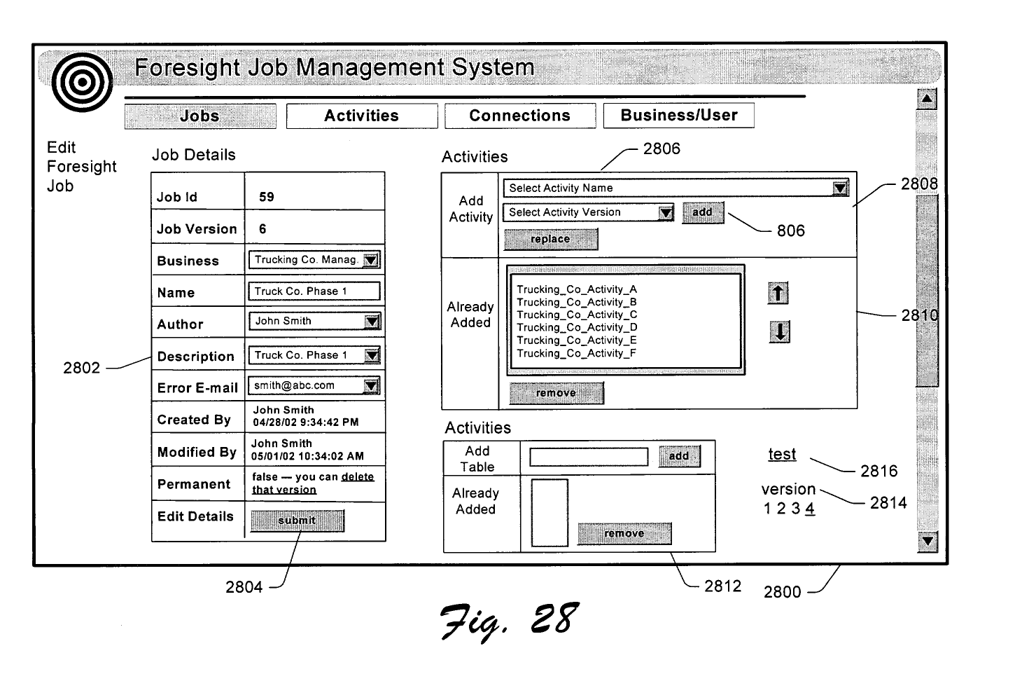

FIG. 28 provides an interface page 2800 for viewing and changing job details and activities. The interface page 2800 includes a jobs details presentation 2802 that identifies the following attributes regarding the job: job ID, job version, business associated with the job, author of the job, a one line description of what the job does, error email (identifying the individual who should receive an alerting email in the event of an error in the run), the individual who created the job, the individual who last modified the job, and an indication of whether a developer is permitted to edit a particular job version. A submit button 2804 on the bottom of a jobs detail presentation 2808 allows a user to edit the information provided in the jobs detail list.

An activities presentation 2806 allows a user to add activities, delete activities, change the order of activities, etc. More specifically, the activities presentation 2806 include a first field 2808 that allows a user to add an activity, and a second field 2810 that shows activities that have already been added. Another field 2812 allows a user to add a table associated with a job, and to view tables that have already been added (and to remove already added tables). Again, the controller 1510 archives these tables after completing a job. This provides for effective tracking for use in assessing the effectiveness of the model over time.

A “version” field 2814 allows a user to select another version than the version presented in interface page 2800. The current version is displayed by default. Any edit of a job that has been run at least once results in a new version. In such a case, the version will automatically be incremented and the name of the user will be posted as the creating and modifying user. If the user makes changes and saves a job that has not been run at least once, the version will not be incremented and the name of the user will be posted only as the modifying user. Note that the versioning is performing in the manner described above to enforce effective version control of the models. This aids in the tracking of model evolution and performance over time.

An “execute test” run field 2816 allows the user to execute a job with respect to a test database.

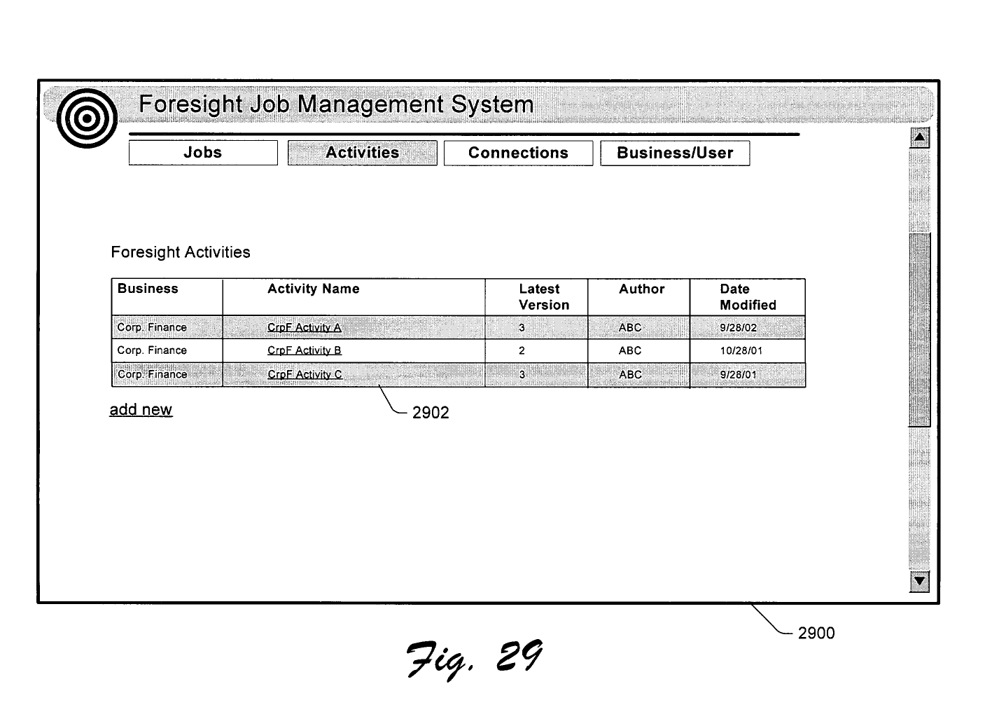

FIG. 29 provides an interface page 2900 including a list of activities 2902 stored in the Foresight database 1508. The listing 2902 identifies the businesses associated with the activities, the names of the activities, the latest version of the activities, and dates that the activities were last modified.

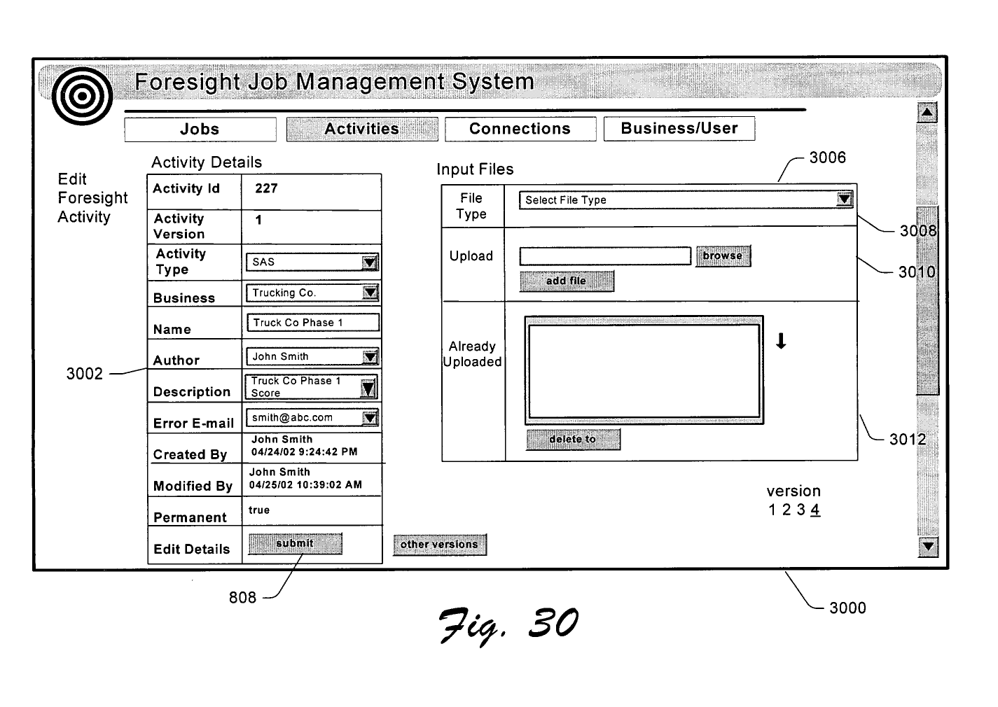

FIG. 30 provides an interface page 3000 that includes an activity detail presentation 3002 for viewing and changing activities. The activity detail presentation 3002 identifies the following attributes regarding each activity: activity ID, activity version, activity type, business, name of activity, author, description, error email (identifying the individual who should receive an alerting email in the event of an error in the run of the activity), the individual who created the job, the individual who last modified the job, and an indication of whether a developer is permitted to edit a particular job version. The submit button 3004 on the bottom of the activities presentation 3002 allows a user to edit the information provided in the activity detail list.

Another field 3006 on the right-hand portion of the interface page 3000 allows a model developer to input files associated with an identified activity. A first field 3008 allows a user to specify a file type. A second field 3010 allows a user to update a selected file. A third field 3012 shows files that have already been uploaded. The third field also allows a user to remove an already uploaded file. Activity versions are managed in a manner analogous to job versions (discussed above). In one implementation, the files associated with the respective activities are written in a format compatible with (or “native to”) the tools being used.

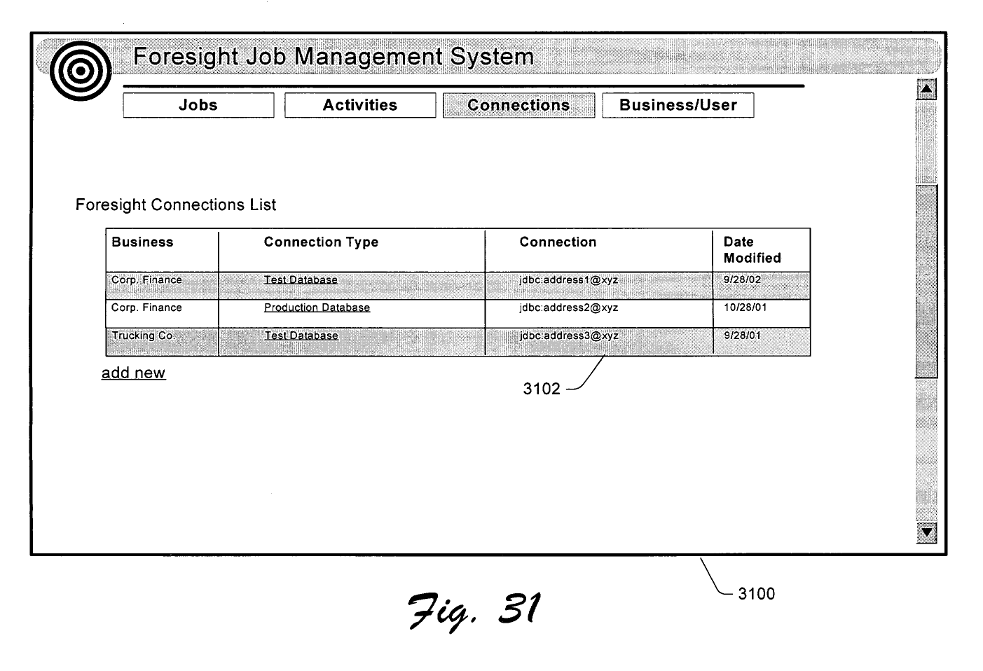

FIG. 31 shows an interface page 3100 that provides a list 3102 of connections associated with different databases. More specifically, a job can be executed using data stored in a normal working database (e.g., a production database) or a test database. The connection list identifies whether a database is intended to serve as a normal working database or a test database. More specifically the connections list identifies businesses associated with the jobs, the connection type associated with a database (test or production), a specific connection link associated with the database, and the date that the connect link was last modified.

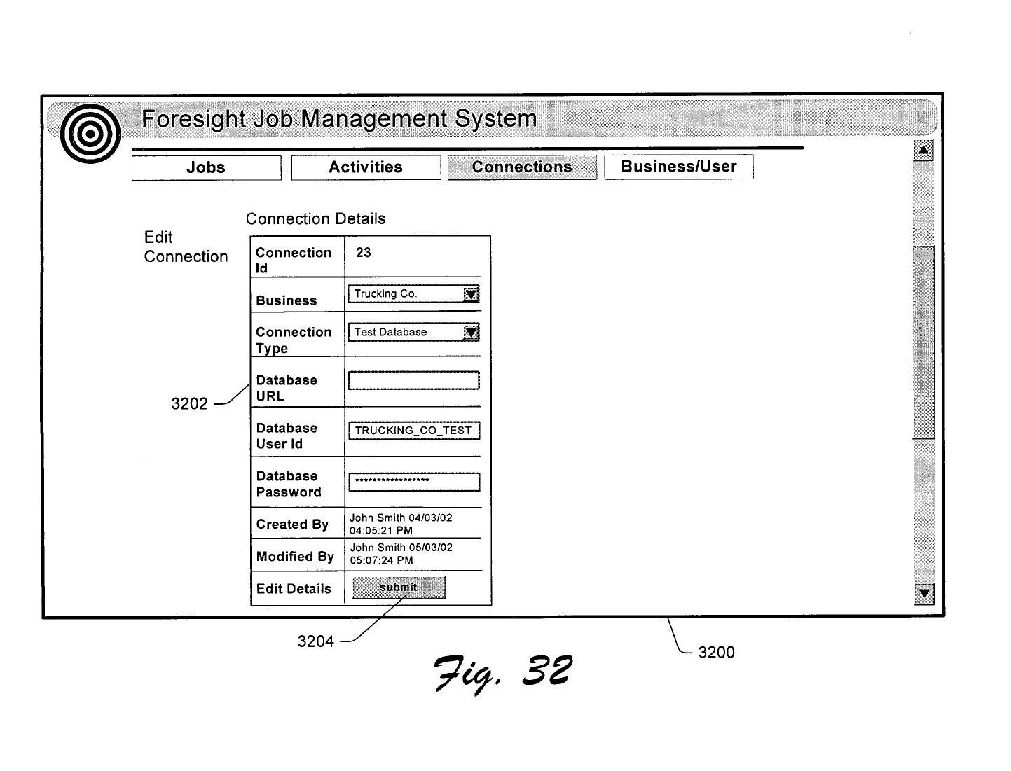

FIG. 32 shows an interface page 3200 including a connection details presentation 3302 for viewing and changing connection details. The interface identifies the following attributes regarding the connection: connection ID, connection type, database URL address, database user id, database password, the individual who created the connection link, and the individual who last modified the connection link. The submit button 3306 on the bottom of the jobs detail presentation 1302 allows a user to edit the information provided in the connection list.

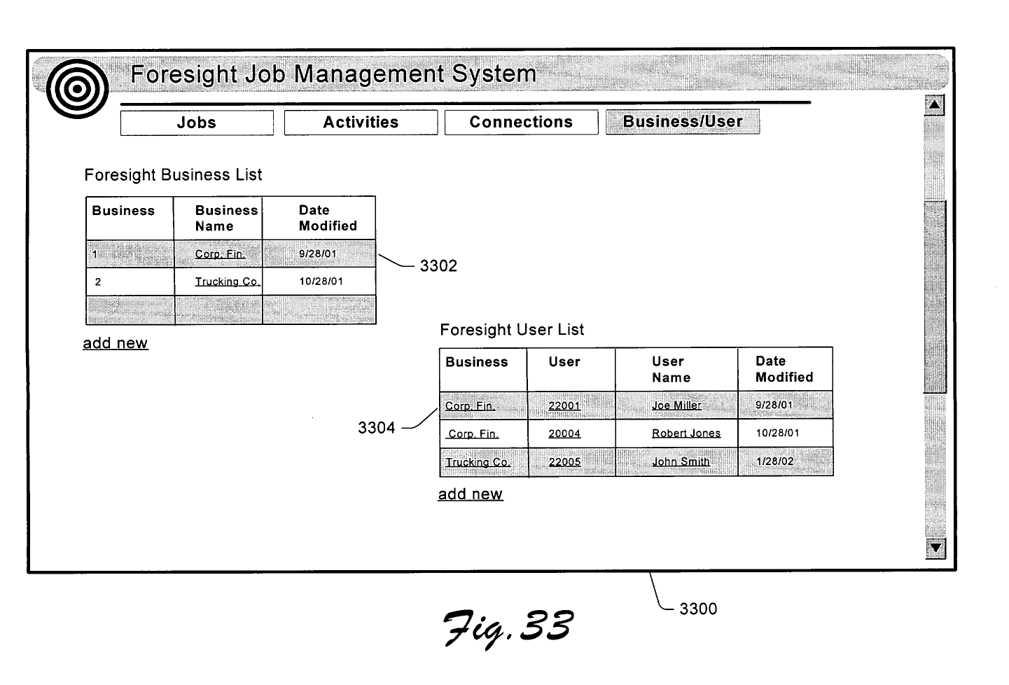

FIG. 33 shows an interface page 3300 that includes a foresight business list 3302 and a foresight user list 3304. The foresight business list 3302 shows a list of businesses associated with the digital cockpit. More specifically, the business list identifies a code associated with the business, a business name, and the date that the entry in the business list was last modified. The user list 3304 shows a list of users that have access to use the digital cockpit. The user list 3304 includes the businesses associated with the user, a user identification number, user name, and the date that an entry in the user list was last modified.

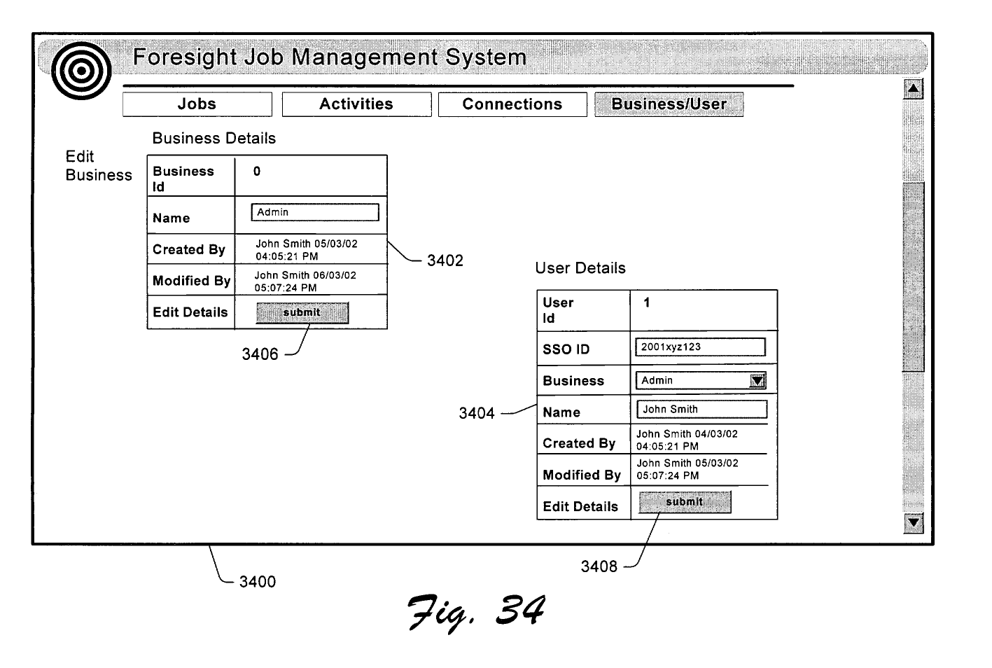

FIG. 34 shows an interface page 3400 for viewing and modifying business details 3402 and user details 3404. The business details interface 3402 identifies the following attributes regarding the businesses: business ID, name of the business, the individual who created the business information, and the individual who last modified the business information. The submit button 3406 on the bottom of the business details presentation 3402 allows a user to edit the information provided in the business list. The user details interface 3404 identifies the following attributes regarding the users: user ID, Single Sign On (SSO) ID, name of the user, individual who created the user details information, and the individual who last modified the user details information. The submit button 3408 on the bottom of the user details presentation 3404 allows a user to edit the information provided in the user list.

By virtue of the above series of pages, a user can easily create and modify job scripts, even though the user may have little or no prior training in formal programming languages.

F. Exemplary Cockpit UI Displays for Different Companies (with Reference to FIGS. 35-54)

FIGS. 35-54 show exemplary digital cockpit displays used in different businesses. The specific selection of information presented in a cockpit display depends on the informational needs a particular business. As such, FIGS. 35-54 are intended to be merely illustrative of the range of information that can be provided in digital cockpit displays. Since the specific fields of information in the cockpit displays are business-specific and merely illustrative, only certain high-level features of each display are discussed. Numerical values are presented with x's (or removed) to facilitate discussion.

Further, to simplify the figures and facilitate analysis, the digital cockpits do not include the prediction functionality described above. However, it is expected that a cockpit designer may wish to add prediction capability to one, several, or all of the digital cockpits illustrated in FIGS. 35-54.

FIG. 35 shows an exemplary digital cockpit page 3500 for use in an appliance company. The information again includes a collection of metrics 3502 pertinent to this business environment, such as metrics associated with order, make, network infrastructure, buy, ship/fulfill, service, servers, etc.

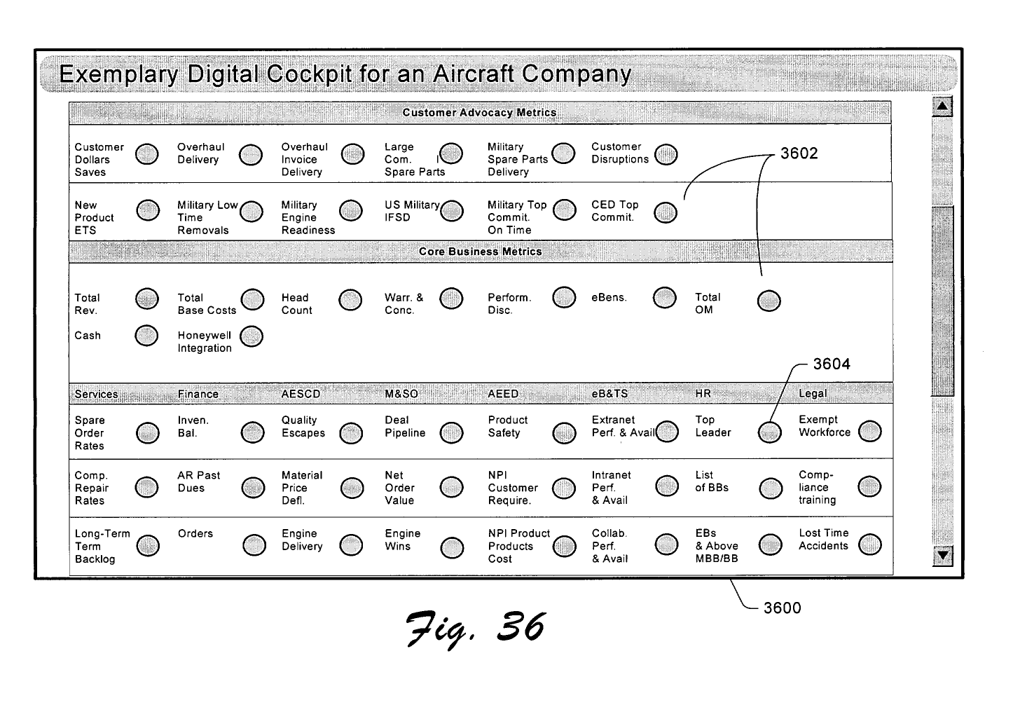

FIG. 36 shows an exemplary digital cockpit page 3600 for use in an aircraft company. The information includes a collection of metrics 3602 pertinent to this business environment, such as customer advocacy metrics, core business metrics, etc. The LED-type lights (e.g., LED-type light 3604) change color depending on whether the numerical value associated with each metric falls into one or plurality of different ranges. A first color (such as red) can be used to denote substandard metric value, a second color (such as yellow) can be used to denote a marginal metric value, and a third color (such as green) can be used to denote a desirable (e.g., a strong) metric value.

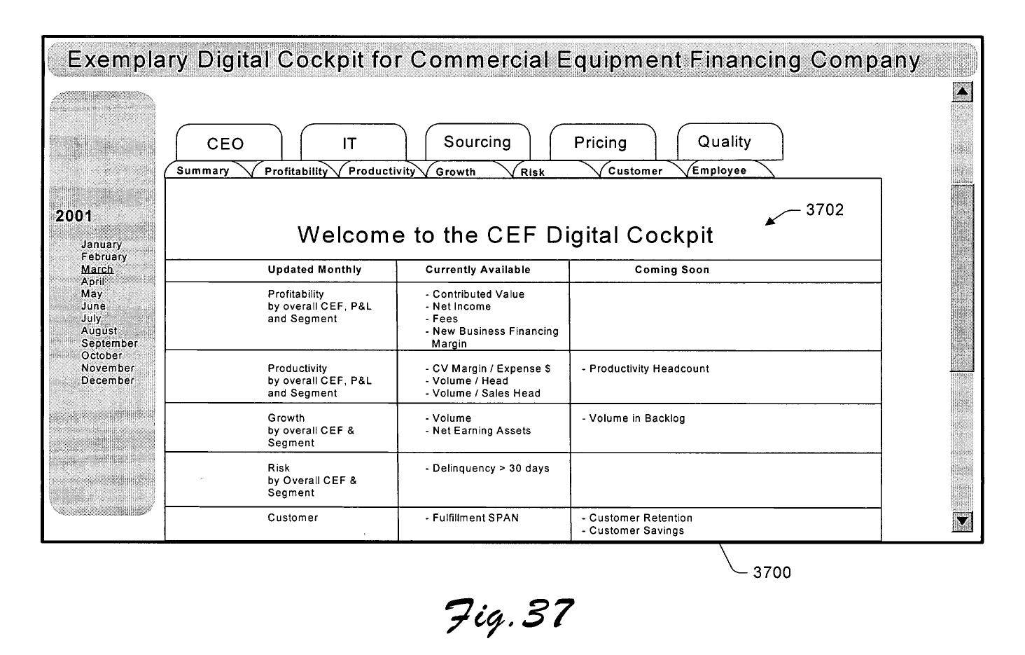

FIG. 37 shows an exemplary cockpit display page 3700 for use in a commercial equipment finance (CEF) company. The information includes a collection of metrics pertinent 3702 to this business environment, such as profitability metrics, productivity metrics, growth metrics, and customer-related metrics.

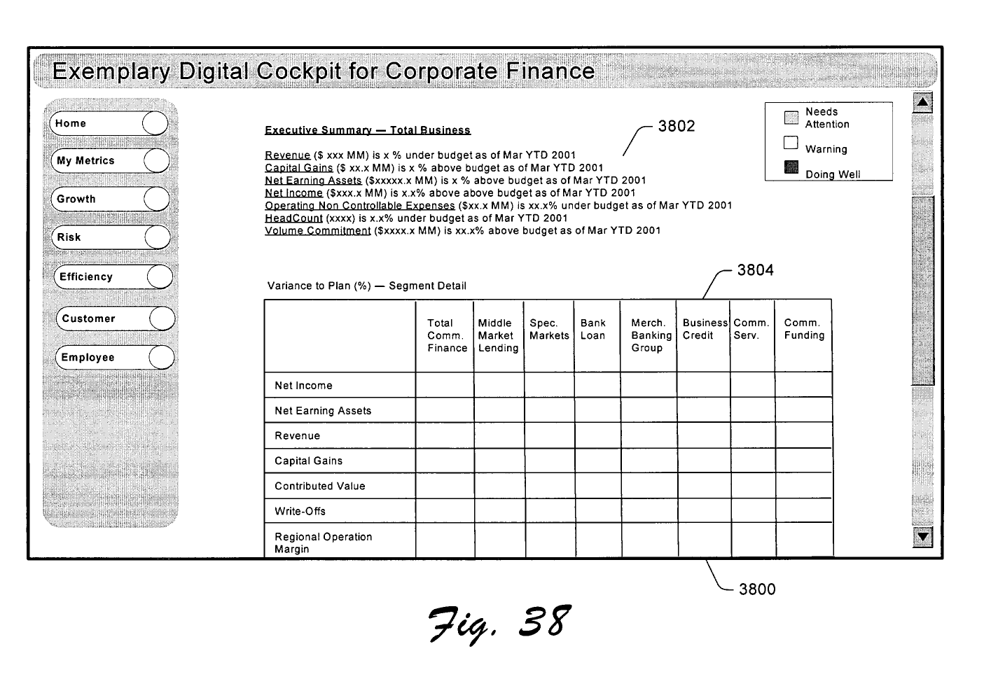

FIG. 38 shows an exemplary cockpit display page 3800 for use in a commercial finance (CF) company. The display includes a top field 3802 that provides an executive summary of high-level information regarding the performance of the business as a whole. The display includes a bottom field 3804 that provide variance to plan percentages.

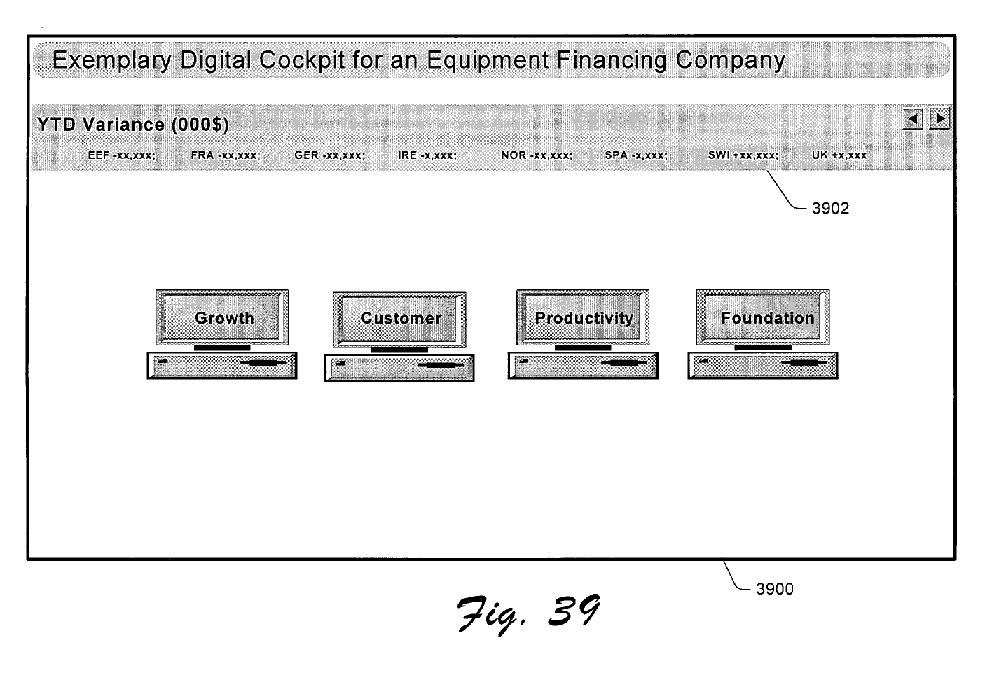

FIG. 39 shows an exemplary cockpit display page 3900 for use in a European equipment finance (EEF) company. The display includes a collection of metrics 3902 associated with the performance of the business in different European countries. The display further allows a user to drill down and receive more fine-grained metrics pertinent to the topics of growth, customer-related matters, productivity, and foundation matters.

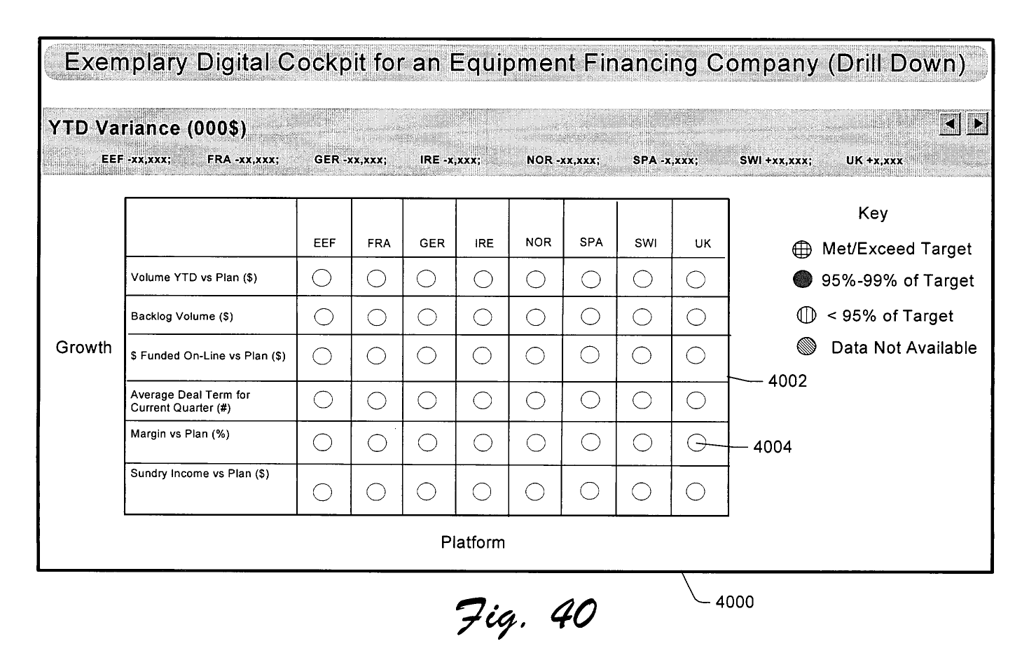

FIG. 40 shows an exemplary cockpit display page 4000 for use in a European equipment finance (EEF) company. This display represents a drill-down from the display shown in FIG. 39 on the topic of growth. Namely, this display shows a variety of growth metrics 4002 for different platforms in different respective European countries. Different colored signal lights (e.g., signal light 4004) are again used to convey whether the metrics are unacceptable, marginally acceptable, or acceptable.

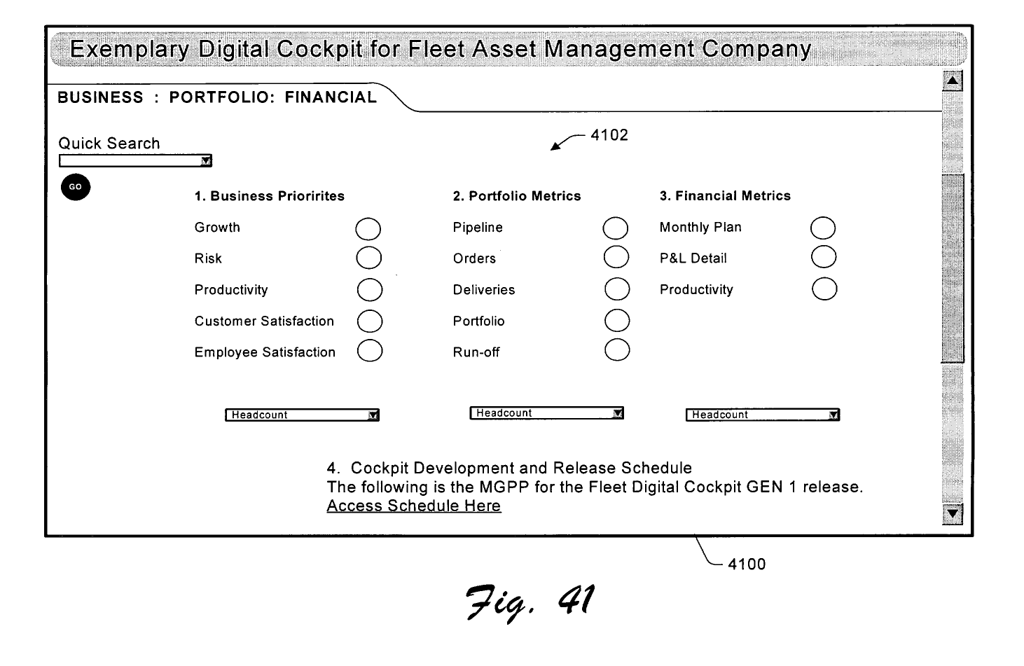

FIG. 41 shows an exemplary cockpit display page 4100 for use in a fleet asset management company. The information displayed here includes a collection of metrics 4102 pertinent to this business environment, such as business priorities, portfolio metrics, financial metrics, etc. Once again, different colored signal lights are again used to convey what value range each metrics falls into (e.g., such as unacceptable, marginally acceptable, or acceptable range).

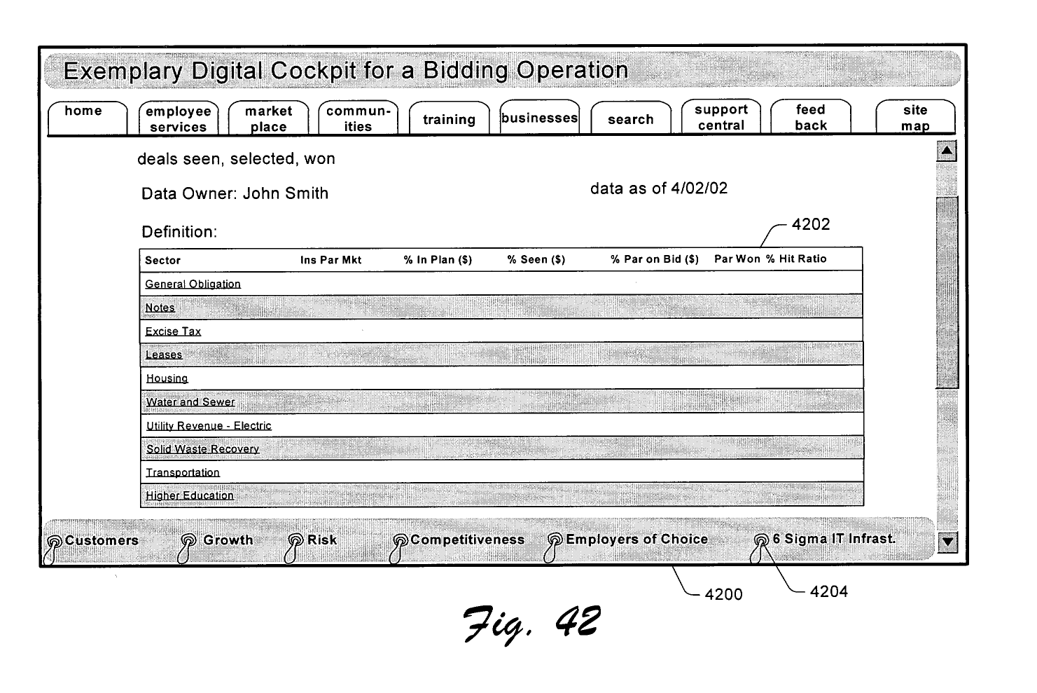

FIG. 42 shows an exemplary cockpit display page 4200 for use in any company that enters bids for projects. The display includes bid-related information 4202 on a per-sector basis. The bottom of the display provides a plurality of simulated toggle switches 4204 that allows a user to drill down to receive metrics on a variety of topics, such as customer-related matters, growth, risk, competitiveness, etc.

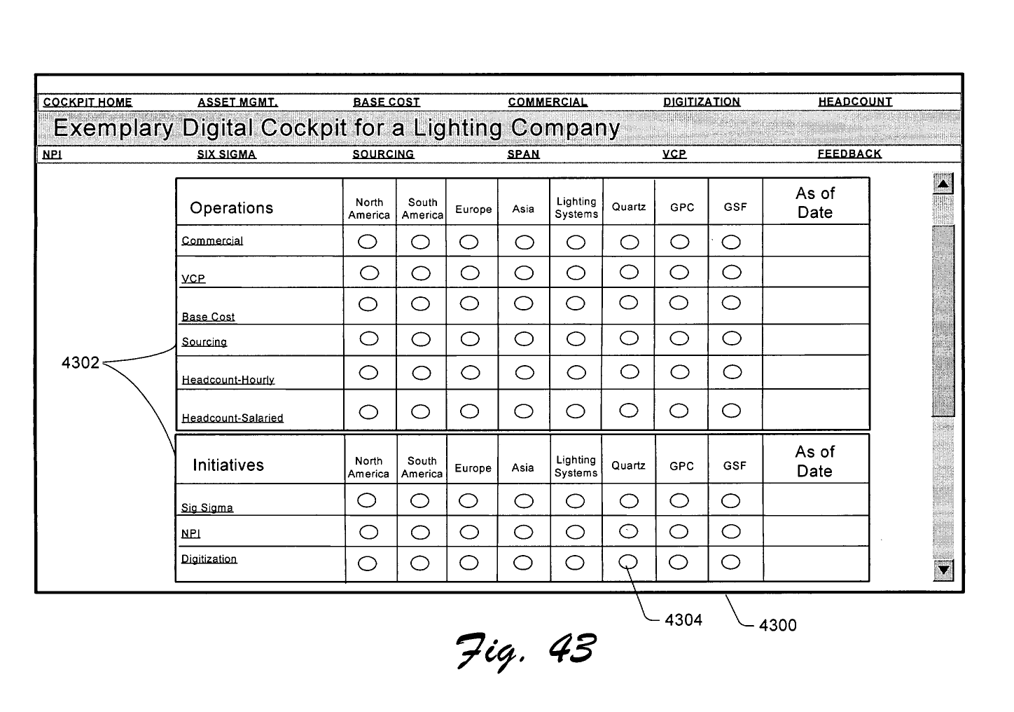

FIG. 43 shows an exemplary cockpit display page 4300 for use in a lighting company. This display shows a variety of metrics 4302 relating to operations and initiatives for a variety of different businesses. Once again, different colored signal lights (e.g., 4304) are again used to convey what value range each metrics falls into (e.g., such as unacceptable, marginally acceptable, or acceptable).

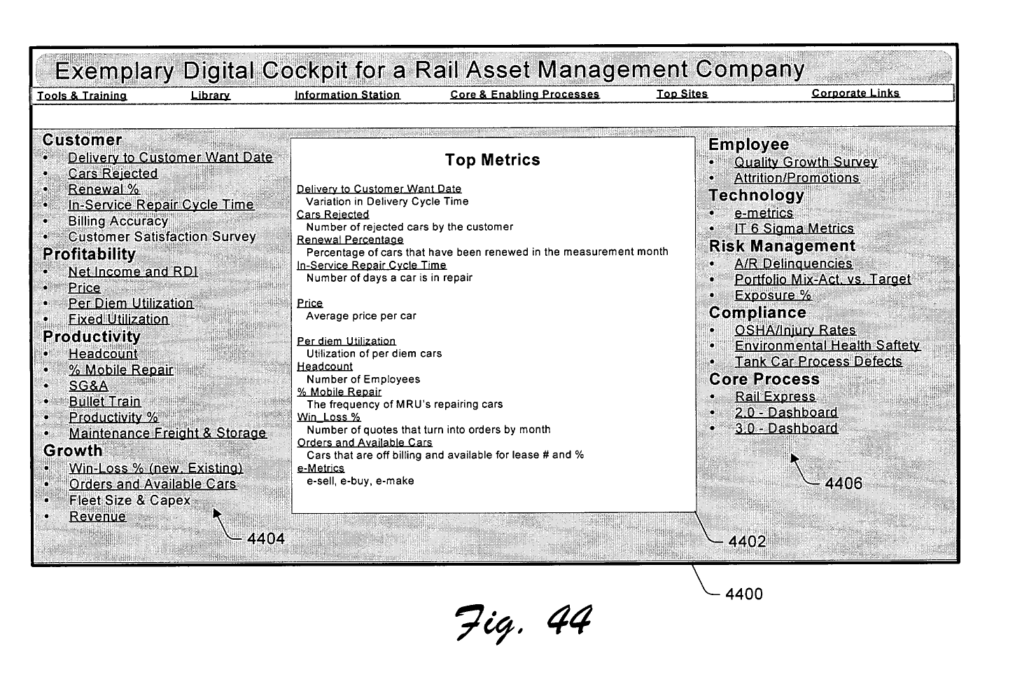

FIG. 44 shows an exemplary cockpit display page 4400 for use in a rail company. The middle portion 4402 of this display includes a variety of “top metrics”. associated with the business. The right and left portions (4404, 4406) of the display provide a menu for drilling down to receive additional metrics related to other aspects of the business.

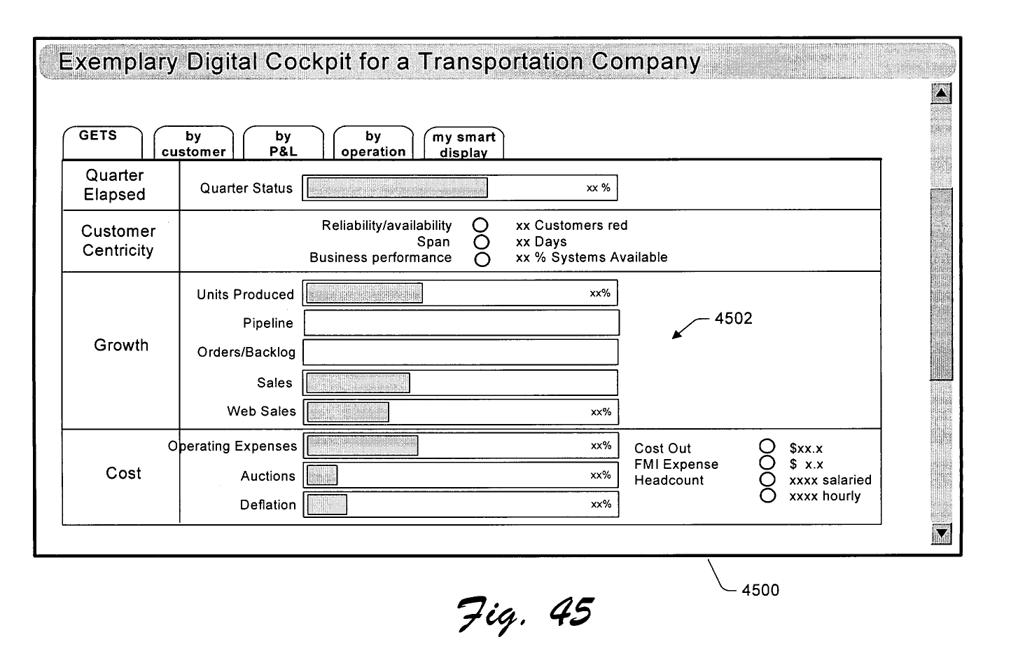

FIG. 45 shows an exemplary cockpit display page 4500 for use in a transportation company. This display shows a variety of metrics 4502 in bar chart format pertaining to this business environment.

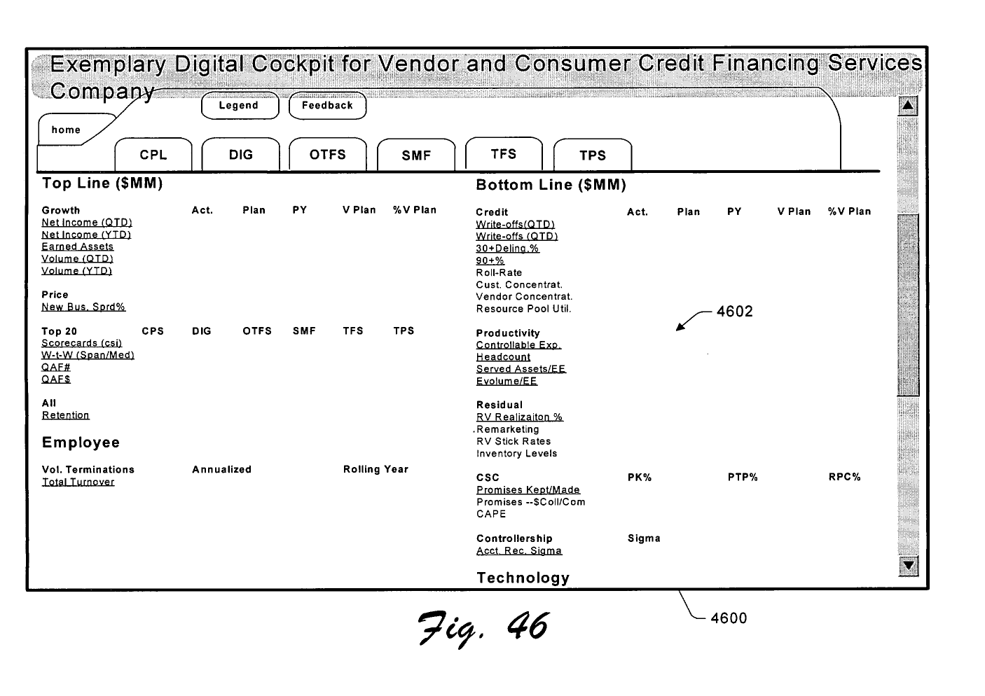

FIG. 46 shows an exemplary cockpit display page 4600 for use in a vendor financial services (VFS) company. This display shows a variety of metrics arranged in the categories of “top line”, “bottom line,” etc.

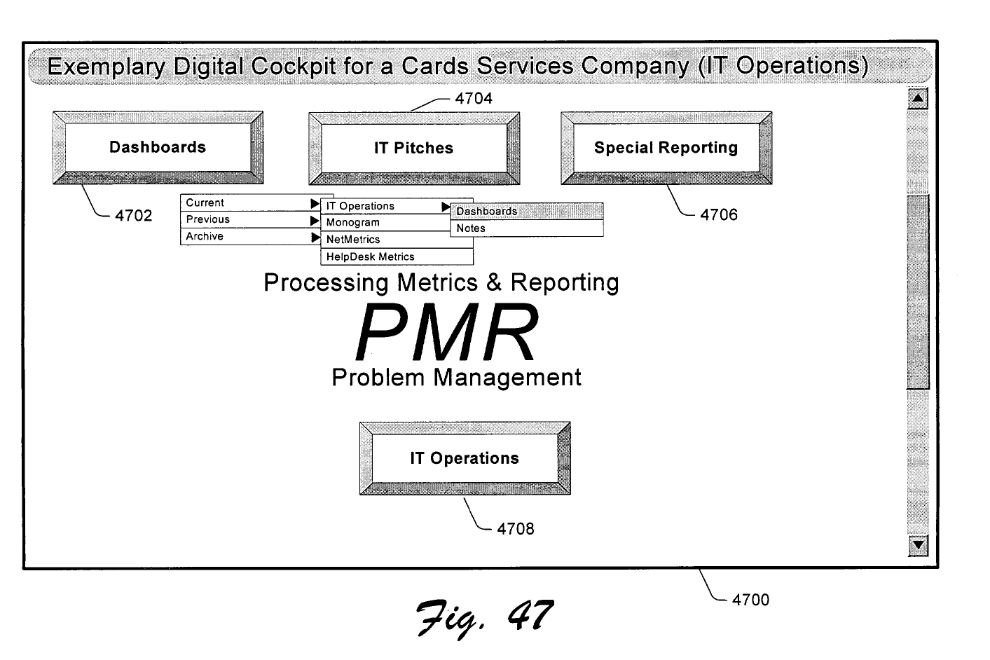

FIG. 47 shows an exemplary cockpit display page 4700 for use in a cards services company. The display includes broad graphically buttons pertaining the categories of dashboards 4702, IT pitches 4704, special reporting 4706, and IT operations 4708.

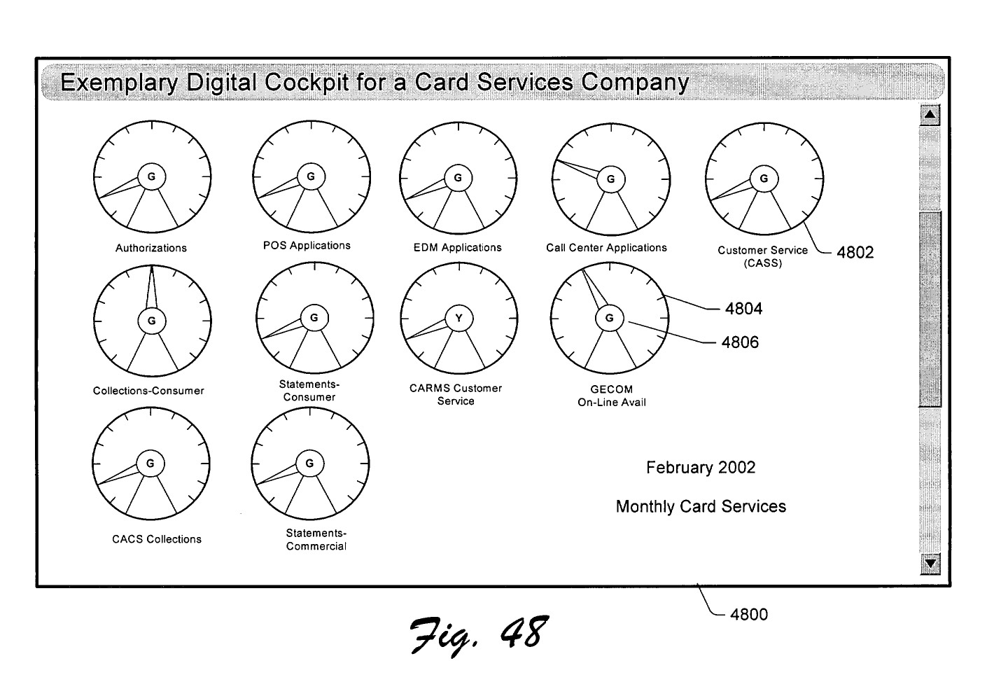

FIG. 48 shows another exemplary cockpit display page 4800 for use in the cards service company. This display presents a variety of card services metrics in the form of multiple gauges (e.g., gauge 4802). The outer portion of each gauge 4804 identifies the specific numerical value of the metrics. The center circle portion 4806 of each gauge provides a color-coded signal level which indicates the relative range that each metrics falls within (such as unacceptable, marginally acceptable, and acceptable ranges).

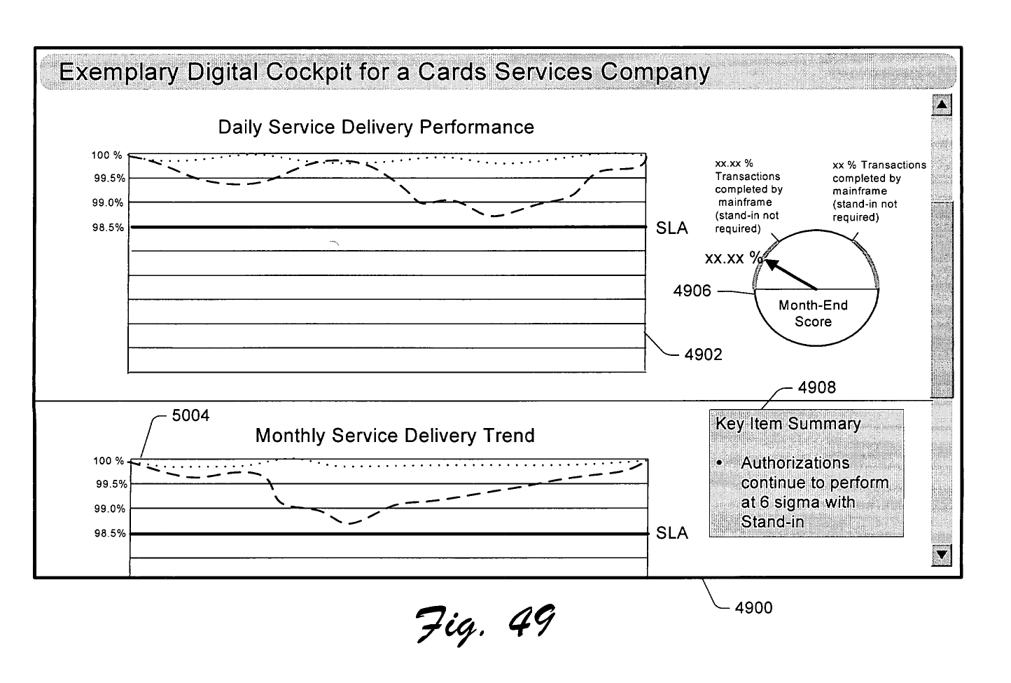

FIG. 49 shows yet another exemplary cockpit display page 4900 for use in the cards service company. This display presents various graphs that map the performance of the card services company with respect to the company's service level agreement (SLA). Namely, a first graph 4902 shows daily service delivery performance, and a second graph 4904 shows monthly service delivery trend. The right portion of the display shows a gauge-type metric display 4906 that provides “month-end score.” The right portion of the display also presents a key item summary 4908.

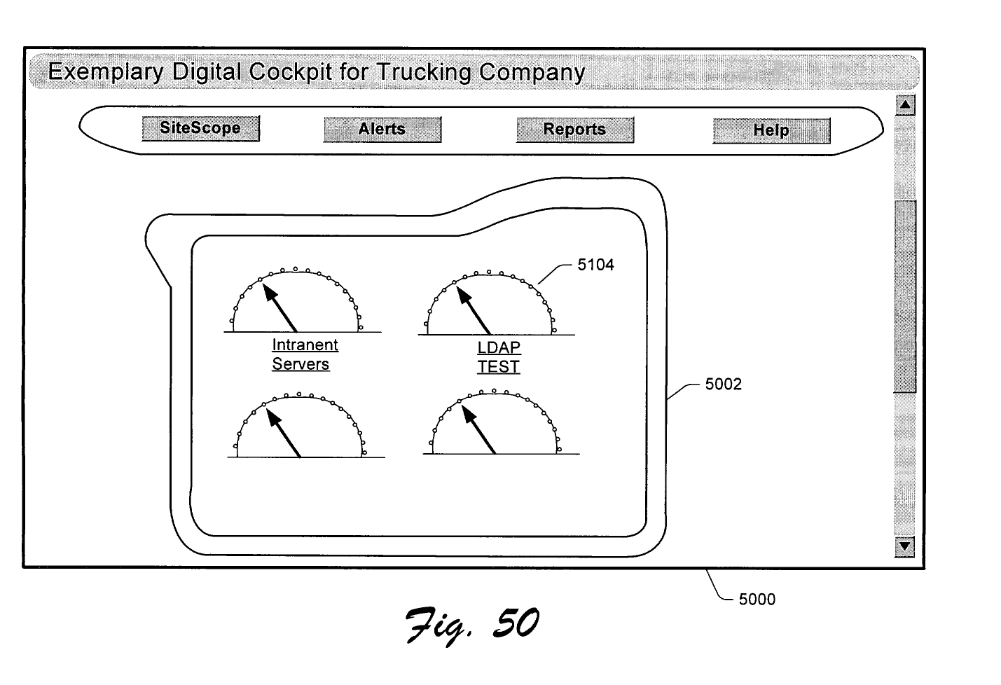

FIG. 50 shows an exemplary cockpit display page 5000 for use in a truck rental company. This display presents information in the simulated form of a vehicle navigation console 5002. The metric information pertains to the performance of various computing systems used by the company. This display presents the metrics using a gauge-type display (e.g., gauge-type display 5004).

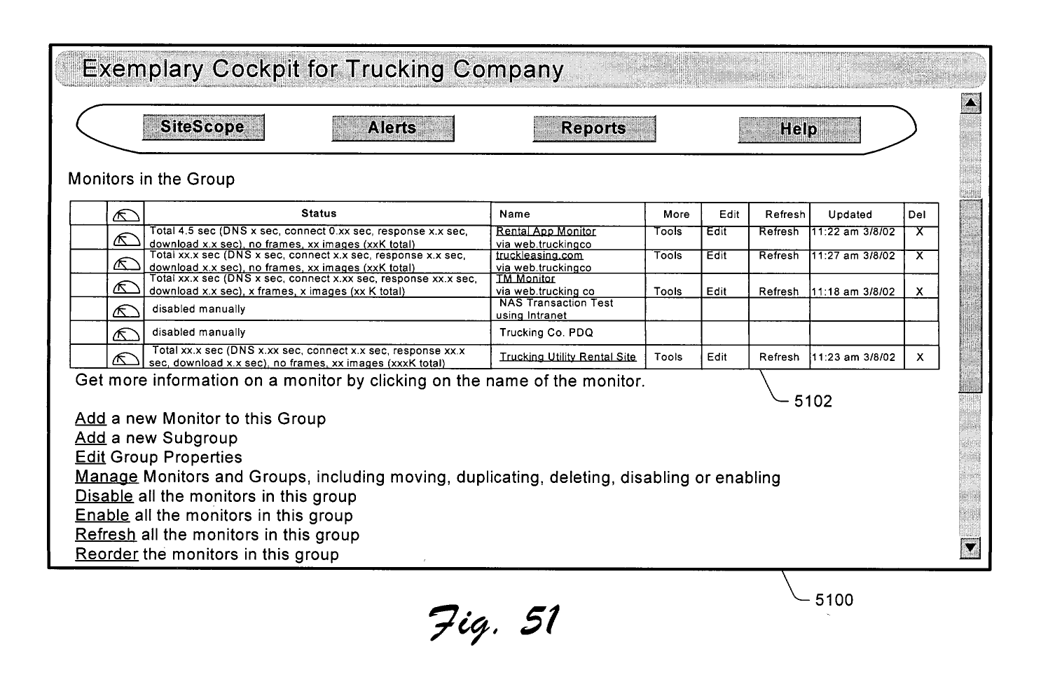

FIG. 51 shows another exemplary cockpit display page 5100 for use in a truck rental company. This display presents information 5102 regarding various monitors associated with the computing systems used by the company. The display provides an indication of the status of the monitors, the name of the monitors, and other information.

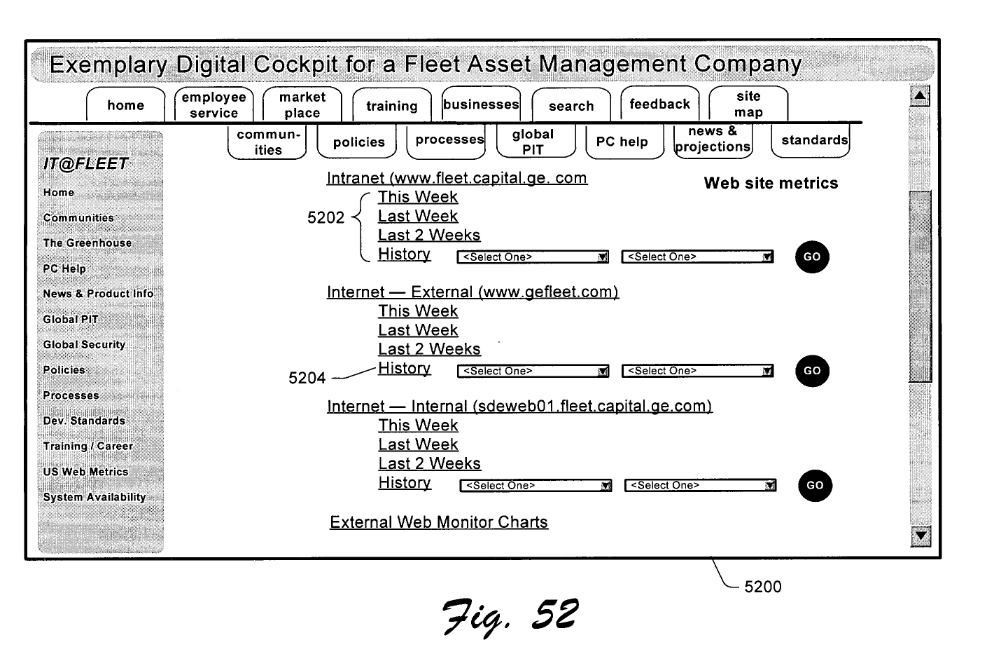

FIG. 52 shows an exemplary cockpit display page 5200 for use in a truck leasing company referred to as Fleet. This display presents various metrics information regarding the systems used by this company in different time intervals (such as this week last week, last two weeks, etc.) (e.g., time internals 5202). More extensive historical information can be providing by clicking on the link labeled “History” 5206.

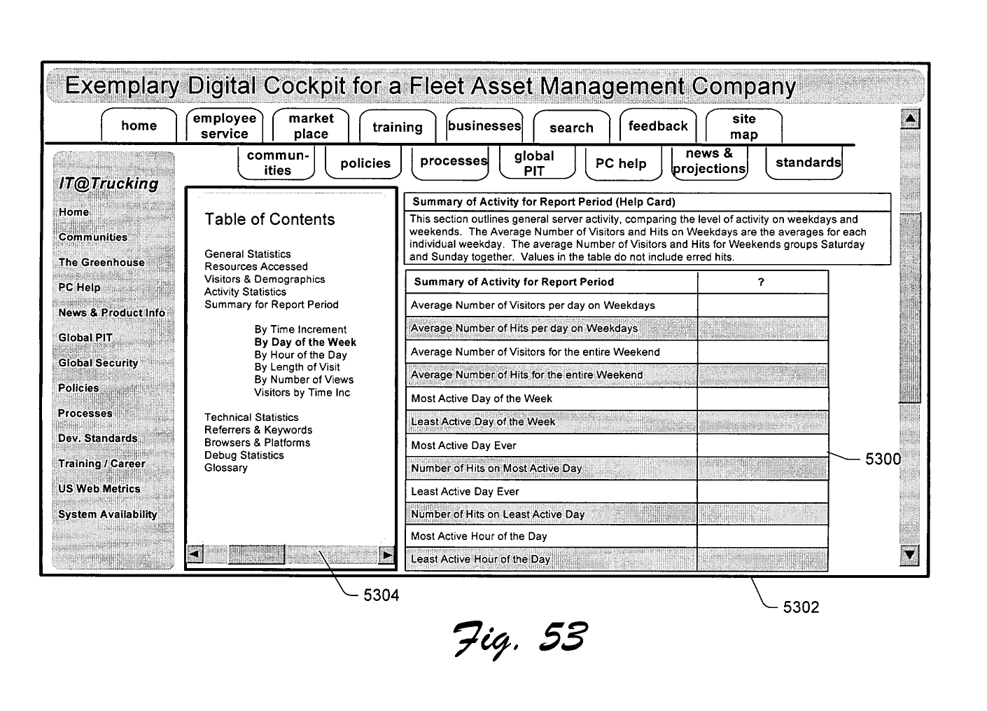

FIG. 53 shows an exemplary cockpit display page 5300 for use in the truck leasing company. The display is a further drill-down from the cockpit display shown in FIG. 52. FIG. 53 provides various performance-related measures 5302 pertaining to the usage of a computer resource, such as usage of a web site resource. A left portion 5304 contains a table of contents that allows a user to drill down and receive a different collection of performance-related metrics.

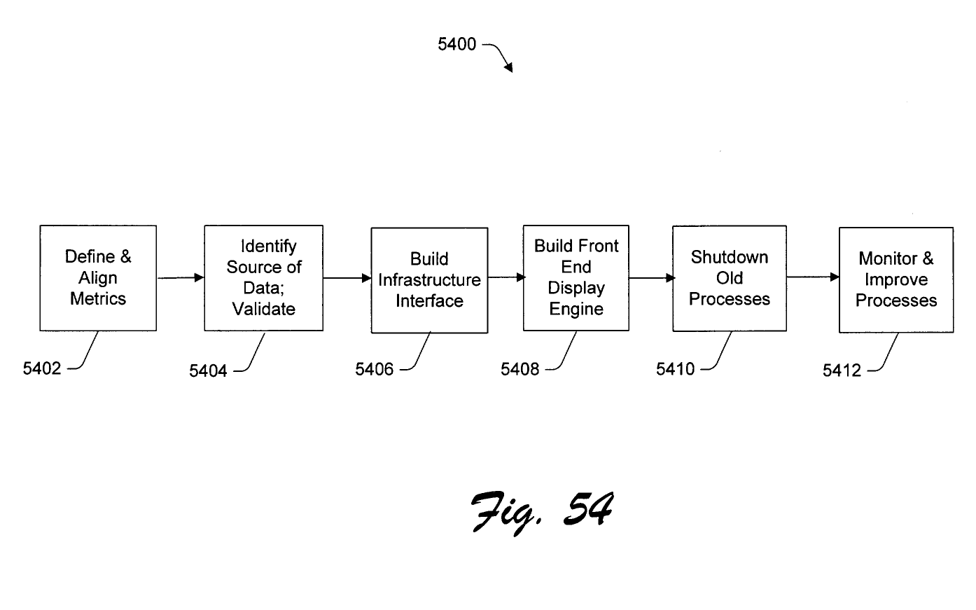

G. Exemplary Method for Designing a Digital Cockpit (FIGS. 54-56)

FIG. 54 is a flowchart of a process 5400 that provides general steps used to design a digital cockpit (which may or may not include predictive capability). The process includes a first step 5402 of defining and aligning metrics. This step 5402 entails defining the input X's and output Y's that are appropriate to a particular business application under consideration. To that end, personnel within the organization are polled to determine what those metrics are, how the data is used, and how that data is gathered. (In some organizations, it may fall to the executive leadership team to make these determinations and, indeed, the involvement of senior management is beneficial to this process. In other organizations, broader groups of employees may be consulted.) Of particular interest is the timeliness or “freshness” of the data. It is also generally desirable to find sources that can deliver data in as close to real-time fashion as is practical.

A second set 5404 involves identifying the source of data, and validating this data. That is, this step 5404 involves defining the internal business sources and potentially external sources that can be relied on to provide the required X's for use in building the digital cockpit. A third step 5406 involves building the infrastructure interface to extract and analyze the data in the manner required. A fourth step 5408 involves building the front-end display engine. That is, this step involves building the particular infrastructure associated with the presentation aspects of the digital cockpit. A fifth step 5410 involves converting any prior system that was used by the business to the new cockpit-enabled system. A sixth step 5412 involves monitoring the performance of the thus-built digital cockpit and making adjustments as necessary to improve the process.

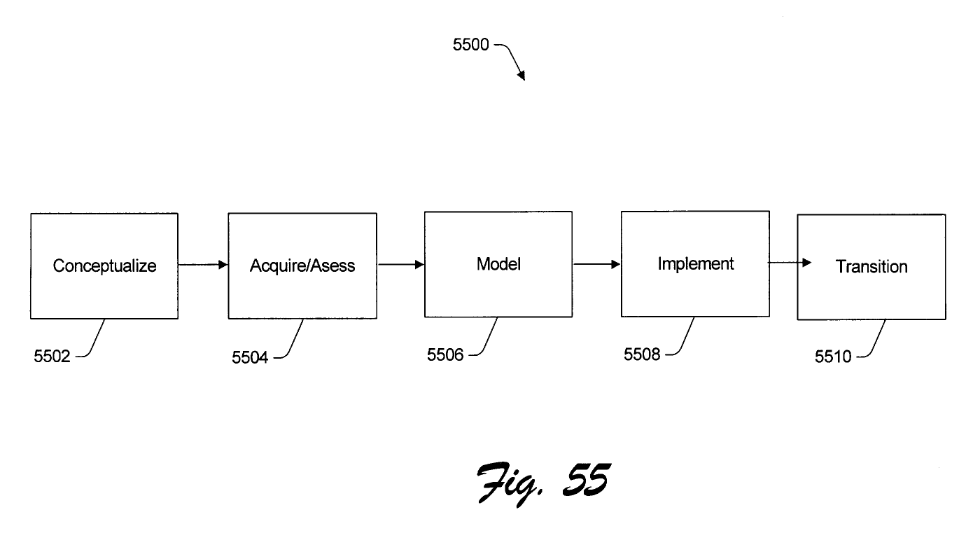

FIG. 55 is another more finely-tuned process 5500 for developing a digital cockpit that specifically includes predictive capability. Process 5500 assumes that some kind of framework is already in place for supporting a digital cockpit. Accordingly, in this design method, the design team seeks to specifically develop a new predictive model (or models) for use in an identified business application.

The process 5500 includes a first step 5502 of conceptualizing the features that will be provided by the digital cockpit. This step 5502 may include an initial substep of defining the nature of the process 5500 itself (such as by establishing team roles, etc.). This step 5502 may also include defining the X's and Y's that might prove useful in the particular business application under consideration. This step 5502 may also involve defining the actionability of the X's and Y's (e.g., whether these parameters reflect features of the business that are under the control of the business).

The second step 5504 involves acquiring and assessing the data used to feed the digital cockpit. This step 5504 involves assessing the quality of the input X's and other aspects of the input data obtained from internal or external data sources. This step 5504 may also involve assessing the predictive potential of the input data, as well as its utility within the context of a digital cockpit application.

The third step 5506 involves developing a predictive model to transform the input X's into the output Y's. This step 5506 may involve developing and validating the model (or models), as well as developing an implementation plan for implementing the model.

The fourth step 5508 actually involves implementing the digital cockpit with predictive capability. This step 5508 may involve implementing the model, testing the model (e.g., ensuring that the model meets various quality and assurance standards), implementing the presentation aspects of the new digital cockpit, and then installing the digital cockpit on a production platform.

The fifth step 5510 involves transitioning from the prior state (without the predictive digital cockpit) to the current state (that includes the predictive digital cockpit). This step 5510 may include various integration and monitoring tasks. The monitoring tasks help ensure that the digital cockpit with predictive capability is running properly and delivering useful information to the target business.

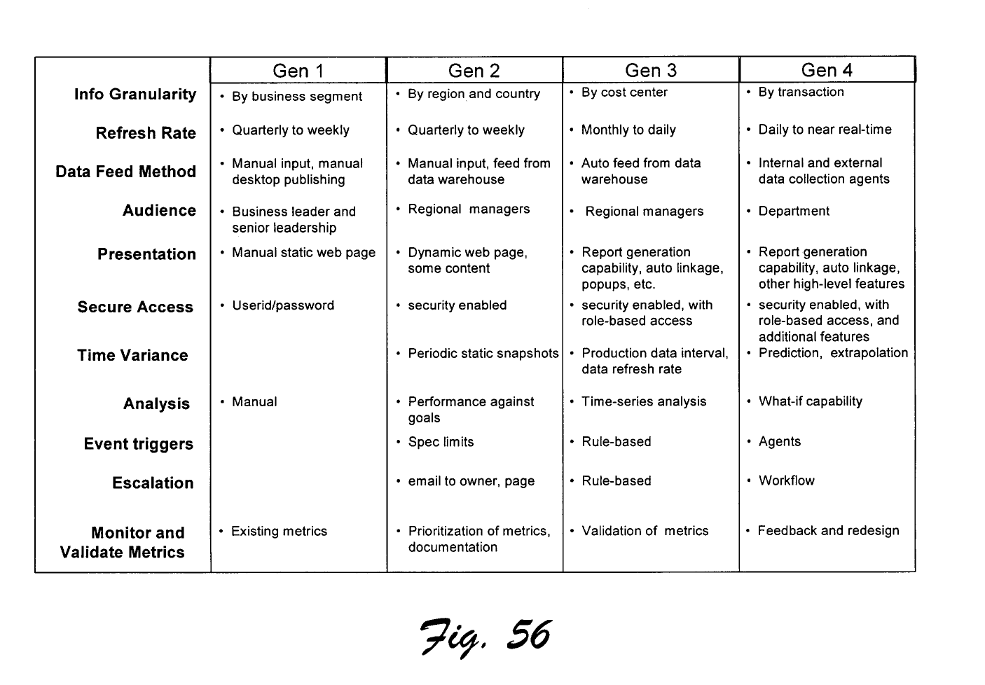

FIG. 56 shows four different generations of the digital cockpit. More specifically, a business may wish to implement the functionality of the digital cockpit in stages, referred to as “generations.” FIG. 57 identifies four generations: GEN1, GEN2, GEN3, and GEN4. Each successive stage includes more functionality than the next, such that the last stage includes the most functionality. This piecemeal approach to the design of the digital cockpit may be advantageous for various budgetary reasons, and also may allow an efficient means for an organization to test different aspects of the systems as they are introduced in succession. The different categories of functionality in the gradual introduction of the digital cockpit include: information granularity, refresh rate, data feed method, audience, presentation, secure access, time variance, analysis, event triggers, escalation, and monitor and validate metrics.

“Information granularity” reflects the level of detail in the information presented. Improvement in this category may constitute providing successively finer levels of information. “Refresh rate” represents the frequency at which information is updated in the digital cockpit. Improvement in this category may constitute providing successively faster refresh rates. “Data feed method” reflects the method of feeding data to the analytics of the digital cockpit. Improvement in this category may constitute providing successively greater automation in data extraction and processing. “Audience” reflects the individuals who are granted access to the digital cockpit. Improvement in this category may reflect making viewing audience more inclusive. “Presentation” refers to the relative sophistication, versatility, etc. of the presentation aspects of the digital cockpit. Improvement in this category may constitute providing more sophisticated and versatile presentation strategies. “Secure access” refers to the security used by the digital cockpit. Improvement in this category may constitute providing more reliable security for the digital cockpit. “Time variance” refers to the capacity of the digital cockpit to present information using different chronological strategies. In other words, “time variance” refers to the how the user is permitted to see results generated by the digital cockpit across time. Improvement in this category may constitute enabling the digital cockpit to present information in increasingly informative time windows (culminating in the possible presentation of information in a time window that encompasses the future). “Analysis” refers to the kinds of analysis performed by the digital cockpit. Improvement here constitutes providing increasingly sophisticated and powerful techniques for processing data. “Event triggers” refers to the types of notification performed by the digital cockpit. Improvement in this category may constitute generating more finely-tuned, accurate, and automatic notification techniques. “Escalation” refers to the protocols used by the digital cockpit to ramp up alert levels in various event scenarios (such as a problem not being adequately addressed after multiple notifications have already been issued). Improvement in this category may constitute making this process more finely-tune, accurate, and automatic. Finally, “monitor and validate metrics” refers to the processing protocols used to monitor and validate metrics. Improvement in this category constitutes making the system increasing responsive to this function.

H. Conclusion

A digital cockpit has been described including a number of beneficial features. For example, the digital cockpit provides an efficient mechanism for providing prompt reporting regarding a business's past behavior, its current behavior, and its projected future behavior. The digital cockpit uses a suite of business models to provide such information. Further, the digital cockpit facilitates exploration of future courses of action by allowing a cockpit user to enter various “what if” scenarios, and to view the projected consequences of such scenarios. All of these capabilities allow a cockpit user to make informed decisions regarding the control of business. The digital cockpit further includes mechanisms for allowing a user to carry out desired control of the business by making changes to the business's processes and associated systems. Further, the digital cockpit provides a modular design which allows for the efficient plug-in and modification of business models. This modularity is achieved through the use of an engine abstraction layer. The engine abstraction layer acts as a generic interface which coordinates interaction between the models and the other aspects of the digital cockpit, enabling changes to be made in the models without necessarily requiring a change in other aspects of the digital cockpit. Still additional merits of the digital cockpit were identified hereinabove.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for controlling a business operation in a business, wherein the business includes plural subprocesses, comprising:
collecting data relevant to the operation of the business;
storing the data in a data storage;
performing a first data manipulation task using the stored data to generate a first output result that provides historical information regarding the past course of the business operation and the present course of the business operation;
performing a second data manipulation task using the stored data to generate a second output result that provides a forecast regarding the future course of the business operation;
disseminating the first output result and the second output result to a user for viewing at a viewing device, wherein the user makes a decision regarding the control of the business operation, including its plural subprocesses, based on the first output result and the second output result; and
receiving an input from the user using the viewing device that affects guidance of the business operation based on the user's decision.

2. A method according to claim 1, wherein the collecting comprises:
collecting data from at least one source internal to the business; and
collecting data from at least one source external to the business.

3. A method according to claim 1, further comprising:
performing initial data processing on the data to transform the data into a specified form prior to storing the data in the data storage.

4. A method according to claim 3, wherein the initial data processing comprises:
performing quality checks on the data to ensure that the data is in the specified form.

5. A method according to claim 1, wherein the data storage is a business data warehouse.

6. A method according to claim 1, wherein the performing of the second data manipulation task comprises:
initiating the second data manipulation task in response to the user identifying a “what-if” scenario via the viewing device; and
executing the second data manipulation task by computing a predicted consequence of the identified “what-if” scenario.

7. A method according to claim 1, wherein the performing of the second data manipulation task comprises:
initiating the second data manipulation task in response to a user identifying a desired outcome result via the viewing device; and
executing the second data manipulation task by developing a recommendation regarding a course of action that is projected to achieve the desired outcome result.

8. A method according to claim 1, wherein the second data manipulation task maps at least one input value X to at least one output value Y using a transfer function.

9. A method according to claim 1, where the second data manipulation task also provides information regarding the level of confidence associated with the second output result as a function of future time.

10. A method according to claim 1, further comprising:
defining a reaction zone that represents a time required by the business to react to a change in the business operation, wherein the reaction zone is a function of at least the capacity of the business to react to a change, and the accuracy of the forecast regarding the future course of the business operation; and
tailoring the first data manipulation task and the second data manipulation task so that the first output result and the second output result provide sufficient information for the business to react to a change in view of the reaction zone of the business.

11. A computer-readable medium having computer-executable instructions for performing the method recited in claim 1.

12. A method for presenting information for use in controlling a business operation, comprising:
initiating the execution of a data manipulation task involving the use of a business tool, where the business tool is one among a group of business tools having different respective processing protocols;
activating an interface associated with the business tool;
executing the performance of the data manipulation task in a manner specified by the interface, including:
retrieving a file that specifies instructions for use in performing the data manipulation task; and
executing the instructions specified in the file using the business tool, and generating an output result in response thereto; and
disseminating the output result to a user for viewing, wherein the output result provides guidance on the operation of the business for use in steering the business in a desired direction.

13. A method according to claim 12, wherein the initiating of the execution of the data manipulation task comprises:
identifying an activity specified in a sequence of instructions, wherein the sequence of instructions defines a business model job; and
notifying the interface of the activity, to enable the interface to execute the data manipulation task corresponding to the activity.

14. A method according to claim 13, wherein the sequence of instructions is formed using a markup language.

15. A method according to claim 12, wherein the initiating of the execution of the data manipulation task further comprises:
identifying an activity type specified in a sequence of instructions, wherein the sequence of instructions defines a business model job; and
determining a type of business tool that is to be used in performing the data manipulation task based on the activity type.

16. A method according to claim 12, wherein the business tool is a business analytic tool for providing a historical summary of the past course of the business operation.

17. A method according to claim 12, wherein the business tool is a business analytic tool for providing a predictive forecast of the future course of the business operation.

18. A method according to claim 12, wherein the business tool is a data-gathering tool for collecting and preprocessing of data.

19. A method according to claim 18, further comprising:
repeating the operations of initiating, activating and executing using a business analytic tool.

20. A method according to claim 12, wherein the execution of the instructions comprises:
activating a wrapper associated with the business tool,
wherein the wrapper coordinates the execution of the instructions by:
passing input data to the business tool for use by the business tool in performing the data manipulation task; and
retrieving the output result provided by the business tool.

21. A method according to claim 12, further comprising:
logging an indication that the business tool has executed the instructions.

22. A method according to claim 12, wherein the step of disseminating comprising:
forwarding the output result to a viewing device.

23. A computer-readable medium having computer-executable instructions for performing the method recited in claim 12.

24. A method for interacting with a tool, comprising:
initiating the execution of a data manipulation task involving the use of the tool, where the tool is one among a group of tools having different respective processing protocols;
activating an interface associated with the tool; and
executing the performance of the data manipulation task in a manner specified by the interface, including:
retrieving a file that specifies instructions for use in performing the data manipulation task; and
executing the instructions specified in the file using the tool, and generating an output result in response thereto.

25. A system for controlling a business operation in a business, wherein the business includes plural subprocesses, comprising:
a data extraction subsystem configured to collect data relevant to the operation of the business;
a data storage subsystem configured to store the extracted data;
a presentation and analysis subsystem configured to:
perform a first data manipulation task using the stored data to generate a first output result that provides historical information regarding the past course of business operation and the present course of the business operation;
perform a second data manipulation task using the stored data to generate a second output result that provides a forecast regarding the future course of the business operation;
a notification and dissemination subsystem configured to disseminate the first output result and the second output result to a user for viewing; and
a viewing device for receiving and displaying the first output result and the second output result,
wherein the viewing device includes a control module configured to affect guidance of the business operation, including its plural subprocesses, in response to interaction with the user.

26. A system according to claim 25, wherein the data extraction subsystem is configured to:
collect data from at least one source internal to the business; and
collect data from at least one source external to the business.

27. A system according to claim 25, wherein the data extraction subsystem is further configured to:
perform initial data processing on the data to transform the data into a specified form prior to storing the data in the data storage subsystem.

28. A system according to claim 27, wherein the data extraction subsystem is configured to perform initial data processing by:
performing quality checks on the data to ensure that the data is in a specified form.

29. A system according to claim 25, wherein the data storage subsystem includes a business data warehouse.

30. A system according to claim 25, wherein the presentation and analysis subsystem is configured to perform the second data manipulation task by:
initiating the second data manipulation task in response to the user identifying a “what-if” scenario via the cockpit viewing device; and
executing the second data manipulation task by computing a predicted consequence of the identified “what-if” scenario.

31. A system according to claim 25, wherein the presentation and analysis subsystem is configured to perform the second data manipulation task by:
initiating the second data manipulation task in response to a user identifying a desired outcome result; and
executing the second data manipulation task by developing a recommendation regarding a course of action that is projected to achieve the desired outcome result.

32. A system according to claim 25, further include at least one business model that uses a transfer function to map at least one input value X to at least one output value Y, wherein the second data manipulation task is configured to perform the second data manipulation task using the business model.

33. A system according to claim 25, wherein the presentation and analysis subsystem is configured to perform the second data manipulation task by also providing information regarding the level of confidence associated with the second output result as a function of future time.

34. A system according to claim 25, wherein the control module includes a graphical user interface for interacting with the user to affect the control of the business operation.

35. A system for presenting information for use in controlling a business operation, comprising:
a controller module;
a group of business tools having different respective processing protocols;
an interface for coordinating interaction between the controller module and a business tool selected from among the group of business tools,
wherein the interface logic includes:
logic configured to receive a request from the controller module to execute a data manipulation task involving the business tool;
logic configured to retrieve a file that specifies instructions for use in performing the data manipulation task by the business tool,
wherein the business tool executes the instructions specified in the file to generate an output result; and
logic configured to disseminate the output result to a user for viewing, wherein the output result provides guidance on the operation of the business for use in steering the business in a desired direction.

36. A system according to claim 35, wherein the controller module is configured to initiate the execution of the data manipulation task by:
identifying an activity specified in a sequence of instructions, wherein the sequence of instructions defines a business model job; and
notifying the interface of the activity, to enable the interface to execute the data manipulation task corresponding to the activity.

37. A system according to claim 36, wherein the sequence of instructions is formed using a markup language.

38. A system according to claim 35, wherein the controller module is configured to initiate the execution of the data manipulation task by:
identifying an activity type specified in a sequence of instructions, wherein the sequence of instructions defines a business model job; and
determining a type of business tool that is to be used in performing the data manipulation task.

39. A system according to claim 35, wherein the business tool is a business analytic tool for providing a historical summary of the past course of the business operation.

40. A system according to claim 35, wherein the business tool is a business analytic tool for providing a predictive forecast of the future course of the business operation.

41. A system according to claim 35, wherein the business tool is a data-gathering tool for collecting and preprocessing of data.

42. A system according to claim 35, further comprising a wrapper configured to coordinate execution of the instructions by:
passing input data to the business tool for use by the business tool in performing the data manipulation task; and
retrieving the output result provided by the business tool.

43. A system according to claim 35, further comprising:
logging logic configured to log an indication that the business tool has executed the instructions.

44. A system for interacting with a tool, comprising:
a controller module;
an interface for coordinating interaction between the controller module and the tool, where the business tool is one among a group of business tools having different respective processing protocols;
wherein the interface logic includes:
logic configured to receive a request from the controller module to execute a data manipulation task involving the tool;
logic configured to retrieve a file that specifies instructions for use in performing the data manipulation task by the tool,
wherein the tool executes the instructions specified in the file to generate an output result.

45. A system, comprising:
a data-gathering tool for collecting and preprocessing data;
a business analytic tool for performing analysis on the data;
a controller module for executing a job involving the use of the data-gathering tool and the business analytic tool; and
an engine abstraction layer associated with the controller module for coordinating interaction between the controller module and the data-gathering tool, and between the controller module and the business analytic tool.

46. A method for developing a model, comprising:
specifying at least one activity used by the model;
specifying a tool to be used to perform the at least one activity; and
storing an indication of the specified at least one activity and the specified tool to form a job script,
wherein the at least one activity includes a file associated therewith, the file containing instructions to be used by the tool in performing the at least one activity when the job script is executed.

47. A method according to claim 46, wherein the job script is formed using a markup language.

48. A method according to claim 46, further including specifying the file associated with the at least one activity.

49. A method according to claim 46, further including specifying job metadata that identifies the model.

50. A method according to claim 46, further including specifying output of the model which is to be archived when the job script is executed.

51. A method according to claim 46, further including providing a graphical user interface including at least one interface page for use in specifying the activity and the tool.

52. A computer-readable medium having computer-executable instructions for performing the job script recited in claim 46.

53. A system for developing a model using a graphical user interface, comprising:
logic configured to prompt a user to specifying at least one activity used by the model;
logic configured to prompt the user to specify a tool to be used to perform the at least one activity; and
logic configured to store an indication of the specified at least one activity and the specified tool to form a job script,
wherein the at the least one activity includes a file associated therewith, the file containing instructions to be used by the tool in performing the at least one activity when the job script is executed.

54. A system according to claim 53, wherein the job script is formed using a markup language.

55. A system according to claim 53, further including logic configured to prompt the user to specify the file associated with the at least one activity.

56. A system according to claim 53, further including logic configured to prompt the user to specify job metadata that identifies the model.

57. A system according to claim 53, further including logic configured to prompt the user to specify output of the model which is to be archived when the job script is executed.

58. A computer-readable medium having computer-executable instructions for performing the logic in claim 53.
